(19) United States
(12) Patent Application Publication
(10) Pub. No.: US 2024/0359317 A1
(43) Pub. Date: Oct. 31, 2024

(54) MODULAR CNC SYSTEM

(71) Applicant: CN-Seamless, Inc., Durham, NC (US)

(72) Inventors: Joshua Allen Cooper, Raleigh, NC (US); Samuel Bennett Marcom, Durham, NC (US); Dario Etienne Alexis Müller, Chapel Hill, NC (US)

(21) Appl. No.: 18/646,062

(22) Filed: Apr. 25, 2024

Related U.S. Application Data
(60) Provisional application No. 63/498,148, filed on Apr. 25, 2023.

(51) Int. Cl. B25J 9/08; B25J 9/10; B25J 11/00; B25J 13/00; B25J 15/00; B25J 15/04

(52) U.S. Cl. CPC B25J 9/08; B25J 9/1005; B25J 11/0055; B25J 13/003; B25J 15/0019; B25J 15/0441

(57) ABSTRACT

A modular robotic system that incorporates CNC functionality and is designed to create precise CNC cut parts. The modular CNC system includes a base, a base arm, a first attachment, a second attachment, and a controller. The modular CNC system includes swappable attachment components and tools for different metalworking processes. The modular CNC system performs metalwork in a variety of orientations including a vertical orientation and an upside-down orientation. The modular CNC system is portable and designed to directly attach to a workpiece.

### CROSS-REFERENCE TO RELATED APPLICATION

This application claims the benefit and priority to U.S. Provisional Patent Application No. 63/498,148, filed on Apr. 25, 2023, the entire content of which is incorporated by reference herein in its entirety.

### BACKGROUND

Computerized Numerical Control (CNC) machines are commonly used in industrial machinery. CNC machines control tools and workpieces utilizing a numerical program. Generally, CNC machines are used to control lathes, electrical discharging machinery (EDM) machines, mills, surfaces, surface grinders, saws, and cutting processes (e.g., oxy-acetylene or plasma).

### FIELD OF THE INVENTION

The present invention is generally directed to CNC machines, more specifically to modular CNC machines and systems.

### DESCRIPTION OF RELATED ART

Problems that typically occur with CNC machines includes (1) using the wrong tools and/or settings, (2) programming errors, (3) poor maintenance, (4) inadequate user skill and training, (5) clamping problems, (6) power supply problems, (7) machine vibration, (8) tool overheating, (9) machine size, and (10) cut limitations.

Generally, CNC machines are not designed to cut oddly shaped parts due to the size and shape of CNC machines. Most CNC cutting machines utilizing plasma, oxy-fuel, or laser cutting can only cut on a large, flat plane. Typically, these CNC machines are not easily moved so the workpieces must be brought to the machine. Also, current CNC machines have difficulty cutting deep flange beams using plasma tables because cutting a flange beam is more complicated than cutting along a flat plane. Therefore, there is a need for a CNC machine that is adaptable for cuts of various sizes and shapes. There is a further need for a portable CNC machine to enable the CNC machine to be brought to a workpiece.

### BRIEF SUMMARY OF THE INVENTION

The present invention includes a modular robotic platform that incorporates CNC functionality and is designed to cut precise CNC manufacturer parts. The modular CNC system provides service and maintenance fabrication processes that are typically executed by user welding utilizing a hand torch. The present invention includes a modular CNC system including a base, a base arm, an oxy-fuel attachment assembly, a plasma attachment assembly, and a controller. In some embodiments, the base includes an oxy-fuel module for managing the operations of an oxy-fuel component (e.g., oxy-fuel torch). Advantageously, the modular CNC system includes swappable and/or adjustable attachment components and tools for different processes. For example, and without limitation, the oxy-fuel attachment may be a drill, a turning tool, a boring tool, a facing tool, a chamfering tool, a cutter, a reamer, a mill, and other tools used for CNC systems. In some embodiments, the modular CNC system includes an additive manufacturing tip (e.g., three-dimensional (3D) printing, selective laser sintering (SLS), stereolithography (SLA), or fused deposition modeling (FDM)), a water jet attachment, a laser cutter, an engraver, an artisan (e.g., painting) attachment, a cardboard cutting component (e.g., razor), a foam cutter, and other similar manufacturing applications. The modular CNC system is further operable for metalworking in a variety of orientations, including a vertical orientation and an upside-down orientation. The modular CNC system may also perform CNC operations on materials other than metal, including but not limited to glass, wood, plastic, and other similar materials.

In some embodiments, a modular computerized numerical control (CNC) system is disclosed. The modular CNC system includes a base assembly including a housing, at least one power supply, at least one rotatable base arm, and an attachment mechanism, at least one module, at least one arm attachment component, at least one processor, and at least one tool. A first end of the at least one arm attachment component is rotatably connected to the at least one rotatable base arm via an attachment component. A second end of the at least one arm attachment component is operable to receive the at least one tool. The base attachment mechanism is operable to engage an external surface. The at least one module is in electrical connection with the at least one processor and the at least one tool. The at least one module is operable to control the at least one tool.

In some embodiments, the at least one tool is an oxy-fuel torch. In some embodiments, the at least one module is an oxy-fuel module. The oxy-fuel module is operable to control a flow of gas to the oxy-fuel torch. In some embodiments, the base attachment mechanism includes an electromagnet. The electromagnet is operable to attach the modular CNC system to a magnetic surface. In some embodiments, the at least one tool is a plasma torch. In some embodiments, the base assembly further includes a height control assembly. The height control assembly is operable to control a height of the at least one rotatable base arm. In some embodiments, the base attachment mechanism includes a vacuum component. The vacuum component includes at least two suction cups and at least one pump. The at least one pump is operable to remove air from the at least two suction cups to create a sealed environment.

In some embodiments, the at least one processor is in network communication with at least one remote device. The at least one remote device is operable to transmit at least one command to the at least one processor. The at least one command includes a power command and/or a position command. The power command includes at least one of activating the base assembly, deactivating the base assembly, activating the at least one tool, or deactivating the at least one tool. The position command includes a target position for the at least one rotatable base arm and/or the at least one tool.

In some embodiments, a modular computerized numerical control (CNC) system is disclosed. The modular CNC system includes a base assembly, at least one module, at least one arm attachment component, at least one processor, and at least one tool. The base assembly includes a housing, at least one power supply, at least one rotatable base arm, and an electromagnet. A first end of the at least one arm attachment component is rotatably connected to the at least one rotatable base arm via an attachment component. A second end of the at least one arm attachment component is operable to receive the at least one tool. The electromagnet is operable to engage an external surface. The at least one module is in electrical connection with the at least one processor and the at least one tool. The at least one module is operable to control the at least one tool.

In some embodiments, the at least one tool includes an oxy-fuel torch. In some embodiments, the at least one module is an oxy-fuel module. The oxy-fuel module is operable to control a flow of gas to the oxy-fuel torch. In some embodiments, the at least one tool is a plasma torch. In some embodiments, the base assembly includes a height control assembly. The height control assembly is operable to control a height of the at least one rotatable base arm. In some embodiments, the modular CNC system further includes a carrying case. The carrying case is operable to receive the base assembly, the at least one module, the at least one arm attachment component, and the at least one tool.

In some embodiments, a modular computerized numerical control (CNC) machine is disclosed. The modular CNC machine includes a base assembly, at least one module, at least one arm attachment component, at least one processor, and at least one tool. The base assembly includes a housing, at least one power supply, at least one rotatable base arm, and an attachment mechanism. A first end of the at least one arm attachment component is rotatably connected to the at least one rotatable base arm via an attachment component. A second end of the at least one arm attachment component is operable to receive the at least one tool. The base attachment mechanism is operable to engage an external surface. The at least one module is in electrical connection with the at least one processor and the at least one tool. The at least one rotatable base arm and the at least one arm attachment component are operable to extend away from the base housing. The at least one module is operable to control the at least one tool.

In some embodiments, the modular CNC system includes an oxy-fuel torch. In some embodiments, the at least one module is an oxy-fuel module designed to control the flow of gas to the oxy-fuel torch. In some embodiments, the at least one tool is a plasma torch. In some embodiments, the base assembly further includes a height control assembly. The height control assembly is operable to control a height of the at least one rotatable base arm. In some embodiments, the modular CNC system further includes at least one sensor. The at least one sensor is operable to receive audio data during operation of the at least one tool. The at least one sensor is operable to transmit the received audio data to the at least one processor. Based on the received audio data, the at least one processor is operable to change at least one operation of the at least one tool. The at least one operation of the at least one tool includes a cutting rate.

### BRIEF DESCRIPTION OF THE SEVERAL VIEWS OF THE DRAWINGS

These embodiments, illustrated, described, and discussed herein are illustrative of the present invention. As these embodiments of the present invention are described with reference to illustrations, various modifications, or adaptations of the methods and/or specific structures described may become apparent to those skilled in the art. It will be appreciated that modifications and variations are covered by the above teachings and within the scope of the appended claims without departing from the spirit and intended scope thereof. All such modifications, adaptations, variations that rely upon the teachings of the present invention, and through which these teachings have advanced the art, are considered to be within the spirit and scope of the present invention. Hence, these descriptions and drawings should not be considered in a limiting sense, as it is understood that the present invention is no way limited to only the embodiments illustrated.

FIG. 1 illustrates a modular CNC system including a mounted oxy-fuel attachment component according to one embodiment of the present invention.

FIG. 2 illustrates an exploded view of a modular CNC system including a base machine, an oxy-fuel attachment, a plasma attachment, an oxy-fuel arm, and a controller according to one embodiment of the present invention.

FIG. 3A illustrates a side perspective view of a modular CNC system including a mounted oxy-fuel attachment component according to one embodiment of the present invention.

FIG. 3B illustrates a top view of the modular CNC system shown in FIG. 3A.

FIG. 3C illustrates a front view of the modular CNC system shown in FIG. 3A.

FIG. 4 illustrates a side view of a modular CNC system on a surface according to one embodiment of the present invention.

FIG. 5A illustrates a top view of a modular CNC system according to one embodiment of the present invention.

FIG. 5B illustrates a top view of the modular CNC system shown in FIG. 5A.

FIG. 5C illustrates a top view of the modular CNC system shown in FIG. 5A.

FIG. 5D illustrates a top view of the modular CNC system shown in FIG. 5A.

FIG. 5E illustrates a top view of the modular CNC system shown in FIG. 5A.

FIG. 6A illustrates a side perspective view of a modular CNC system including a vacuum attachment component according to one embodiment of the present invention.

FIG. 6B illustrates a vacuum attachment component of the modular CNC system shown in FIG. 6A.

FIG. 6C illustrates an exploded view of the vacuum attachment component shown in FIG. 6B.

FIG. 7A illustrates an exploded view of a modular CNC system according to one embodiment of the present invention.

FIG. 7B illustrates an assembled view of a modular CNC system according to one embodiment of the present invention.

FIG. 8A illustrates a modular CNC system with an exploded view of a base arm according to one embodiment of the present invention.

FIG. 8B illustrates a side view of the modular CNC system with an exploded view of the base arm shown in FIG. 8A.

FIG. 8C illustrates a side view of the modular CNC system shown in FIG. 8A with an attached base arm.

FIG. 9A illustrates a perspective view of a frame of a modular CNC system according to one embodiment of the present invention.

FIG. 9B illustrates a bottom perspective view of the frame of the modular CNC system shown in FIG. 9A.

FIG. 10A illustrates an side perspective view of an interior of a modular CNC system according to one embodiment of the present invention.

FIG. 10B illustrates an rear perspective view of the interior of the modular CNC system shown in FIG. 10A.

FIG. 10C illustrates an rear perspective view of the interior of the modular CNC system shown in FIG. 10A.

FIG. 10D illustrates an exploded view of the interior of the modular CNC system shown in FIG. 10A.

FIG. 10E illustrates a rear perspective view of the exploded view of the interior of the modular CNC system shown in FIG. 10D.

FIG. 10F illustrates a side perspective view of the exploded view of the interior of the modular CNC system shown in FIG. 10D.

FIG. 11A illustrates a side perspective view of a base of a modular CNC system with an exploded view of a top plate according to one embodiment of the present invention.

FIG. 11B illustrates a side perspective view of the base of the modular CNC system shown in FIG. 11A.

FIG. 12A illustrates a front perspective view of a rear plate of a modular CNC system according to one embodiment of the present invention.

FIG. 12B illustrates an exploded view of the rear plate of the modular CNC system shown in FIG. 12A.

FIG. 13A illustrates a perspective view of a vertical plate of a base of a modular CNC system according to one embodiment of the present invention.

FIG. 13B illustrates a perspective view of the vertical plate of the base of the modular CNC system shown in FIG. 13A.

FIG. 13C illustrates a perspective view of the vertical plate of the base of the modular CNC system shown in FIG. 13A.

FIG. 13D illustrates an exploded view of the vertical plate of the base of the modular CNC system shown in FIG. 13A.

FIG. 14A illustrate a power supply assembly of a modular CNC system according to one embodiment of the present invention.

FIG. 14B illustrates an exploded view of the power supply assembly of the modular CNC system shown in FIG. 14A.

FIG. 15A illustrates a perspective view of a height control assembly of a modular CNC system according to one embodiment of the present invention.

FIG. 15B illustrates a perspective view of the height control assembly of the modular CNC system shown in FIG. 15A.

FIG. 15C illustrates an exploded view of the height control assembly of the modular CNC system shown in FIG. 15A.

FIG. 15D illustrates a disassembled view of the height control assembly of the modular CNC system shown in FIG. 15A.

FIG. 15E illustrates a top view of the height control assembly of the modular CNC system shown in FIG. 15A.

FIG. 15F illustrates a top view of the height control assembly of the modular CNC system shown in FIG. 15A.

FIG. 15G illustrates a rear perspective view of the height control assembly of the modular CNC system shown in FIG. 15A.

FIG. 16A illustrates a side perspective view of a height control assembly of the modular CNC system according to one embodiment of the present invention.

FIG. 16B illustrates a side perspective view of a height control assembly of the modular CNC system shown in FIG. 16A.

FIG. 16C illustrates a rea perspective view of a height control assembly of the modular CNC system shown in FIG. 16A.

FIG. 16D illustrates a side perspective view of a height control assembly of the modular CNC system shown in FIG. 16A attached to a vertical plate.

FIG. 16E illustrates a side perspective view of a height control assembly of the modular CNC system shown in FIG. 16A attached to a vertical plate.

FIG. 17 illustrates a cross-sectional view of a switch homing board according to one embodiment of the present invention.

FIG. 18A illustrates a battery component of a modular CNC system according to embodiment of the present invention.

FIG. 18B illustrates an exploded view of the battery component of the modular CNC system shown in FIG. 18A.

FIG. 19A illustrates a plasma arm component of a modular CNC system according to one embodiment of the present invention.

FIG. 19B illustrates an exploded view of the plasma arm component of the modular CNC system according to one embodiment of the present invention.

FIG. 19C illustrates a top view of a plasma arm component of the modular CNC system shown in FIG. 19A.

FIG. 19D illustrates a top view of a plasma arm component of the modular CNC system shown in FIG. 19A.

FIG. 20A illustrates an oxy-fuel manifold mounted in a case of a modular CNC system according to one embodiment of the present invention.

FIG. 20B illustrates a rear perspective view of the oxy-fuel manifold of the modular CNC system shown in FIG. 20A.

FIG. 20C illustrates a rear view of the oxy-fuel manifold of the modular CNC system shown in FIG. 20A.

FIG. 20D illustrates an exploded view of the oxy-fuel manifold of the modular CNC system shown in FIG. 20A.

FIG. 20E illustrates a front view of the oxy-fuel manifold of the modular CNC system shown in FIG. 20A.

FIG. 20F illustrates a cross-sectional view of the oxy-fuel manifold of the modular CNC system shown in FIG. 20A.

FIG. 20G illustrates a cross-sectional view of the oxy-fuel manifold of the modular CNC system shown in FIG. 20A.

FIG. 20H illustrates a bottom view of the oxy-fuel manifold of the modular CNC system shown in FIG. 20A.

FIG. 21A illustrates a plasma manifold of a modular CNC system according to one embodiment of the present invention.

FIG. 21B illustrates an exploded view of the plasma manifold of the modular CNC system shown in FIG. 21A.

FIG. 22A illustrates an oxy-fuel manifold of a modular CNC system according to one embodiment of the present invention.

FIG. 22B illustrates a side perspective view of the oxy-fuel manifold of the modular CNC system shown in FIG. 22A.

FIG. 22C illustrates an exploded view of the oxy-fuel manifold shown in FIG. 22A.

FIG. 23A illustrates an oxy-fuel manifold according to one embodiment of the present invention

FIG. 23B illustrates a transparent view of the oxy-fuel manifold shown in FIG. 23A.

FIG. 23C illustrates a top transparent view of the oxy-fuel manifold shown in FIG. 23A.

FIG. 23D illustrates a cross-sectional transparent view of the oxy-fuel manifold shown in FIG. 23A.

FIG. 23E illustrate a bottom transparent view of the oxy-fuel manifold shown in FIG. 23A.

FIG. 24A illustrates a plasma manifold of a modular CNC system according to one embodiment of the present invention.

FIG. 24B illustrates a side perspective view of a housing of the plasma manifold of the modular CNC system shown in FIG. 24A.

FIG. 24C illustrates an exploded view of the housing of the plasma manifold of the modular CNC system shown in FIG. 24B.

FIG. 24D illustrates an exploded view of the plasma manifold shown in FIG. 24A.

FIG. 25A illustrates a bottom view of an oxy-fuel arm attachment component according to one embodiment of the present invention.

FIG. 25B illustrates a bottom view of the oxy-fuel arm attachment component shown in FIG. 25A.

FIG. 26A illustrates a bottom view of an arm attachment component according to one embodiment of the present invention.

FIG. 26B illustrates a bottom view of the arm attachment component shown in FIG. 26A.

FIG. 27 illustrates an oxy-fuel arm attachment component according to one embodiment of the present invention.

FIG. 28 illustrates an plasma arm attachment component according to one embodiment of the present invention.

FIG. 29A illustrates an oxy-fuel arm attachment component according to one embodiment of the present invention.

FIG. 29B illustrates an exploded view of the oxy-fuel arm attachment component shown in FIG. 29A.

FIG. 30A illustrates an oxy-fuel arm attachment component according to one embodiment of the present invention.

FIG. 30B illustrates an exploded view of the oxy-fuel arm attachment component shown in FIG. 30A.

FIG. 31A illustrates an oxy-fuel assembly according to one embodiment.

FIG. 31B illustrates an oxy-fuel assembly according to one embodiment.

FIG. 32A illustrates a plasma assembly according to one embodiment of the present invention.

FIG. 32B illustrates a plasma assembly according to one embodiment of the present invention.

FIG. 33A illustrates a side perspective view of a quick attachment component according to one embodiment of the present invention.

FIG. 33B illustrates an exploded view of the quick attachment component shown in FIG. 33A.

FIG. 33C illustrates a top view of the quick attachment component shown in FIG. 33A including a cross-sectional line A-A.

FIG. 33D illustrates a cross-sectional view along section-sectional line A-A of the quick attachment component shown in FIG. 33C.

FIG. 34 illustrates a modular CNC system on a calibration plate according to one embodiment of the present invention.

FIG. 35 illustrates a calibration plate according to one embodiment of the present invention.

FIG. 36A illustrates a modular CNC system in a lowered arm position according to one embodiment of the present invention.

FIG. 36B illustrates the modular CNC system shown in FIG. 36A in a raised arm position.

FIG. 37A illustrates a modular CNC system including a carrying case according to one embodiment of the present invention.

FIG. 37B illustrates an exploded view of the modular CNC system shown in FIG. 37A.

FIG. 37C illustrates a top view of the modular CNC system shown in FIG. 37A.

FIG. 38 illustrates a screenshot of a software platform of a modular CNC system according to one embodiment of the present invention.

FIG. 39 illustrates a screenshot of a software platform of a modular CNC system according to one embodiment of the present invention.

FIG. 40 illustrates a screenshot of a software platform of a modular CNC system according to one embodiment of the present invention.

FIG. 41 illustrates a screenshot of a software platform of a modular CNC system according to one embodiment of the present invention.

FIG. 42 illustrates a screenshot of a software platform of a modular CNC system according to one embodiment of the present invention.

FIG. 43 illustrates a screenshot of a software platform of a modular CNC system according to one embodiment of the present invention.

FIG. 44 illustrates a screenshot of a software platform of a modular CNC system according to one embodiment of the present invention.

FIG. 45 illustrates a screenshot of a software platform of a modular CNC system according to one embodiment of the present invention.

FIG. 46 illustrates a screenshot of a software platform of a modular CNC system according to one embodiment of the present invention.

FIG. 47 illustrates a screenshot of a software platform of a modular CNC system according to one embodiment of the present invention.

FIG. 48 illustrates a screenshot of a software platform of a modular CNC system according to one embodiment of the present invention.

FIG. 49 illustrates a screenshot of a software platform of a modular CNC system according to one embodiment of the present invention.

FIG. 50 illustrates a screenshot of a software platform of a modular CNC system according to one embodiment of the present invention.

FIG. 51 illustrates a screenshot of a software platform of a modular CNC system according to one embodiment of the present invention.

FIG. 52 illustrates a screenshot of a software platform of a modular CNC system according to one embodiment of the present invention.

FIG. 53 illustrates a screenshot of a software platform of a modular CNC system according to one embodiment of the present invention.

FIG. 54 illustrates a screenshot of a software platform of a modular CNC system according to one embodiment of the present invention.

FIG. 55 illustrates a screenshot of a software platform of a modular CNC system according to one embodiment of the present invention.

FIG. 56 illustrates a screenshot of a software platform of a modular CNC system according to one embodiment of the present invention.

FIG. 57 illustrates a screenshot of a software platform of a modular CNC system according to one embodiment of the present invention.

FIG. 58 illustrates a screenshot of a software platform of a modular CNC system according to one embodiment of the present invention.

FIG. 59 illustrates a screenshot of a software platform of a modular CNC system according to one embodiment of the present invention.

FIG. 60 illustrates a screenshot of a software platform of a modular CNC system according to one embodiment of the present invention.

FIG. 61 illustrates a screenshot of a software platform of a modular CNC system according to one embodiment of the present invention.

FIG. 62 illustrates a screenshot of a software platform of a modular CNC system according to one embodiment of the present invention.

FIG. 63 illustrates a screenshot of a software platform of a modular CNC system according to one embodiment of the present invention.

FIG. 64 illustrates a screenshot of a software platform of a modular CNC system according to one embodiment of the present invention.

FIG. 65 illustrates a screenshot of a software platform of a modular CNC system according to one embodiment of the present invention.

FIG. 66 illustrates a screenshot of a software platform of a modular CNC system according to one embodiment of the present invention.

FIG. 67 illustrates a screenshot of a software platform of a modular CNC system according to one embodiment of the present invention.

FIG. 68 illustrates a screenshot of a software platform of a modular CNC system according to one embodiment of the present invention.

FIG. 69 illustrates a screenshot of a software platform of a modular CNC system according to one embodiment of the present invention.

FIG. 70 illustrates a screenshot of a software platform of a modular CNC system according to one embodiment of the present invention.

FIG. 71 illustrates a screenshot of a software platform of a modular CNC system according to one embodiment of the present invention.

FIG. 72 illustrates a screenshot of a software platform of a modular CNC system according to one embodiment of the present invention.

FIG. 73 illustrates a screenshot of a software platform of a modular CNC system according to one embodiment of the present invention.

FIG. 74 illustrates a screenshot of a software platform of a modular CNC system according to one embodiment of the present invention.

FIG. 75 illustrates a screenshot of a software platform of a modular CNC system according to one embodiment of the present invention.

FIG. 76 illustrates a screenshot of a software platform of a modular CNC system according to one embodiment of the present invention.

FIG. 77 illustrates a screenshot of a software platform of a modular CNC system according to one embodiment of the present invention.

FIG. 78 illustrates a screenshot of a software platform of a modular CNC system according to one embodiment of the present invention.

FIG. 79 illustrates a screenshot of a software platform of a modular CNC system according to one embodiment of the present invention.

FIG. 80 illustrates a screenshot of a software platform of a modular CNC system according to one embodiment of the present invention.

FIG. 81 illustrates a screenshot of a software platform of a modular CNC system according to one embodiment of the present invention.

FIG. 82 illustrates a screenshot of a software platform of a modular CNC system according to one embodiment of the present invention.

FIG. 83 illustrates a screenshot of a software platform of a modular CNC system according to one embodiment of the present invention.

FIG. 84 illustrates a screenshot of a software platform of a modular CNC system according to one embodiment of the present invention.

FIG. 85 illustrates a screenshot of a software platform of a modular CNC system according to one embodiment of the present invention.

FIG. 86 illustrates a screenshot of a software platform of a modular CNC system according to one embodiment of the present invention.

FIG. 87 illustrates a screenshot of a software platform of a modular CNC system according to one embodiment of the present invention.

FIG. 88 illustrates a screenshot of a software platform of a modular CNC system according to one embodiment of the present invention.

FIG. 89 illustrates a screenshot of a software platform of a modular CNC system according to one embodiment of the present invention.

FIG. 90 illustrates a screenshot of a software platform of a modular CNC system according to one embodiment of the present invention.

### DETAIL DESCRIPTION

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a device” can include a plurality of such devices, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the presently disclosed subject matter.

In some embodiments, the present invention includes a modular CNC system including a base, a base arm, a first attachment, a second attachment, and a controller. The first attachment and the second attachment each include an end effector. For example, and without limitation, the first attachment includes an oxy-fuel attachment comprising an oxy-fuel module, an arm, and a plurality of cables and hoses connecting the oxy-fuel module and the oxy-fuel arm. The oxy-fuel module is positioned on the base. The oxy-fuel module is connected to at least one supply container. The at least one supply container includes an oxygen supply and/or a fuel gas container. In some embodiments, the second attachment includes a plasma attachment comprising a plasma arm, a plasma module, and a plurality of cables connecting the plasma module and the plasma arm. The plasma manifold and plasma torch are connected via a plurality of cables to an external plasma cutting system.

In some embodiments, the modular CNC system includes a ledge operable to receive a module (e.g., oxy-fuel module). The ledge is designed for a corresponding module to slide in and out of the base of the modular CNC system. Once a module is attached to the base, the module is electrically connected via an electrical connector to a main circuit board. Advantageously, the ledge ensures that the module is aligned with the electrical connector. The modular CNC system includes a cam lock designed to hold a module in place when connected to the base.

In some embodiments, the modular CNC system includes a plurality of stiffeners and a ledge to receive a module (e.g., oxy-fuel module, plasma module). The modular CNC system further includes a cam lock and plunger mechanism. For example, and without limitation, when turned, the cam lock moves the plunger into a hole in the base plate. In some embodiments, the modular CNC system includes a cam lock and a locking cutout. The cam lock is operable to insert into a cam lock hole positioned on the base. The base of the modular CNC system further includes a locking ledge to receive the locking cutout. In some embodiments, the modular CNC system includes a ledge operable to receive an oxy-fuel module and/or a plasma module. The ledge is operable for a module to slide in and out. The ledge further limits the degrees of freedom. Once a module is attached to the base, the module is electrically connected via an electrical connector to communicate with a printed circuit board. Advantageously, the ledge ensures that the electrical connector aligns with the corresponding connector on the base. The base further includes a cam lock to hold the module in place when connected to the base.

In some embodiments, the modular CNC system includes a base enclosure. The base enclosure includes an aluminum base plate, a rear plate, a vertical plate, a front plate, a top plate, a plurality of tie-downs, and a top plate. The base further includes a sheet metal base plate and a plurality of side panels for closeout. The base further includes an electromagnet. Alternatively, or additionally, the base includes a vacuum component to attach to another device, system, apparatus, and/or workpiece.

In some embodiments, the CNC modular system is designed for height control. The CNC modular system includes a height control system including vertical plate, a stepper motor, a plurality of homing switches, a flex component, and a servo motor. The housing of the CNC modular system protects the motors from external elements. In some embodiments, the modular CNC system includes a plurality of rails for moving an arm component in a vertical direction. In some embodiments, the modular CNC system includes a plurality of servo motors. In some embodiments, a plurality of magnetic homing switches are used.

In some embodiments, the base arm includes aluminum and is removably attached to the height control system. The base arm is designed to attach to the flex component of the height control system. The modular CNC system further includes a taper lock. Advantageously, once connected to the base, the modular CNC system is carriable via the base arm. In some embodiments, the base arm includes a gripping surface to improve carrying. In some embodiments, the base arm is extendable (e.g., telescopic) to enable the base arm to extend or contract as needed for a workpiece. In some embodiments, the base arm includes a plurality of linkages (e.g., 4-bar linkage) to improve the adjustability.

In some embodiments, the modular CNC system includes a quick connect system. The quick connect system includes a base module that is operable to slide into a base of the modular CNC system. The base includes an electrical connector for establishing electrical connection between the base module and the base. The modular CNC system further includes a plurality of guide rails to limit movement in a vertical direction. The modular CNC system further includes a cam lock to hold the base at a designated position. Advantageously, the modular CNC system provides a single device that can perform multiple CNC processes. In some embodiments, the quick connect system includes a thumbscrew, a pin, a ball detent, and other similar attachment mechanisms. In some embodiments, the modular CNC system includes a dovetail joint to constrain the base module.

In some embodiments, the modular CNC system includes a quick attachment system. The quick attachment system includes a mechanical taper that mates with a taper on a secondary arm component and includes a handle to tighten a connection between the two tapers. The taper lock enables tool switching and processes. In some embodiments, the handle includes a thumbscrew, a bolt, and other similar tightening mechanisms.

In some embodiments, the modular CNC system includes a controller. In some embodiments, the controller is in the base housing. Alternatively, or additionally, the controller is in a control interface (e.g., display, remote device). The controller is designed to control the operations (e.g., gas flow, arm movement, height control) of the modular CNC system. The controller is further operable to display a real-time status of the modular CNC system. In some embodiments, the controller is in a wired connection with the base of the modular CNC system. In some embodiments, the controller is in a wireless connection with the base of the modular CNC system. In some embodiments, the controller is operable to control a plurality of modular CNC devices and systems. In some embodiments, the modular CNC system is in network communication with at least one remote device including an AR/VR headset that generates a virtual cutting path.

In some embodiments, the modular CNC system includes a carrying case. The module CNC system includes a CNC machine operable to fold into the carrying case. The carrying case includes a foam layer to protect the CNC machine. For example, and without limitation, the carrying case includes a rolling case, a crate, and other similar carrying devices.

In some embodiments, the CNC modular system includes a cleaning and/or surface preparation attachment. For example, and without limitation, the cleaning and/or surface preparation attachment includes a laser cleaning attachment, a laser peening attachment, a glass bead peening attachment, an adhesive (e.g., glue) deposit attachment, and/or a liquid cleaning attachment. In some embodiments, the CNC modular system includes a moving attachment. The moving attachment is operable to move the modular CNC system and/or move at least one component of the modular CNC system. For example, and without limitation, the moving attachment includes a suction component, a clamping component, and/or a flexure. The suction component is operable to attach the base to another system, apparatus, device, workpiece, and/or surface. The clamping component is designed to lock and release at least one component of the modular CNC system.

In some embodiments, the modular CNC system includes an information collection component. The information collection component includes a probing component, a coordinate measuring machine (CMM) component, an ultrasound scanning component, an infrared component, and/or an X-ray scanning component. In some embodiments, the information collection component is operable to collect metrology information. In some embodiments, the information collection component is operable to scan an external workpiece and detect fractures and related information (e.g., positioning).

In some embodiments, the modular CNC system includes an additive manufacturing component. The additive manufacturing component includes, but is not limited to, a fused filament fabrication component, a powder bed fusion component, a binder getting component, a material getting component, a directed energy deposition component, and/or a vat photopolymerization component.

In some embodiments, the modular CNC system includes a welding component. The welding component includes a metal inert gas (MIG) welding component, a stick welding component, a tig welding component, a plasma arc welding component, an electron beam component, a laser welding component, and/or a gas welding component. In some embodiments, the modular CNC system includes a drawing and/or marking component. The drawing and/or marking component includes a scribing component, an engraving component, a marking component, a scale layout component, and/or a glass scoring component. For example, and without limitation, the modular CNC system includes a pneumatic scribe, a marker, a positioning component, and/or a razor. In some embodiments, the modular CNC system further includes a PCB repair component or a composite repair component. In some embodiments, the modular CNC system further includes an attachment for household application including but not limited to lawn maintenance, and coffee making.

In some embodiments, the modular CNC system includes a beveling component, a multi-head tool, an imaging component, and a battery powered module. The beveling component includes a ball joint and/or an angle adjusting compass to improve rotation.

In some embodiments, the modular CNC system includes a height probing system. The height probing system includes capacitance based control of the torch-arm assembly relative to a workpiece and machine-base assembly. The modular CNC system includes a capacitive sensing component between the manifold and the torch adapter. Advantageously this enables continuous precise measurement of a height between a torch-tip and a base material. In some embodiments, the height probing system is gas back-pressure based and gas conductivity based.

In some embodiments, the modular CNC system includes an auto-torch lighting component. In some embodiments, the modular CNC system includes a sensor for monitoring a strength of attachment between the base and a workpiece and/or surface. For example, and without limitation, the sensor is designed to monitor the electromagnetic connection between the electromagnet in the base of the modular CNC device and a corresponding surface.

In some embodiments, the modular CNC system includes a global positioning component and an antenna. In some embodiments, the modular CNC system is designed for remote control via a remote device (e.g., tablet).

In some embodiments, the modular CNC system includes a plurality of grips to improve the transportation of a base of the modular CNC system. In some embodiments, the handle is removably attached. In some embodiment, the modular CNC system include a plurality of visual indicators. The visual indicators are operable to include an operating condition (e.g., on/off) of the system and the activity of the electromagnet.

In some embodiments, the modular CNC system includes an internal power supply, a battery backup, a universal serial bus (USB) C connector, a plurality of magnetic strips, a centering tip, a plasma module clamp, a frictionless stepper motor, and/or a homing board with limit switch. The modular CNC system further includes a flex cable, a vision assistance component, automated gas control, and a beveling attachment.

In some embodiments, the present invention includes a software platform. The software platform is designed for vision based cut tracing, audio-based adaptive feed rate, vision-based adaptive feed rate, an artificial intelligence component, and a pattern recognition component. The vision based cut tracing implements computer vision algorithms to perform a cut while tracing a feature on a workpiece. The audio based adaptive feed rate is designed to capture and analyze audio data produced by the modular CNC system to determine a cut quality and feed rate. The vision-based adaptive feedback component is designed to capture image data of a torch and determine cut quality. In some embodiments, the modular CNC system includes a large language model (LLM) to create a design based on user input (e.g., words, drawings).

In some embodiments, the modular CNC system is operable for military environments, metalworking, metal scrapping, manufacturing, robotic environments, automotive repair, oil rig fabrication, railcar service and repair, shipbuilding, equipment installation, aircraft maintenance, and construction.

In some embodiments, the modular CNC system includes a silver solder braze to combine stainless steel tubes to the torch head and brass torch adapter.

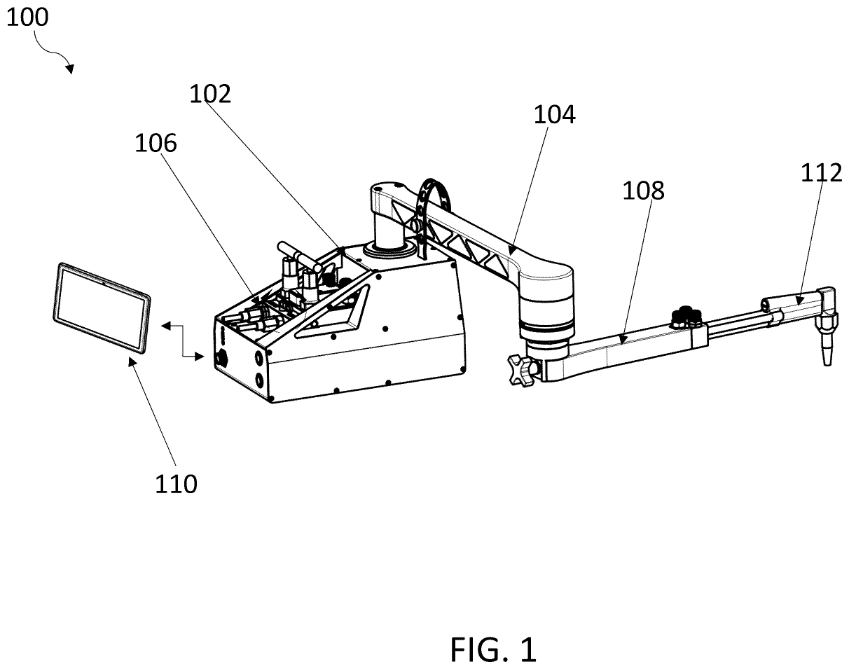

In some embodiments, as shown in FIG. 1, the modular CNC system 100 includes a base 102, a base arm assembly 104, a first attachment component including a first module 106 and a first arm 108, and a remote device 110. The first module 106 is removably attached to the base 102. The first arm 108 is removably attached to the base arm 104. The base arm assembly includes a base arm, a first joint motor, a first adapter, a second adapter, a second joint motor, a stepper motor, a vertical rail, and a vertical block. The base arm assembly is mounted to the vertical rail plate of a base of the modular CNC system. The joint motors includes at least one drive, at least one motor, at least one gearbox, and at least one bearing. The stepper motor contains a lead screw that is designed to move the entire arm assembly in a vertical direction. Alternatively, the modular CNC system includes an alternating current (AC) motor, a direct current (DC) motor, a pneumatic motor, a hydraulic motor, and/or a servo motor. The first arm 108 is operable to receive at least one tool 112. In some embodiments, the at least one tool is fixed to the first arm. In some embodiments, the at least one tool is removably attached to the first arm of the first attachment component.

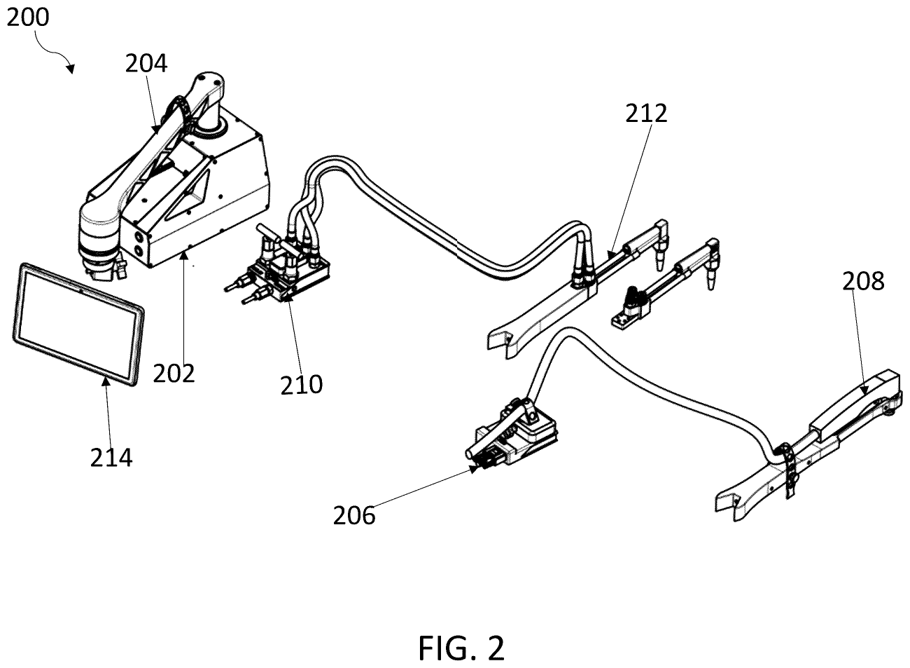

In some embodiments, as shown in FIG. 2, the modular CNC system 200 includes a base 202, a base arm assembly 204, a first attachment including a first module 206 and a first arm 208, a second attachment including a second module 210 and a second arm 212, and a controller 214. For example, and without limitation, the base arm 204 is removably attached to the base 202. The first attachment can include a plasma torch. The second attachment can include an oxy-fuel module and oxy-fuel torch. Alternatively, or additionally, the modular CNC system includes a welder, a scribing system, a beveling attachment, an additive manufacturing tip, a water jet attachment, a laser cutter, an engraver, a razor, a foam cutter, and other similar devices for manufacturing applications.

In some embodiments, the controller 214 is in a wired connection with the base, the base, the base arm, the first attachment, and the second attachment. In some embodiments, the controller is wirelessly connected (e.g., network communication) to the base, the base arm, the first attachment, and the second attachment. The first attachment and/or the second attachment are operable to attach to an end of the base arm. Advantageously, the first attachment and the second attachment are swappable to enable the modular CNC system to receive a variety of tools (e.g., plasma torch, oxy-fuel arm) as necessary for a cutting process. The controller includes a display screen, a plurality of buttons, at least one joystick, a universal serial bus (USB) port, and a High-Definition Multimedia Interface (HDMI) port. For example, and without limitation, in some embodiments, the controller includes an interactive interface (e.g., touchscreen) operable to receive user input. In some embodiments, the controller includes a remote device including touchscreen. Additionally, the controller is operable to connect (e.g. wired or wirelessly) to a second controller including physical control features (e.g., joystick, buttons).

In some embodiments, the first attachment and the second attachment are removably attached to the base arm via a taper lock. The modular CNC system includes a first joint motor including a male taper (e.g., adapter) designed to connect to a female taper positioned on each arm of the first attachment and the second attachment. Advantageously, the taper lock prevents vibration by properly aligning and securing the attachment arm via fastener.

In some embodiments, the modular CNC system includes a CNC oxyacetylene cutting machine including a selective compliance articulated robot arm (SCARA) platform. The modular CNC system further includes an attachment swap system including an arm and a module.

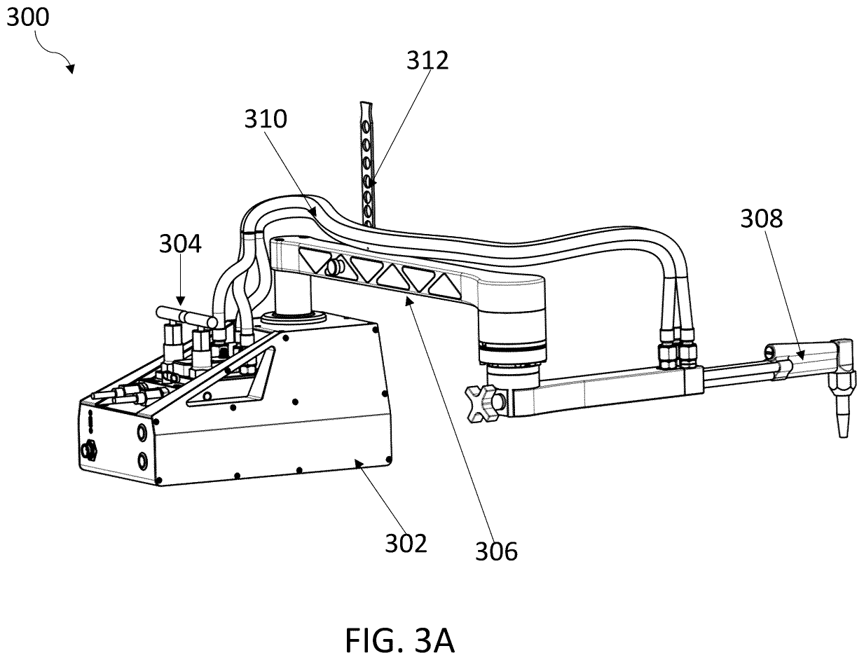

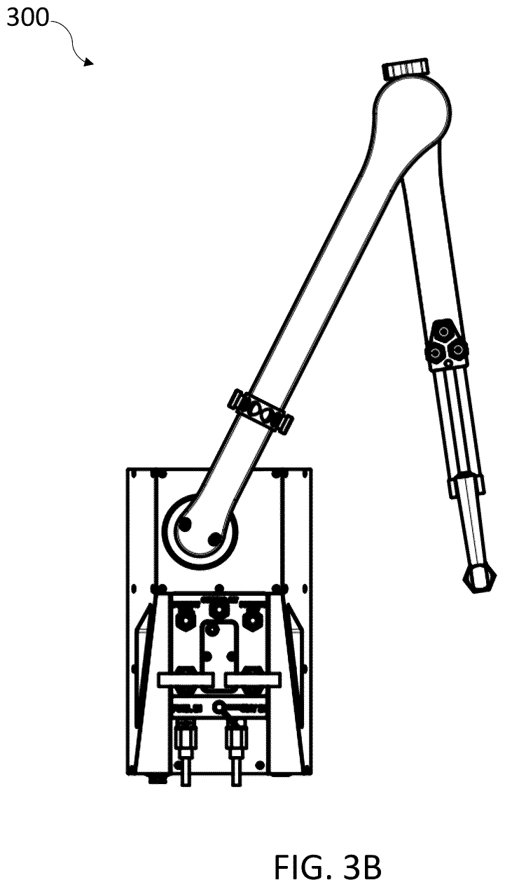

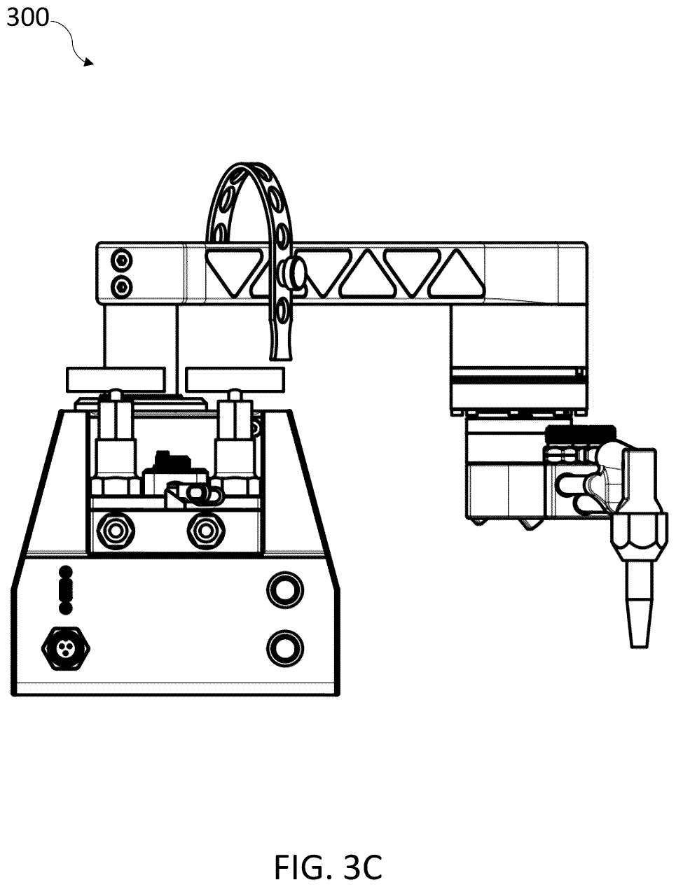

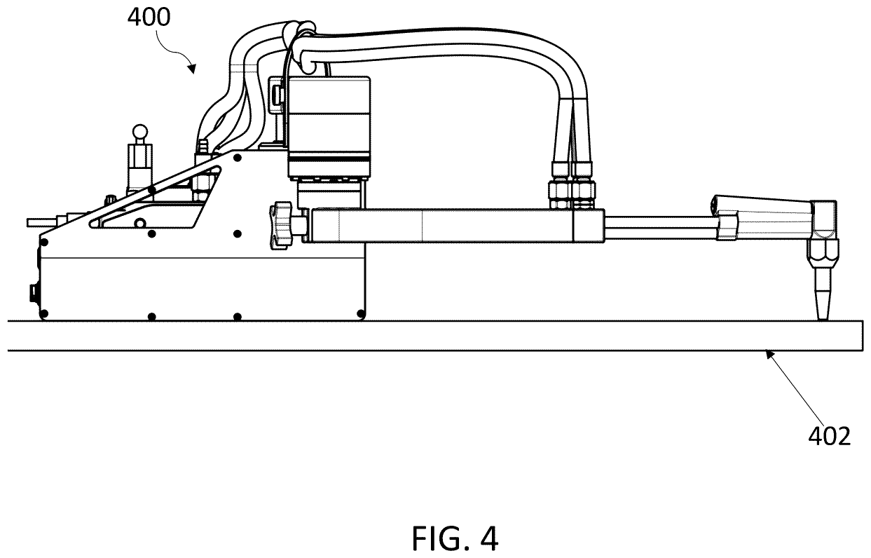

FIG. 3A illustrates a side perspective view of a modular CNC system according to one embodiment of the present invention. The modular CNC system 300 includes a base 302, at least one module 304, a base arm 306, and an arm attachment component 308. The at least one module 304 is removably connected to the base 302. The at least one module 304 is connected to the arm attachment component 308 via a plurality of cables 310 and gas hoses. The modular CNC system 300 includes at least one strap 312 designed to wrap around the plurality of cables 310 and attach the plurality of cables 310 to the base arm 306. FIG. 3B illustrates a top view of the modular CNC system shown in FIG. 3A. FIG. 3C illustrates a front view of the modular CNC system 300 shown in FIG. 3A. FIG. 4 illustrates a modular CNC system 400 attached to a surface 402 according to one embodiment of the present invention. For example, and without limitation, the modular CNC system 400 is attached to the surface 402 via a magnetic component (e.g., electromagnet) and/or a vacuum component.

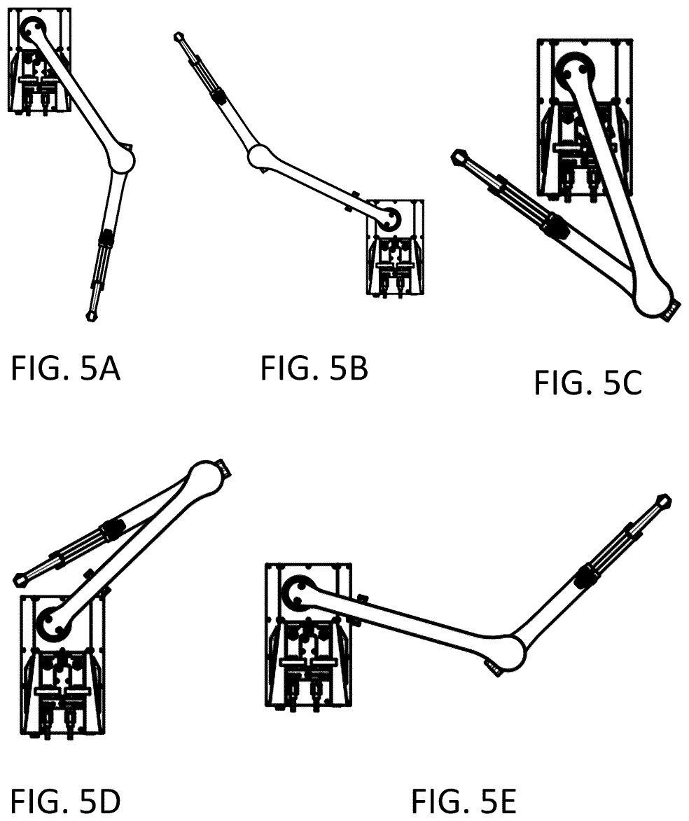

In some embodiments, the base arm and at least one attachment component are operable to move. FIGS. 5A-5E illustrate the base arm and the at least one attachment component in a plurality of positions. The base arm and the at least one attachment component are operable to extend away from the base and toward the base. The at least one attachment component is rotatably connected to the base arm. For example, and without limitation, the arm attachment component is operable to rotate in a circular motion relative to an attachment point between the base arm and the at least one attachment component.

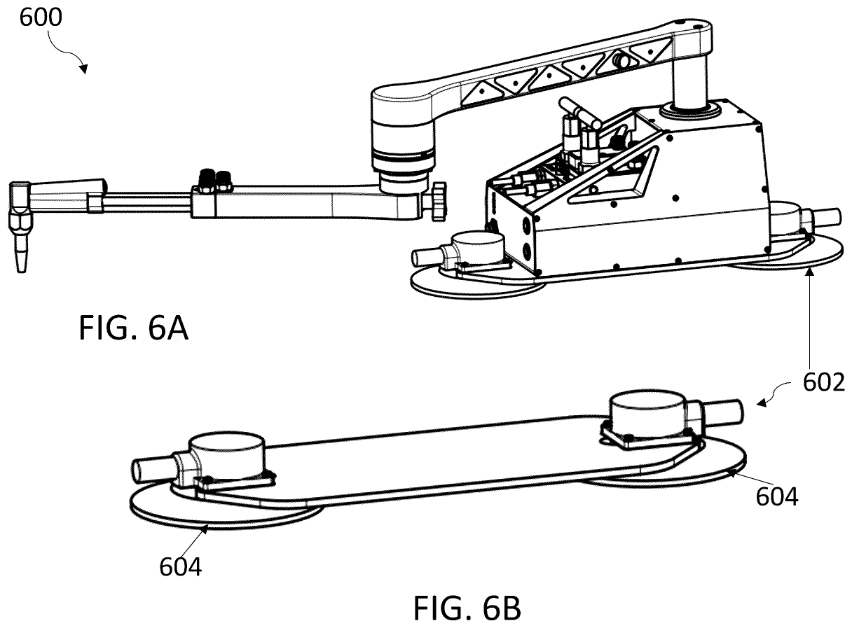

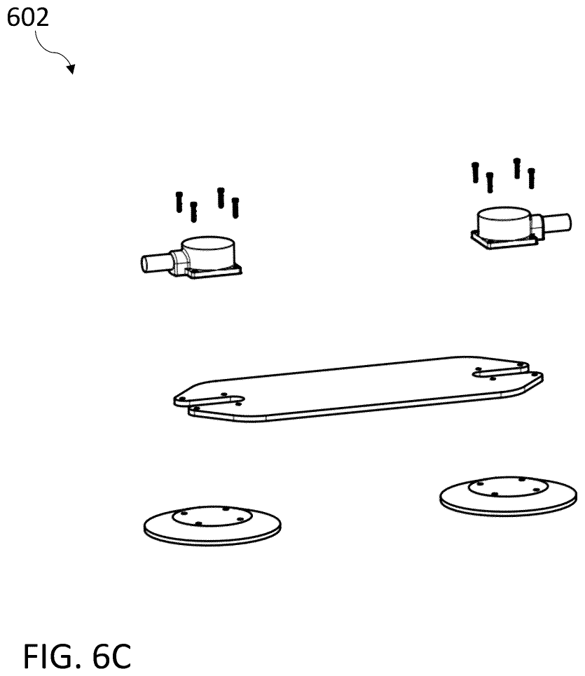

In some embodiments, as shown in FIGS. 6A-6C, the modular CNC system is operable to attach to a surface (e.g., workpiece) via a vacuum component. FIG. 6A illustrates a side perspective view of a modular CNC system 600 including a vacuum component 602. FIG. 6B illustrates the vacuum component 602 according to one embodiment of the present invention. The vacuum component includes at least two suction cups 604. In some embodiments, the vacuum component includes at least one suction cup. The at least two suctions cups are operable to mount onto a surface (e.g., steel plate). The vacuum component 602 includes a pump operable to remove air from the at least two suction cups 604 to create a sealed environment. FIG. 6C illustrates an exploded view of the vacuum component shown in FIG. 6B.

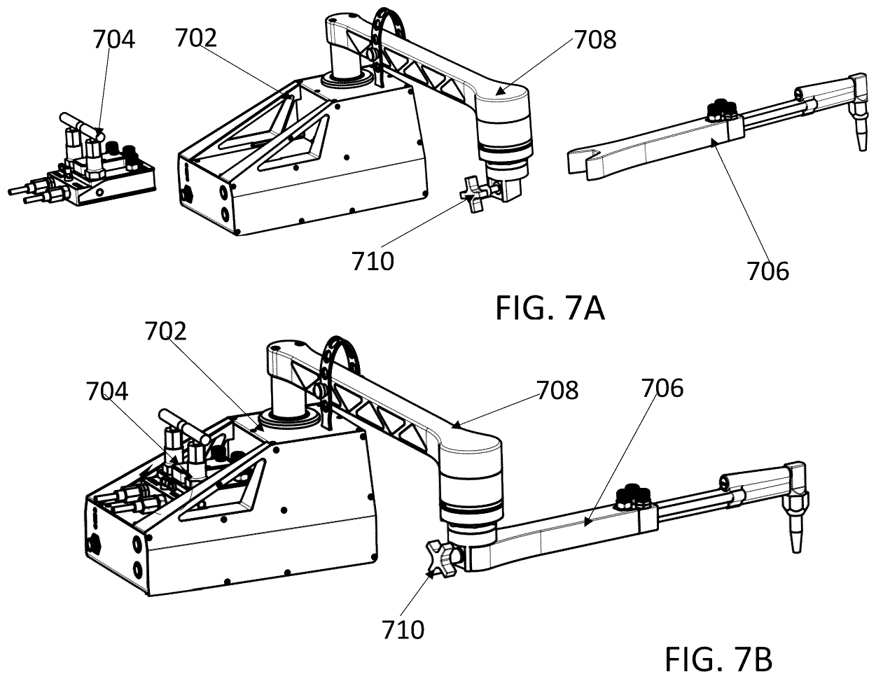

FIG. 7A illustrates a modular CNC system 700 including a modular CNC machine 702, a module 704, and a detached arm component 706 according to one embodiment of the present invention. FIG. 7B illustrates the modular CNC system shown in FIG. 7A including an attached module 704 and attached arm component 706. In some embodiments, the arm component 706 is removably attached to a base arm 708 of the CNC machine 702 via an attachment component 710.

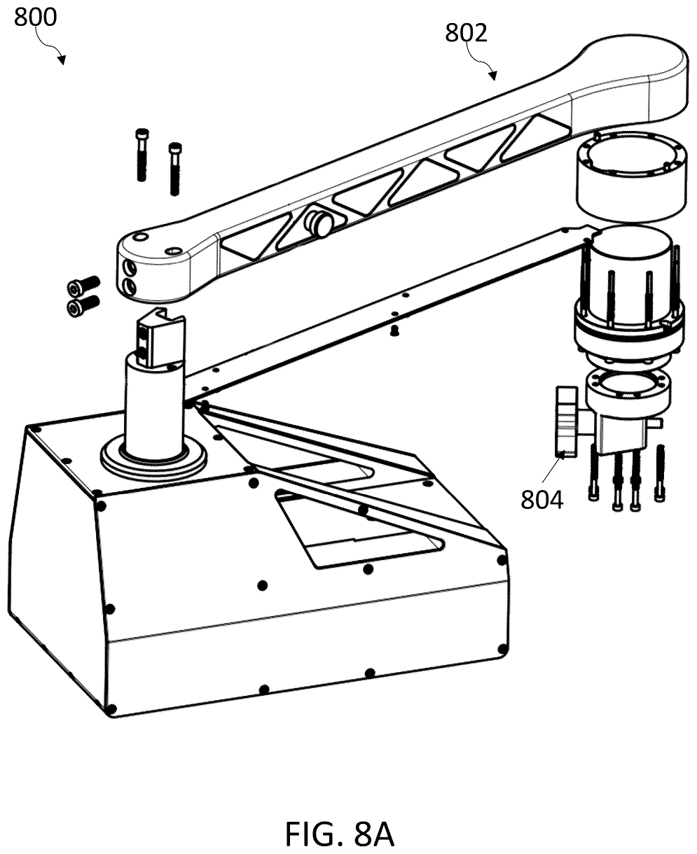

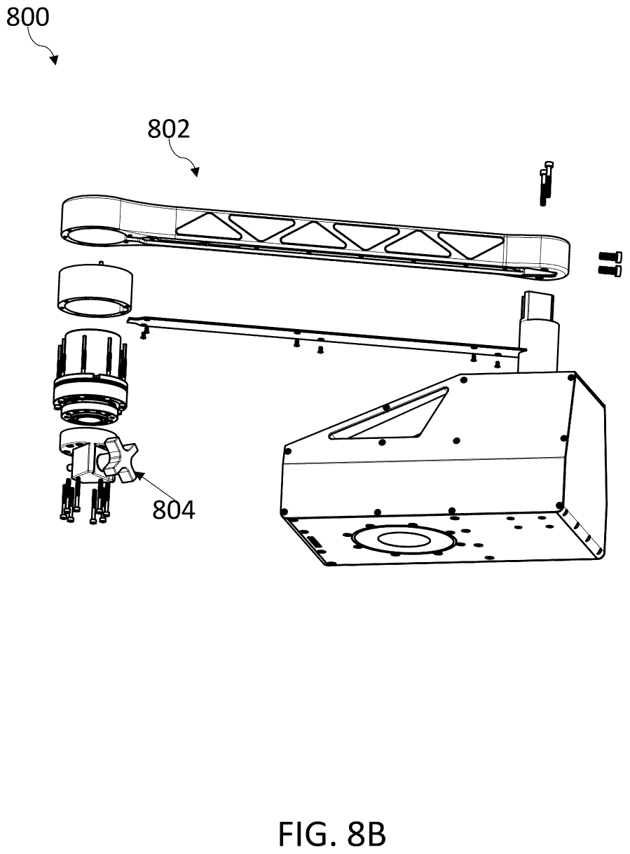

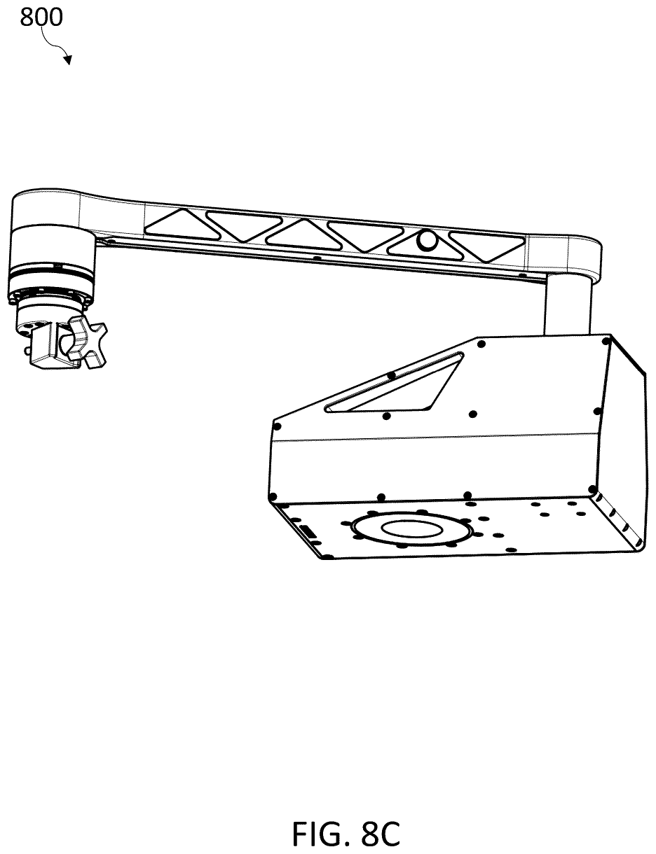

FIG. 8A illustrates a modular CNC system 800 including an exploded base arm 802 according to one embodiment of the present invention. The base arm 802 includes a joint adapter, a motor, and a quick attachment component 804. FIG. 8B illustrates a side perspective view of the modular CNC system shown in FIG. 8A. FIG. 8C illustrates a modular CNC system 800 including an assembled base arm 802.

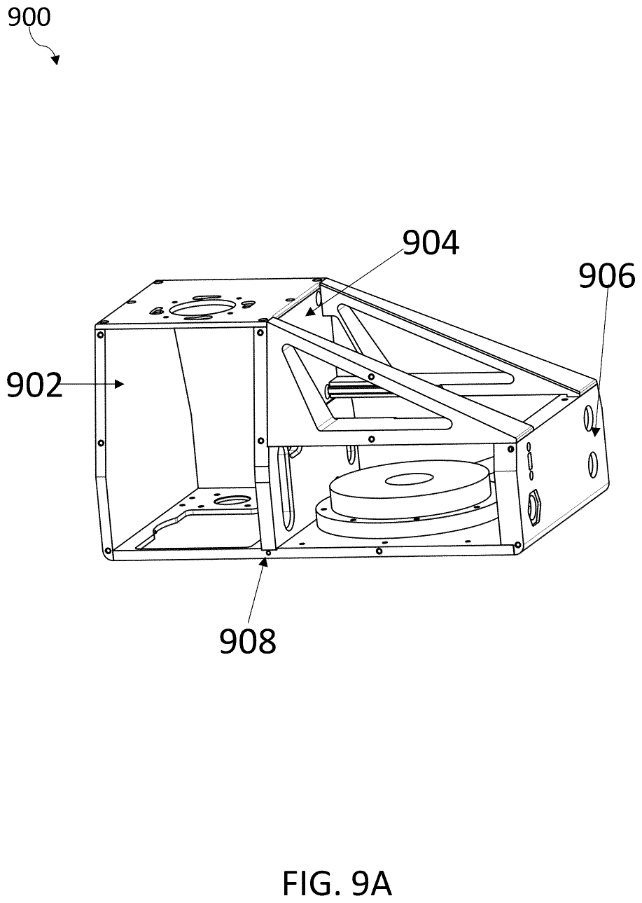

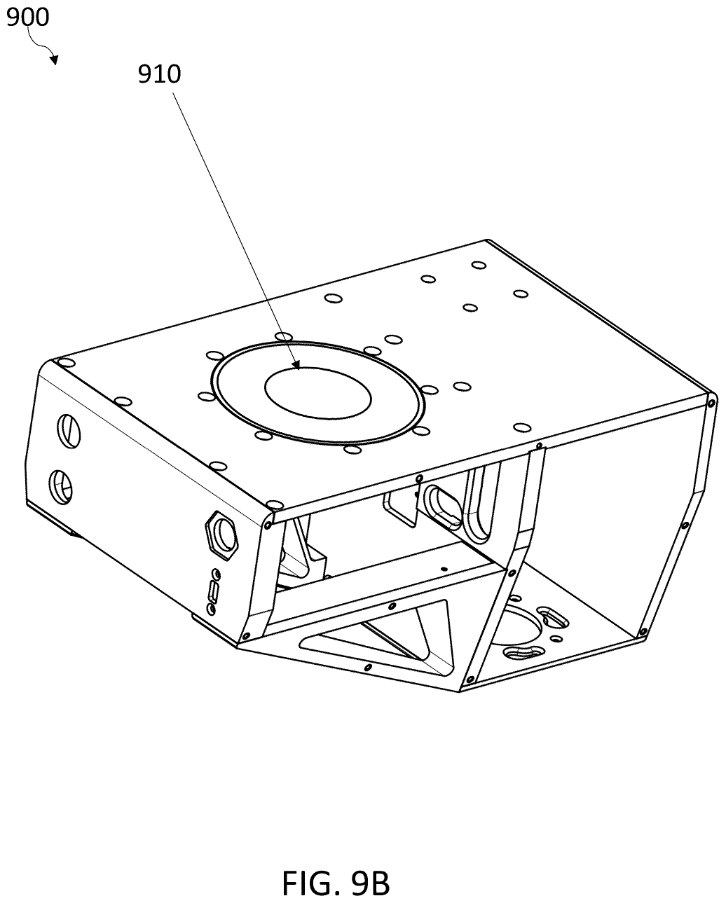

FIG. 9A illustrates a side perspective view of a base of a modular CNC system according to one embodiment of the present invention. The base 900 includes a front plate 902, a vertical rail plate 904, a rear vertical plate 906, and a bottom plate 908. In some embodiments, the base includes at least one plate, at least two plates, and/or at least three plates. The base can include at least one plate, at least one support member, at least one tube, at least one casting, at least one molding, and other similar components. FIG. 9B illustrates a bottom perspective view of the base 900 of the modular CNC system shown in FIG. 9A. The base includes an electromagnet 910 designed to create a magnetic attachment with another surface (e.g., workpiece). Advantageously, the electromagnet enables the modular CNC system to attach to a workpiece material without clamps. Yet another advantage, the electromagnet enables the modular CNC system to attach to a workpiece material in any orientation (e.g., horizontal or vertical). In some embodiments, the electromagnet is controlled via switch mounted on a rear of the base. Alternatively, or additionally, the modular CNC system includes a vacuum clamp designed to clamp onto aluminum or other non-ferrous material. For further example, and without limitation, the modular CNC system includes a manual clamp including a spring clamp, a screw clamp, and/or other mechanical fasteners. Alternatively, or additionally, the modular CNC system includes a counterweight designed to affixed the modular CNC system to a workpiece.

In some embodiments, the base of the modular CNC system include a front plate, a vertical plate, a bottom plate, a rear plate, an electromagnet, and a plurality of stiffeners. Advantageously, the modular CNC system is designed for vertical and/or upside-down cutting utilizing the stiffeners as mounting ports. For example, and without limitation, in some embodiments, the modular CNC system includes at least one strap connected to the plurality of stiffeners to provide additional support. The stiffeners provide structural reinforcement to the vertical rail plate and the entire modular CNC system.

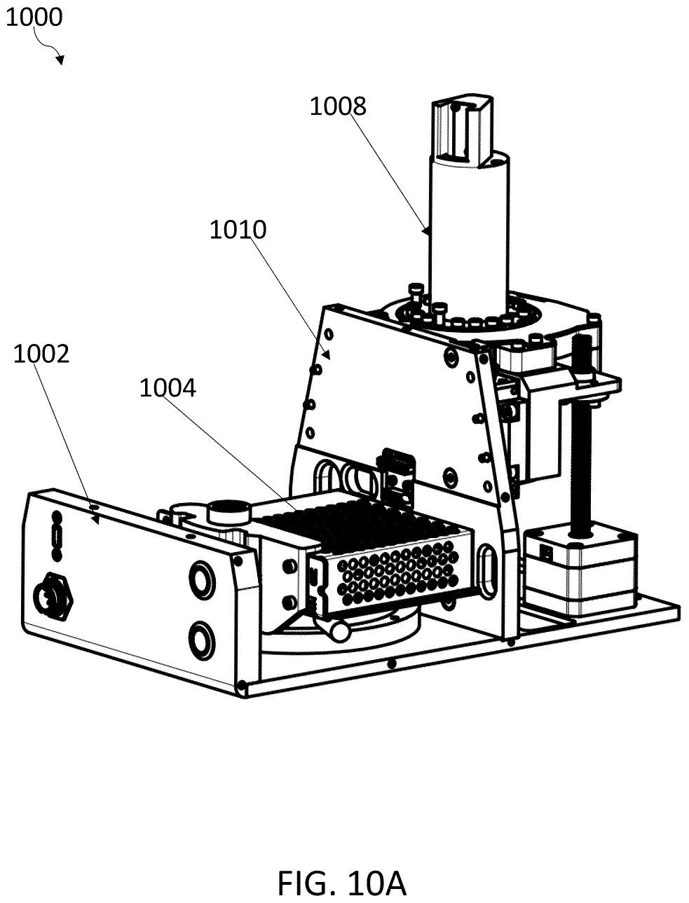

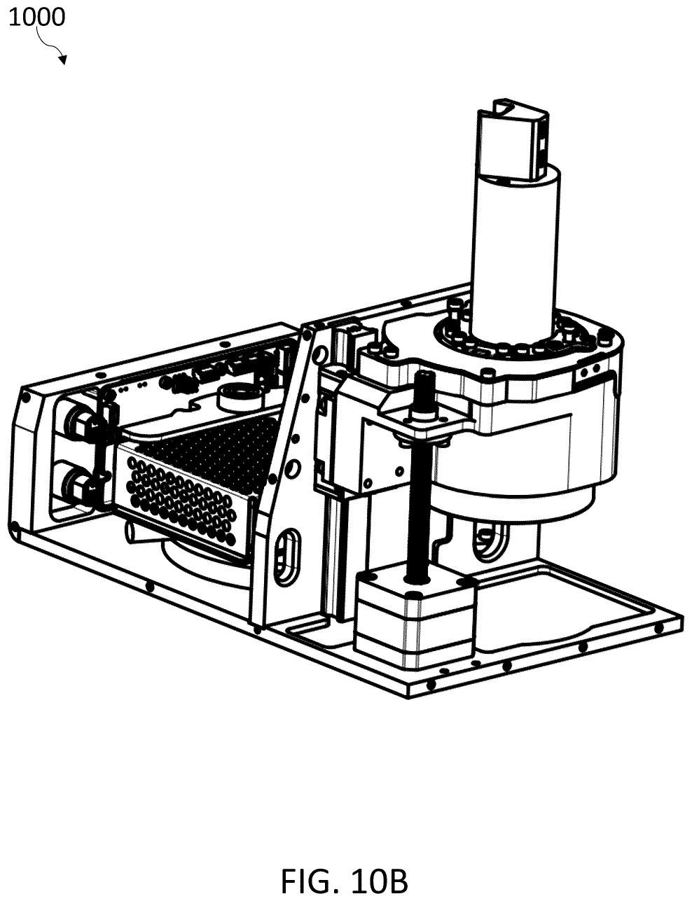

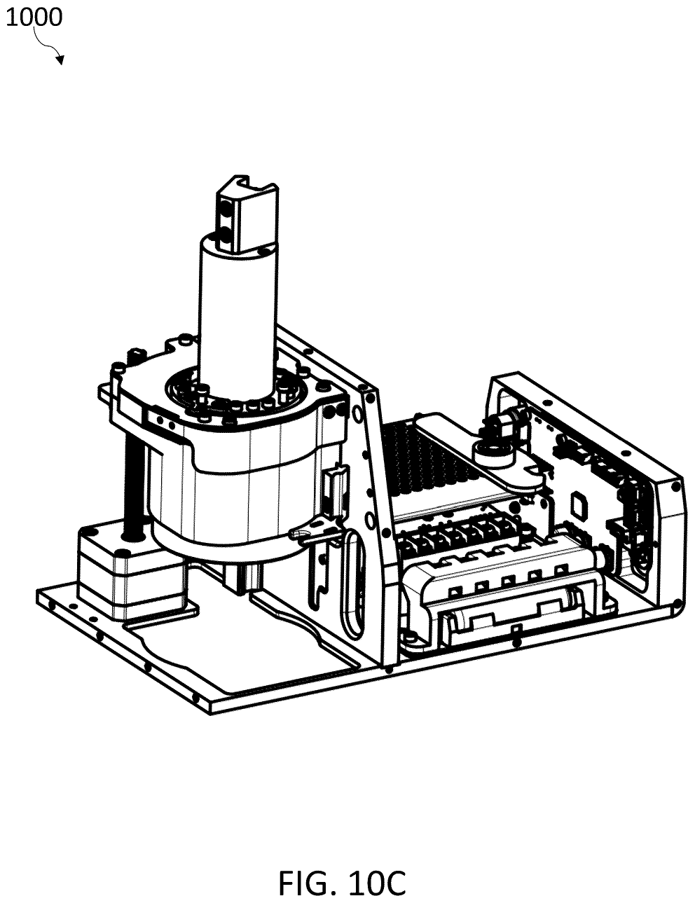

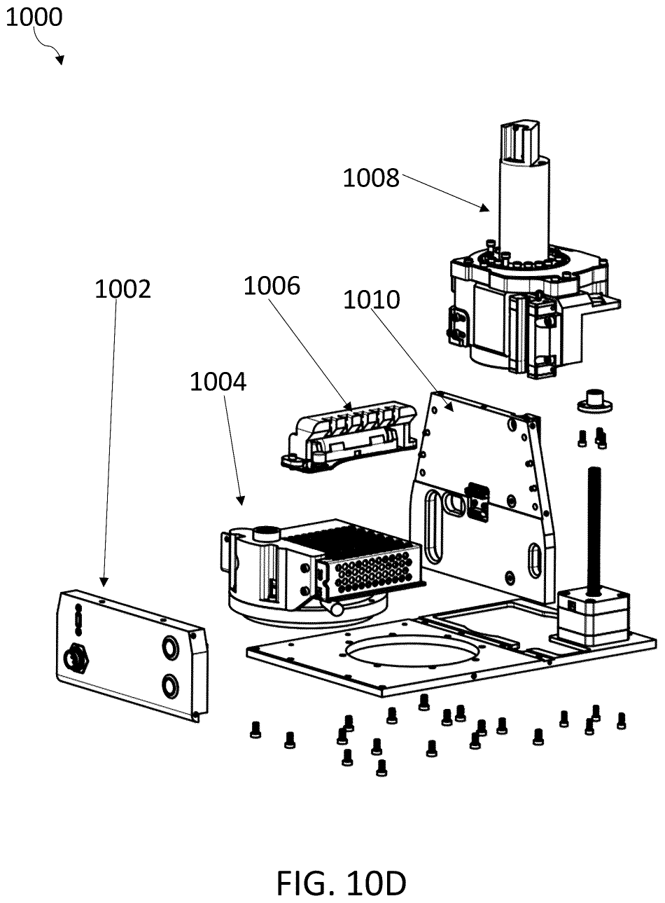

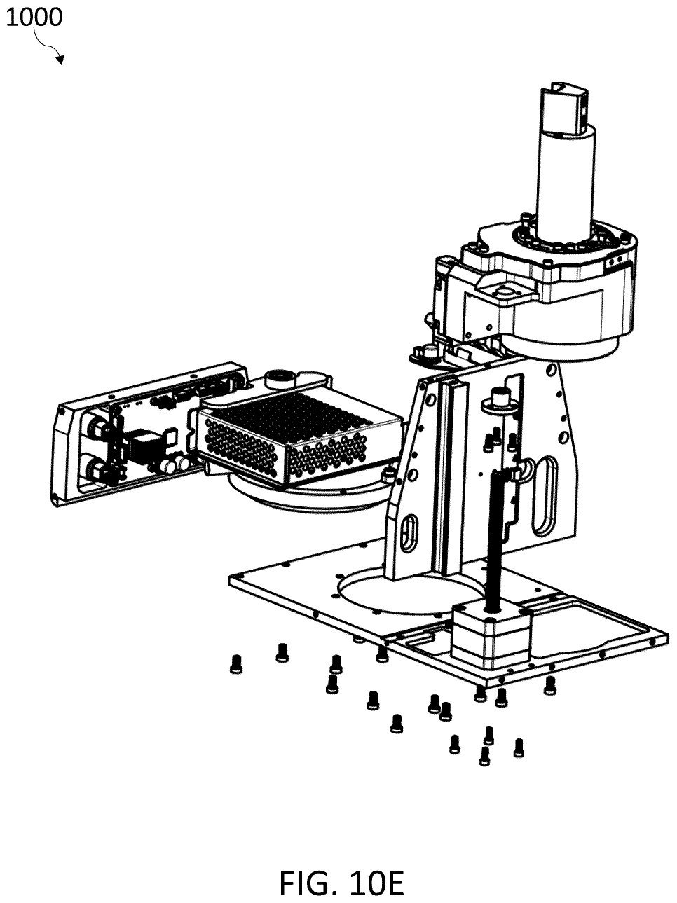

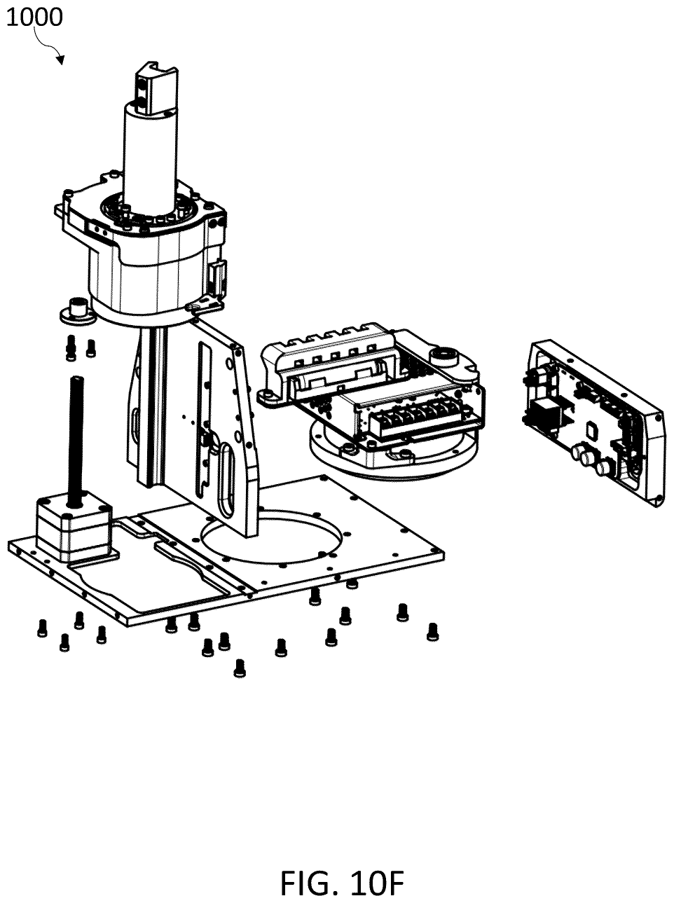

FIG. 10A illustrates an interior of a base of a modular CNC system according to one embodiment of the present invention. The base 1000 includes a rear plate 1002, a power supply assembly 1004, a battery holder 1006, a height control motor, a height control adapter 1008, and a vertical plate assembly 1010. FIG. 10B illustrates a rear perspective view of the base shown in FIG. 10A. FIG. 10C illustrates a side perspective view of the base shown in FIG. 10A. FIG. 10D illustrates an exploded view of the base shown in FIG. 10A. FIG. 10E illustrates a rear perspective view of the exploded view of the base shown in FIG. 10D. FIG. 10F illustrates a rear perspective view of the exploded view of the base shown in FIG. 10D.

In some embodiments, the modular CNC system includes a seal to protect against environmental elements (e.g., dirt). The top plate of the base includes a plurality of holes designed to receive screws and provide a locking mechanism for the base arm. Advantageously, the top plate enables the modular CNC system to be transported without the base arm swinging around. Yet another advantage of the modular CNC system includes keeping the base arm in an raised position even when the modular CNC system is powered off due to the locking mechanism of the top plate.

The modular CNC system includes a plurality of servo motors that provide power for actuating the base arm, the first attachment, and the second attachment. In some embodiments, a first motor powers the first attachment. The first motor is connected via an adapter to the arm of the first attachment. A second motor attaches to the first arm of the first attachment through a joint adapter and powers the first attachment. In some embodiments, a flex cable winds around a first motor to enable full rotation. For example, and without limitation, the motor includes a groove designed to receive the cable. The groove surrounds the motor such that the cable can move around the entirety of the motor. By wrapping around the motor, the modular CNC system prevents the cable from being pulled on or kinked. In some embodiments, the modular CNC system includes at least one cable guide.

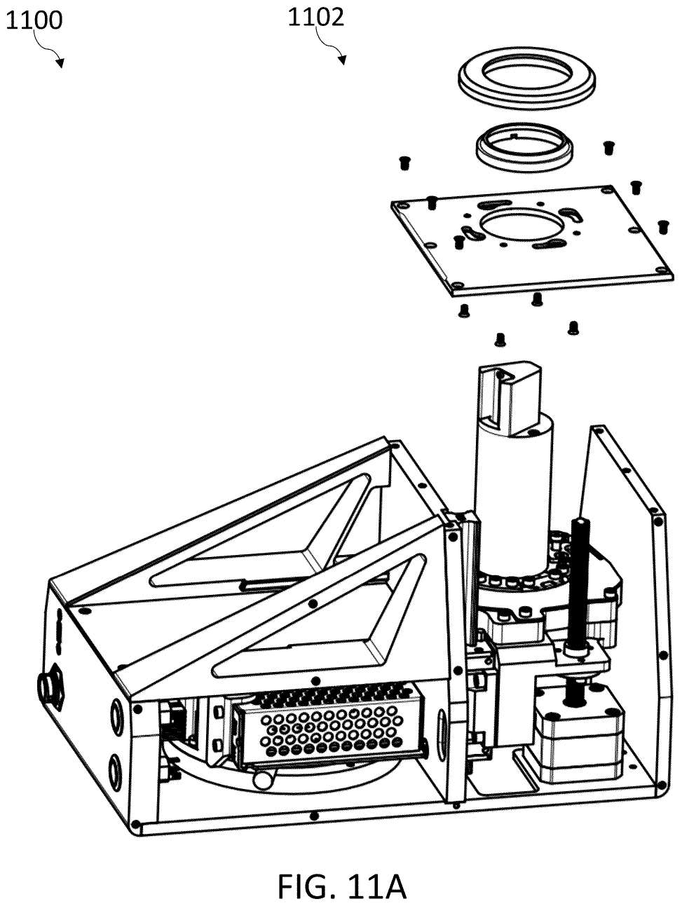

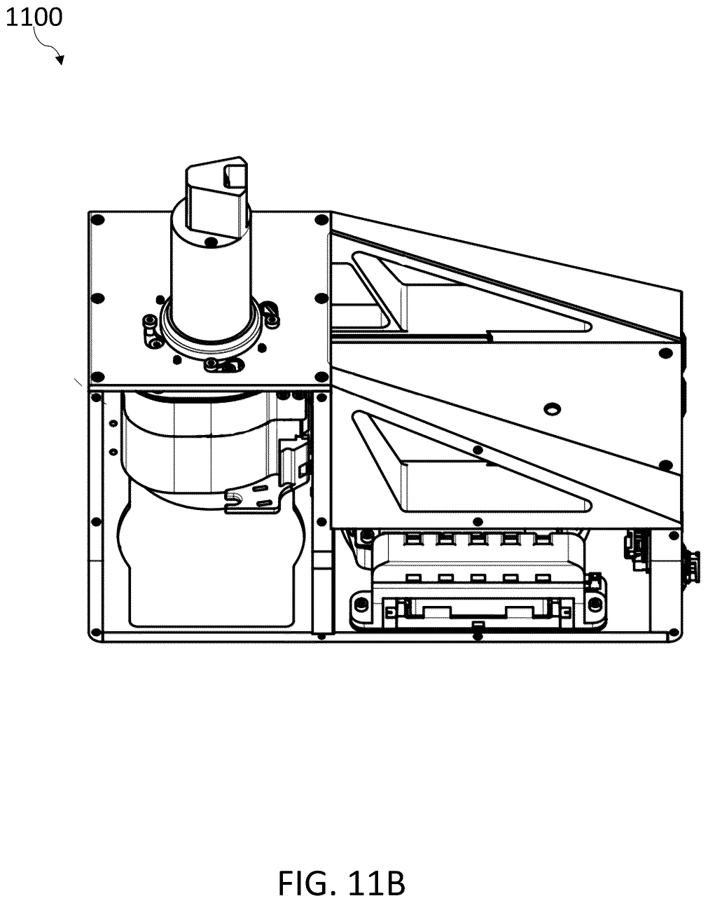

FIG. 11A illustrates a side perspective view of a base 1100 of a modular CNC system with an exploded view of a top plate assembly 1102 according to one embodiment of the present invention. The top plate assembly 1102 includes a top plate, a hydraulic seal, and a lockout wing. FIG. 11B illustrates a side perspective view of an assembly top plate assembly of the base shown in FIG. 11A. FIG. 11B illustrates a lockout position of the modular CNC system. When in the lockout position, a plurality of screws are locked through the top plate of the base 1100 of the modular CNC system.

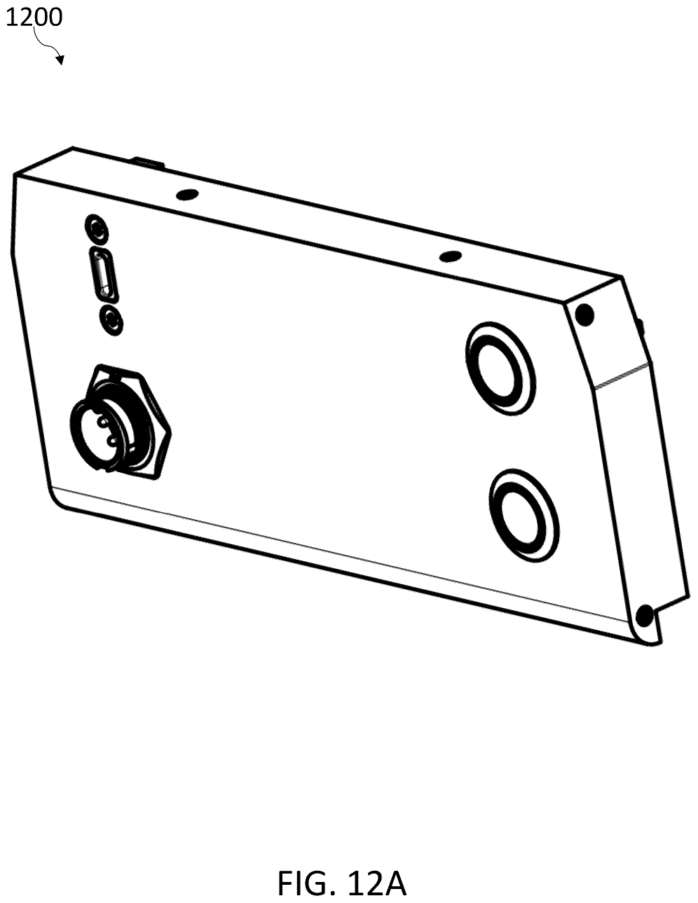

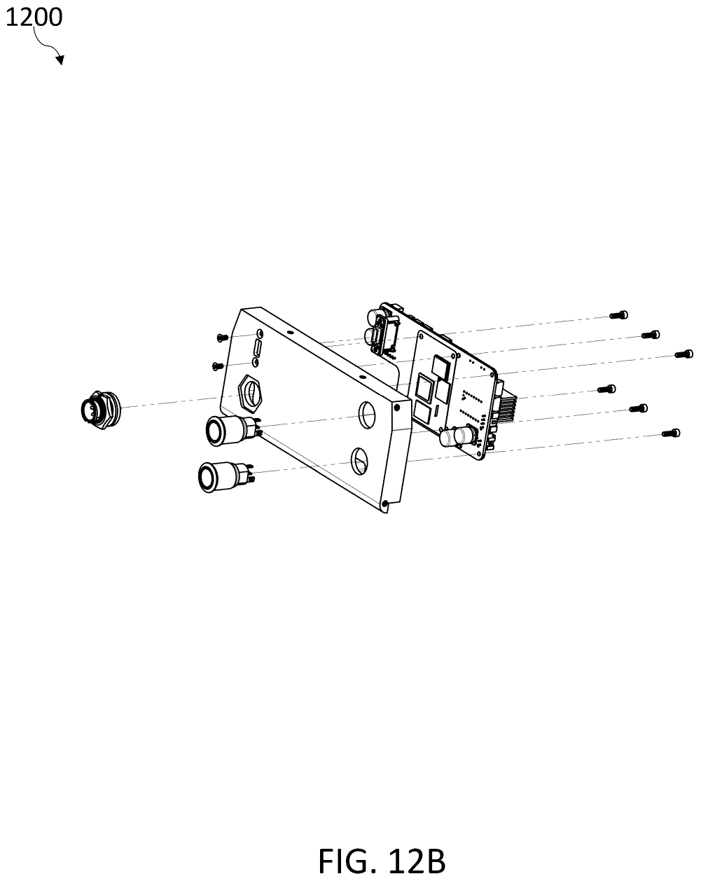

FIG. 12A illustrates a front perspective view of an assembly rear plate assembly 1200 of a base of a modular CNC system according to one embodiment of the present invention. FIG. 12B illustrates an exploded view of the rear plate assembly shown in FIG. 12A. The rear plate assembly includes a stop switch, a power cable connector, a USB-C port, and a magnetic base switch. The stop switch is operable to stop the power and operation of the CNC machine. The magnetic base switch is operable to power the electromagnet on and off.

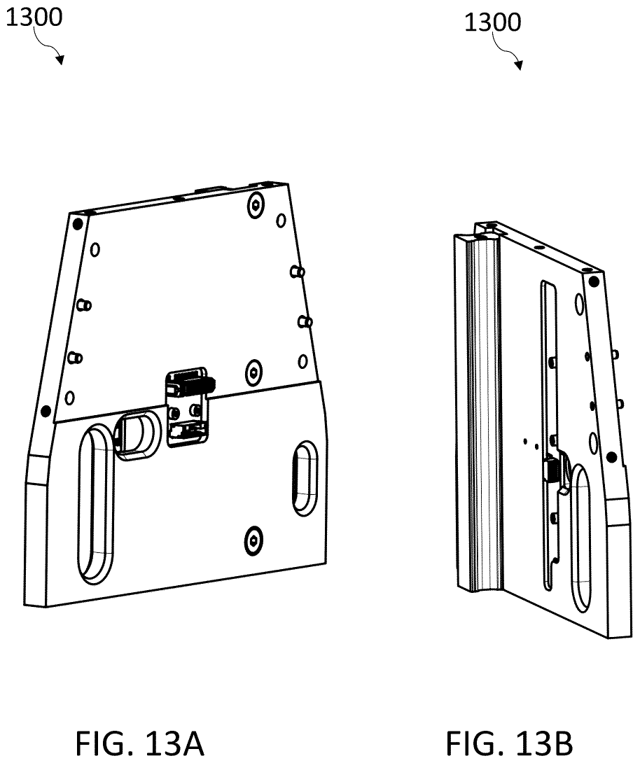

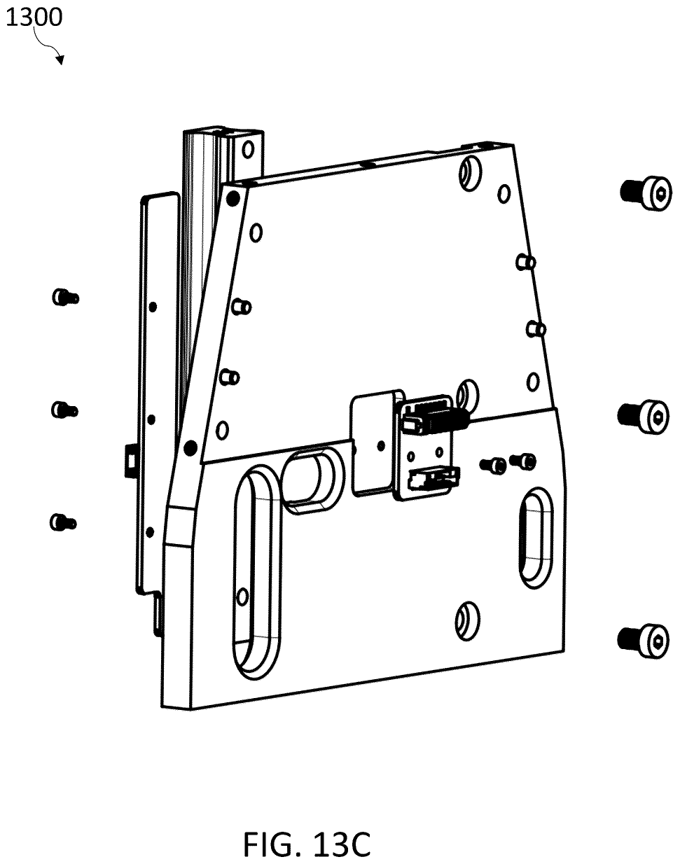

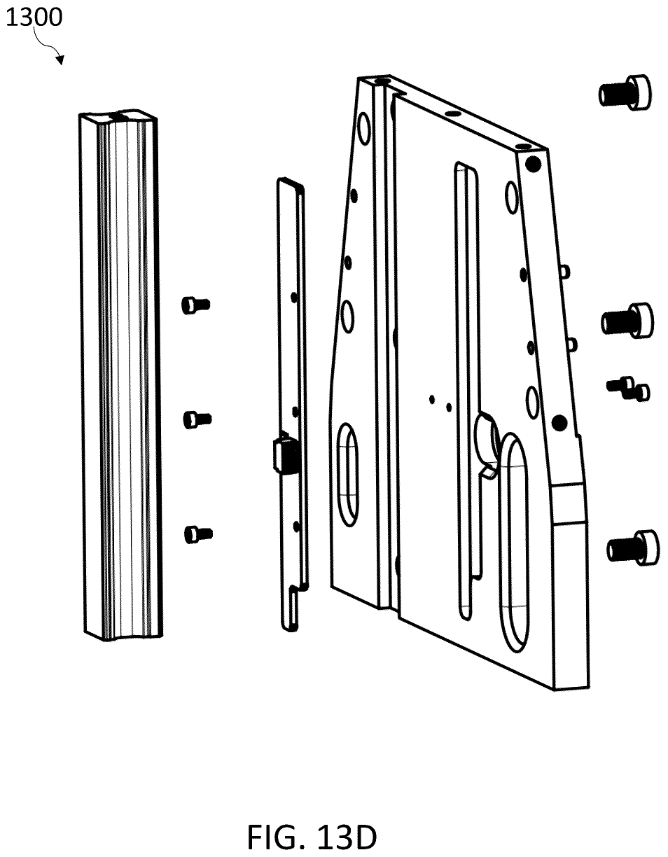

FIG. 13A illustrates a perspective view of a vertical plate assembly 1300 of a modular CNC system according to one embodiment of the present invention. The vertical plate assembly 1300 includes a plate, a linear rail with a plurality of fasteners, a switch homing board, and a quick connect circuit board. FIG. 13B illustrates a rear perspective view of the vertical plate assembly shown in FIG. 13A. FIG. 13C illustrates an exploded view of the vertical plate assembly shown in FIG. 13A. FIG. 13D illustrates an exploded view of the rear plate assembly shown in FIG. 13B.

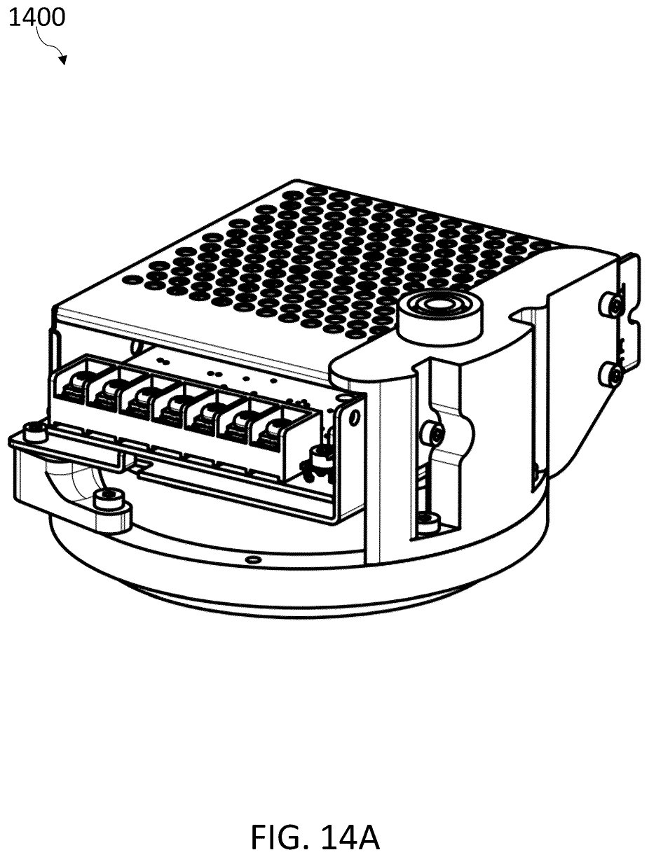

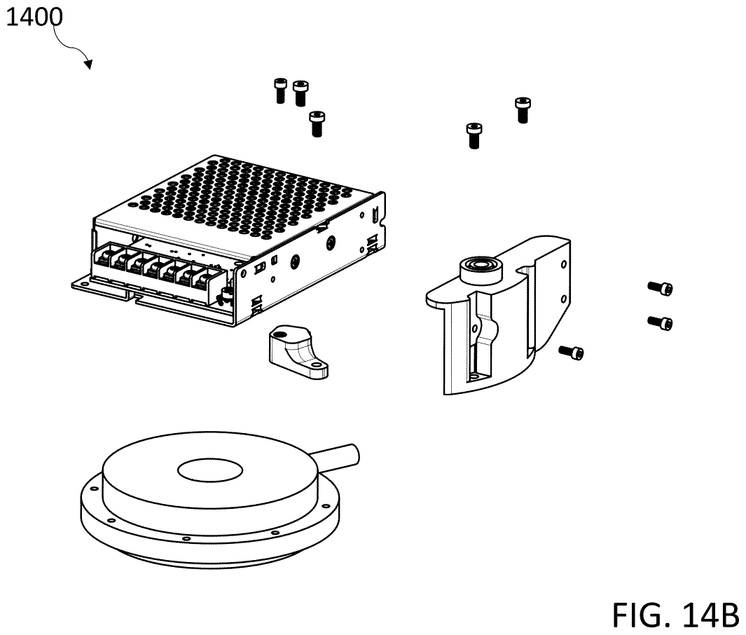

FIG. 14A illustrates a power supply assembly 1400 according to one embodiment of the present invention. The power supply assembly 1400 includes a magnet, a power supply, a plurality of fasteners, and a plurality of supports. The power supply includes a hole positioned on a top surface designed to receive a cam lock to push the power supply into a manifold. The power supply connects a power cable to a printed circuit board of the modular CNC system. FIG. 14B illustrates an exploded view of the power supply assembly shown in FIG. 14A.

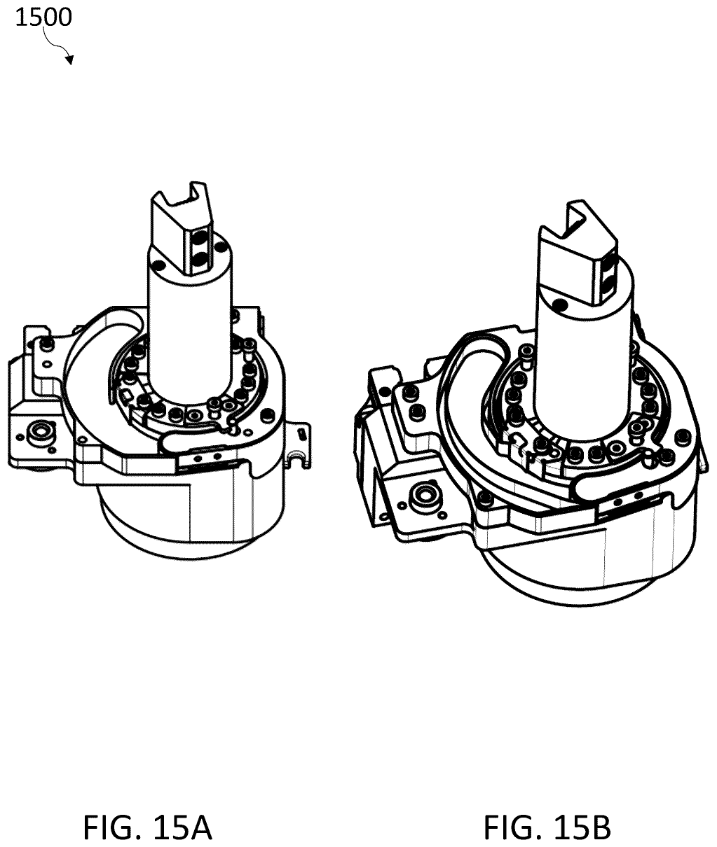

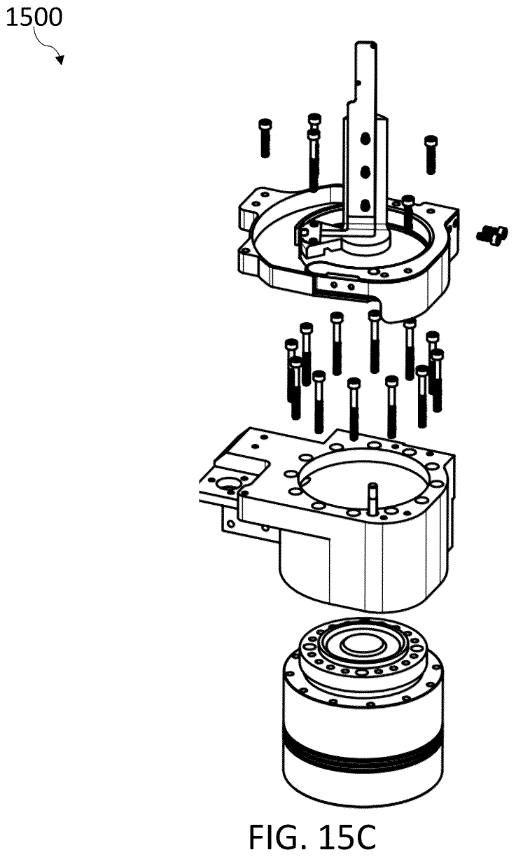

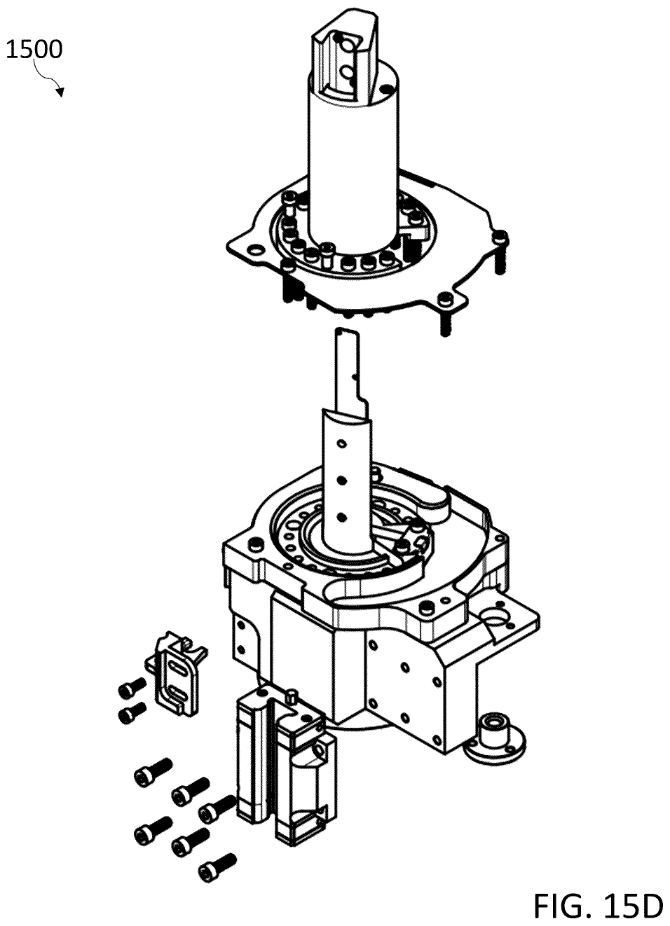

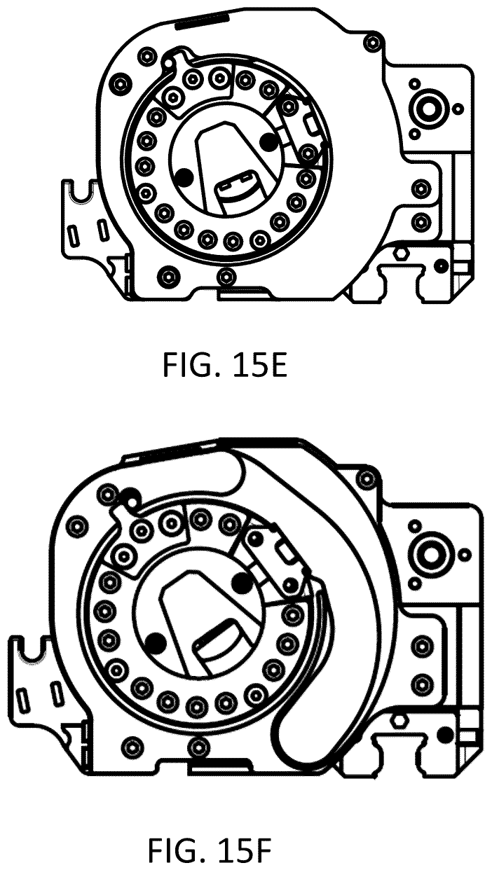

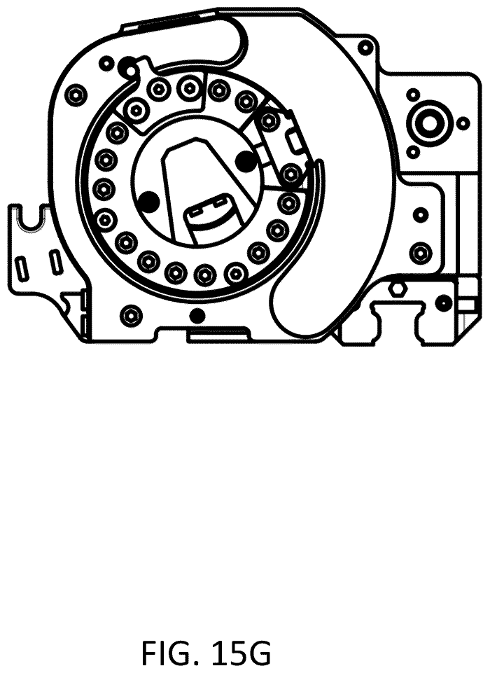

FIG. 15A illustrates a height control assembly 1500 according to one embodiment of the present invention. FIG. 15B illustrates the height control assembly in a stopped position. FIG. 15C illustrates an exploded view of the height control assembly shown in FIG. 15A. The height control assembly 1500 includes a closeout sheet, a motor cable management component, a stepper nut, a rail block, a flex cable retainer, a motor, and a hard stop component. The hard stop component includes a pin designed to prevent the motor from rotating a 360 degrees. For example, and without limitation, the hard stop component is positioned to stop the motor at a rotation of 355 degrees. Advantageously, this prevents the motor from continuously rotating, which would result in the stress and snapping of the flex cable. FIG. 15D illustrates a perspective view of the height control assembly shown in FIG. 15A. FIGS. 15E-15G illustrate a top view of the height control assembly shown in FIG. 15A.

In some embodiments, a stepper motor is connected to a height control assembly of the modular CNC system. The height control assembly is designed to move up and/or down as a leadscrew of the stepper motor is turned. Alternatively, the modular CNC system includes an alternating current (AC) motor, a direct current (DC) motor, a pneumatic motor, a hydraulic motor and/or a servo motor.

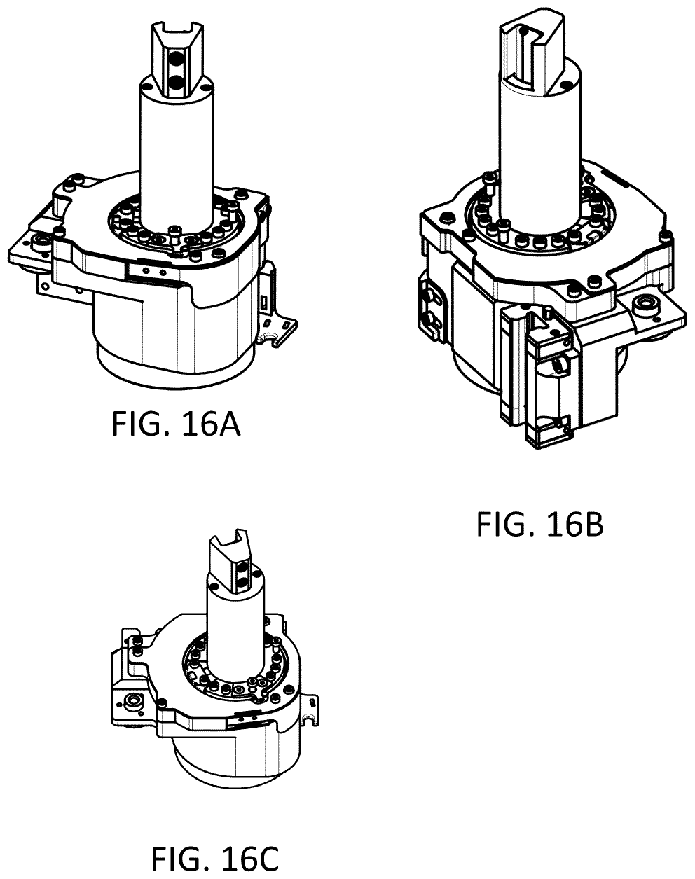

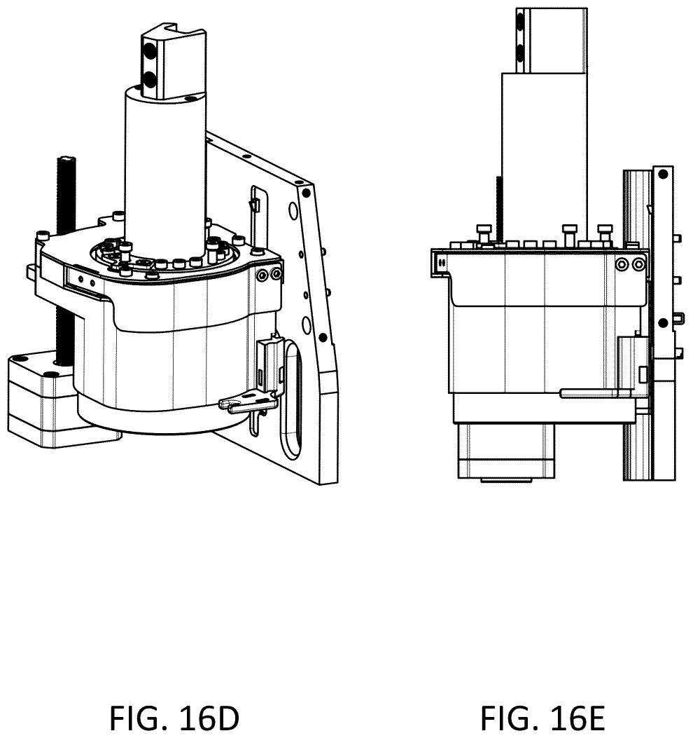

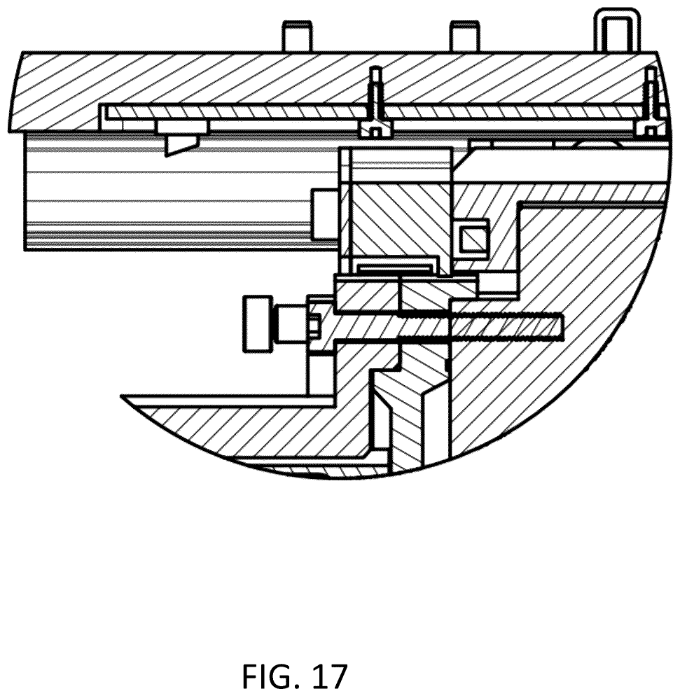

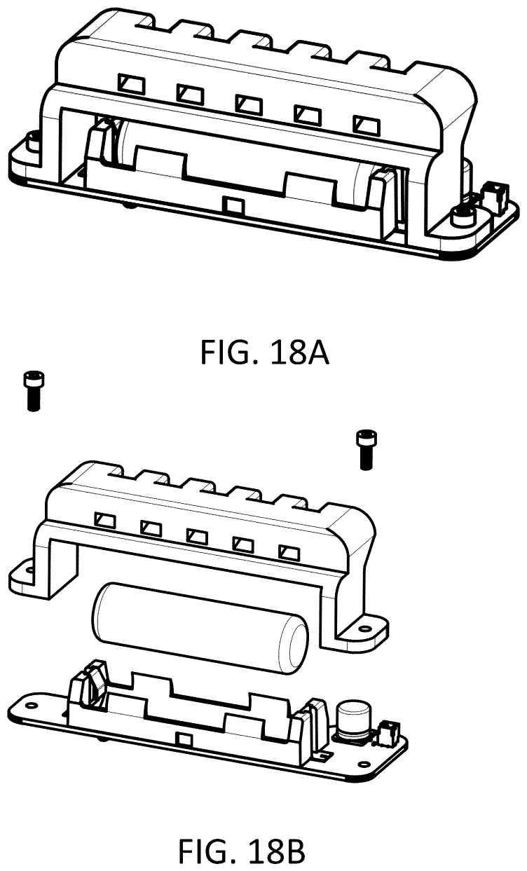

FIGS. 16A-16E illustrates a height control assembly of a modular CNC system according to one embodiment of the present invention. FIG. 17 illustrates a cross-sectional view of a limit switch homing point. The switch homing point is positioned on the vertical plate and is includes a sensor designed to send a signal to a printed circuit board of the modular CNC system based on a position of the height control assembly. FIG. 18A illustrate a battery holder according to one embodiment of the present invention. FIG. 18B illustrates an exploded view of the battery holder shown in FIG. 18A.

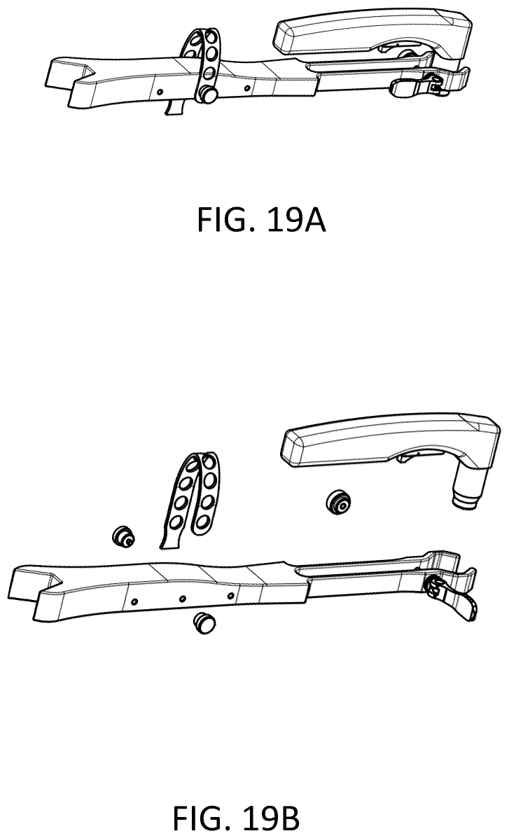

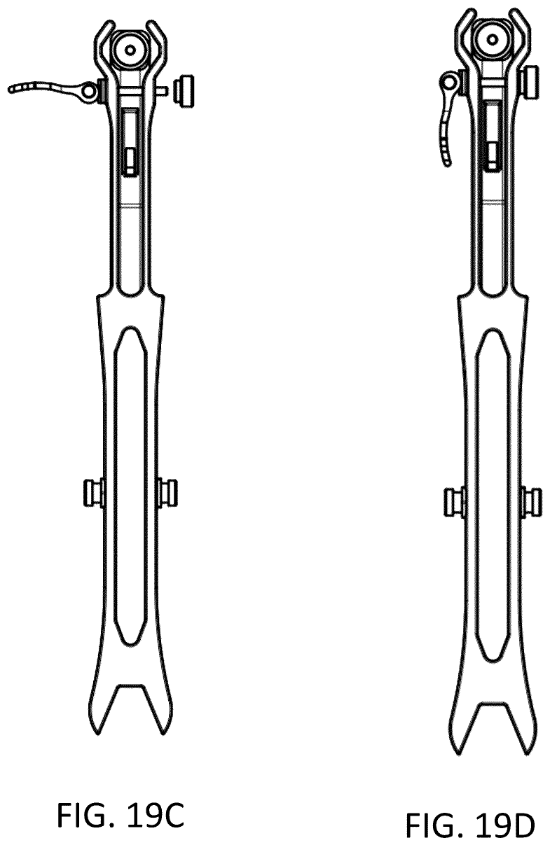

FIG. 19A illustrates a plasma arm component according to one embodiment of the present invention. The plasma arm attachment component includes a strap designed to clamp over cables corresponding to the plasma arm component. The plasma arm attachment component is operable to receive a plasma torch via a flexure on the plasma arm attachment component. The plasma arm component includes a cam lock and nut combination to tighten the flexure. FIG. 19B illustrates an exploded view of the plasma arm component. FIGS. 19C and 19D illustrates a bottom view of the plasma arm attachment component. In some embodiments, the modular CNC system includes an attachment component operable to affix the plasma torch to an end of the plasma tool.

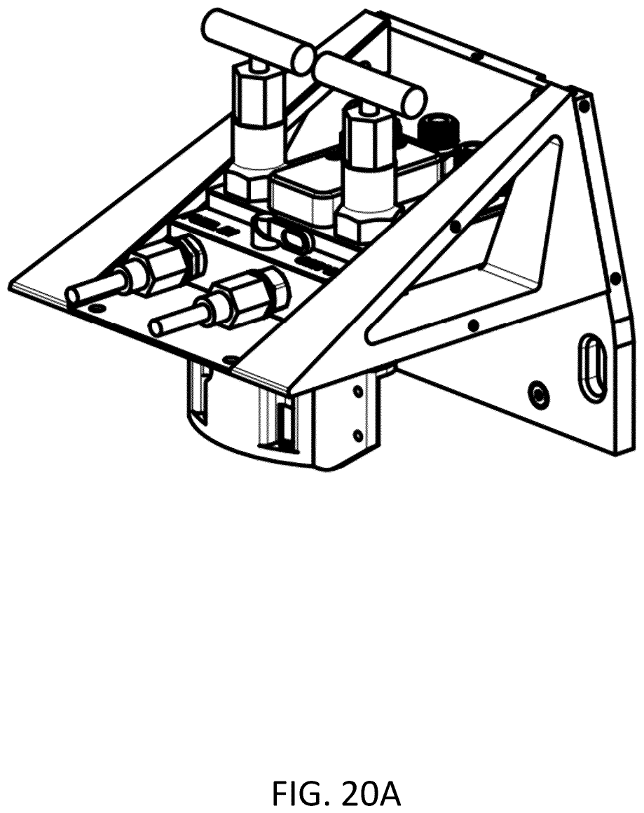

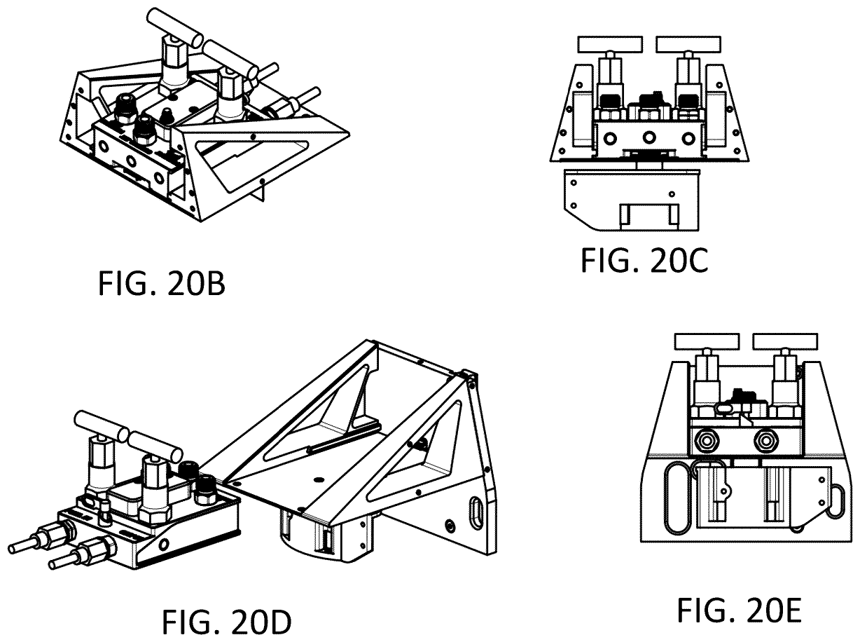

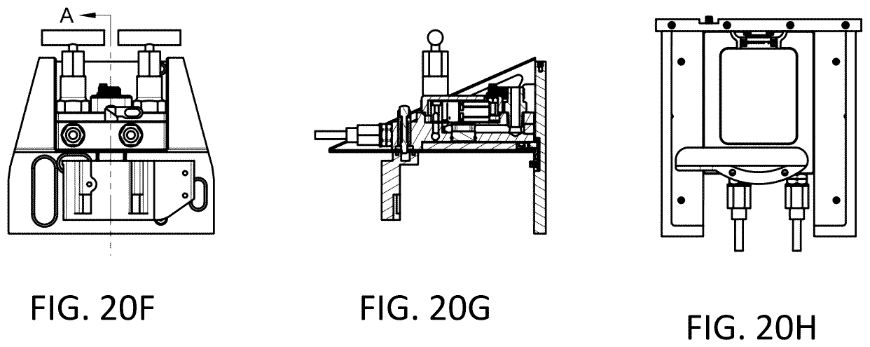

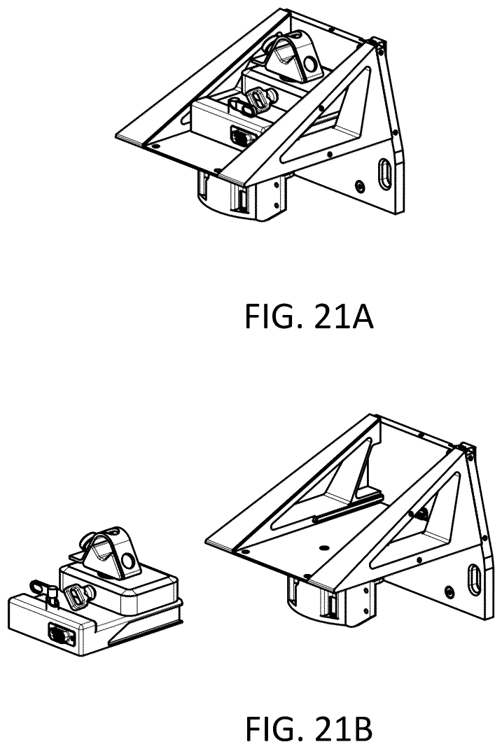

FIG. 20A illustrates a side perspective view of an oxy-fuel manifold assembly according to one embodiment of the present invention. FIG. 20B illustrates a rear perspective view of the manifold shown in FIG. 20A. FIG. 20C illustrates a rear view of the manifold shown in FIG. 20A. FIG. 20D illustrates an exploded view of the manifold shown in FIG. 20A. FIG. 20E illustrates a front view of the manifold shown in FIG. 20A. FIG. 20F illustrates a front view of the manifold shown in FIG. 20A including a cross-sectional line A-A. FIG. 20G illustrates a cross-sectional view of the manifold along cross-sectional line A-A shown in FIG. 20F. FIG. 20H illustrates a top view of the manifold shown in FIG. 20A. FIGS. 21A and 21B illustrates a manifold according to one embodiment of the modular CNC system.

In some embodiments, the oxy-fuel manifold assembly includes a ledge operable to receive an oxy-fuel module. The ledge is designed for a corresponding module to slide in and out of the base of the modular CNC system. Once a module is attached to the base, the module is electrically connected via an electrical connector to a main circuit board. Advantageously, the ledge ensures that the module is aligned with the electrical connector. The modular CNC system includes a cam lock designed to hold a module in place when connected to the base.

In some embodiments, the modular CNC system includes a plurality of stiffeners and a ledge to receive a module (e.g., oxy-fuel module, plasma module). The modular CNC system further includes a cam lock and plunger mechanism. For example, and without limitation, when turned, the cam lock moves the plunger into a hole in the base plate. In some embodiments, the modular CNC system includes a cam lock and a locking cutout. The cam lock is operable to insert into a cam lock hole positioned on the base. The base of the modular CNC system further includes a locking ledge to receive the locking cutout. In some embodiments, the modular CNC system includes a ledge operable to receive an oxy-fuel module and/or a plasma module. The ledge is operable for a module to slide in and out. The ledge further limits the degrees of freedom. Once a module is attached to the base, the module is electrically connected via an electrical connector to communicate with a printed circuit board. Advantageously, the ledge ensures that the electrical connector aligns with the corresponding connector on the base. The base further includes a cam lock to hold the module in place when connected to the base.

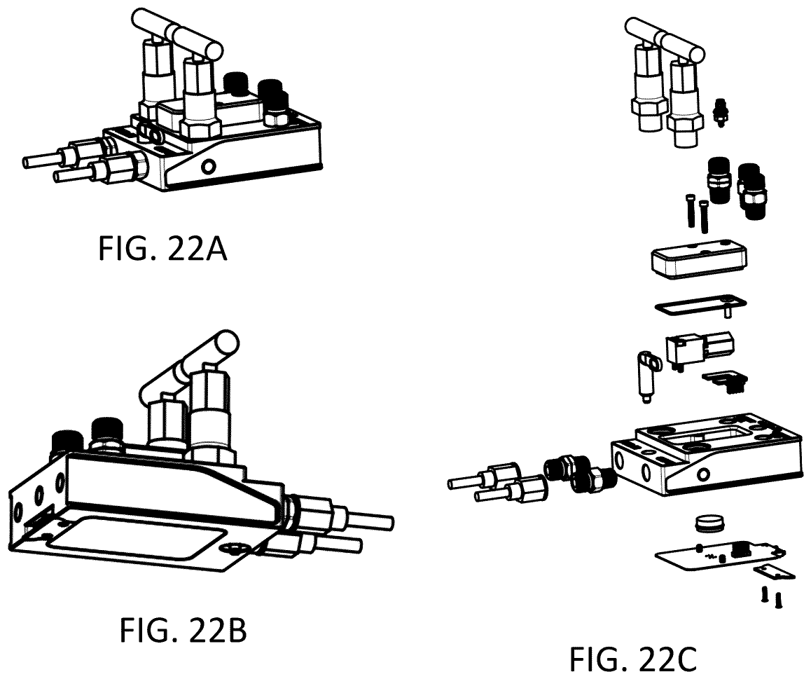

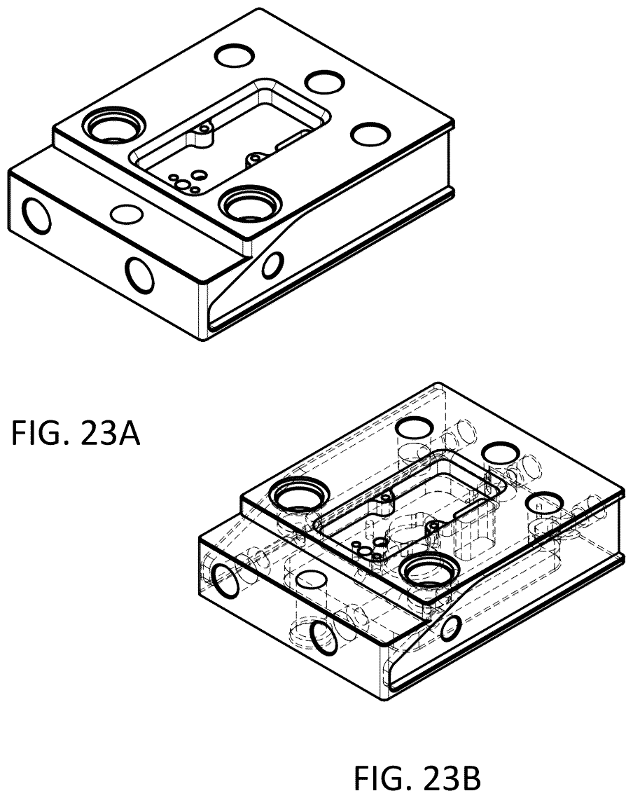

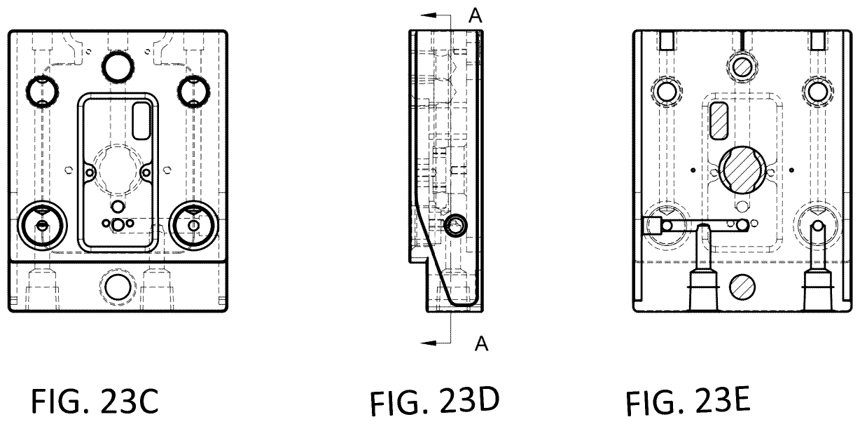

FIG. 22A illustrates an oxy-fuel manifold of a modular CNC system according to one embodiment of the present invention. FIG. 22B illustrates a side perspective view of the oxy-fuel manifold shown in FIG. 22A. FIG. 22C illustrates an exploded view of the oxy-fuel manifold shown in FIG. 22A. FIG. 23A illustrates an oxy-fuel manifold according to one embodiment of the modular CNC system. FIG. 23B illustrates a transparent view of the oxy-fuel manifold shown in FIG. 23A. The oxy-fuel manifold is operable to determine a pressure in a cutting attachment, control an opening in a solenoid value, and control the temperature and pressure during preheating and other cutting and metalworking processes. FIG. 23C illustrates a top view of the manifold shown in FIG. 23B. FIG. 23D illustrates a side view of the manifold shown in FIG. 23B including a cross-sectional line A-A. FIG. 23E illustrates a view of the manifold shown in FIG. 23B along cross-sectional line A-A.

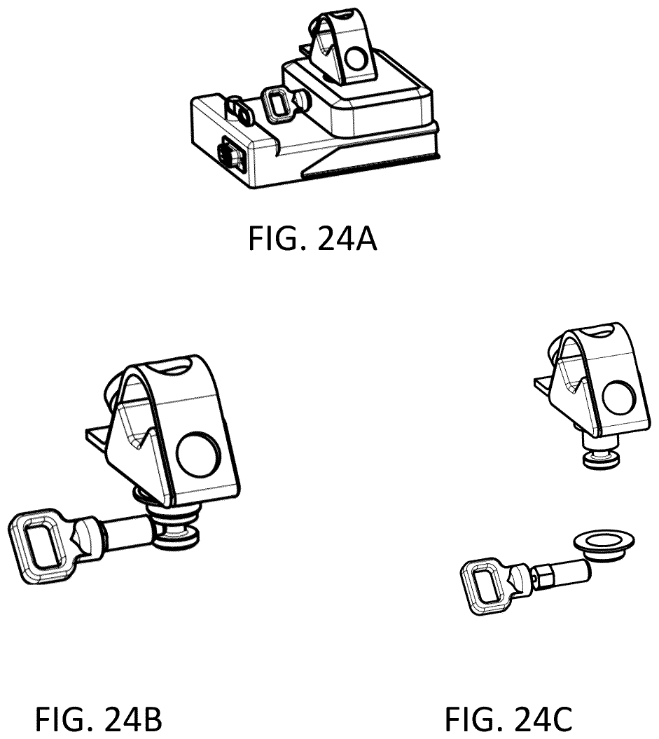

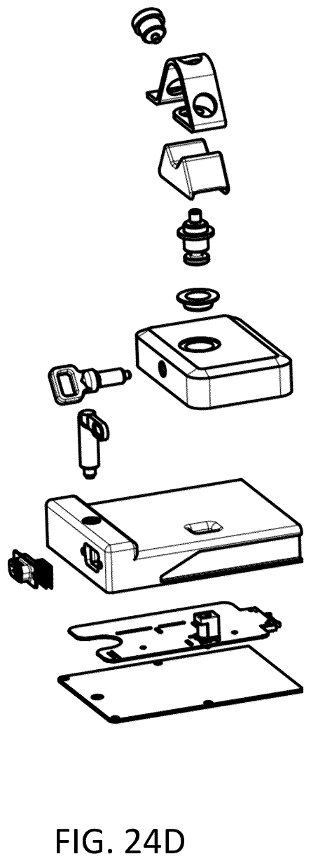

FIGS. 24A, 24B, and 24C illustrate a plasma manifold for a modular CNC system according to one embodiment of the present invention. FIG. 24D illustrates an exploded view of the plasma manifold shown in FIG. 24A. The plasma manifold is operable to attach to a base of a modular CNC system via an attachment component (e.g., cam lock). The plasma manifold is operable to connect to a printed circuit board positioned on or within the base of the CNC modular system. The plasma manifold is further operable to receive a plasma cable. The plasma manifold is designed to allow for a top block of the plasma manifold to sit at a fixed height while rotating.

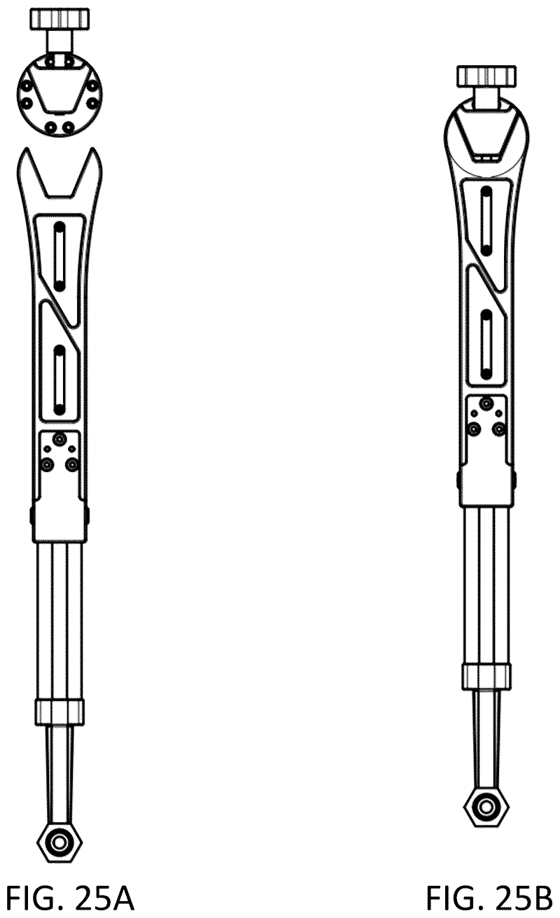

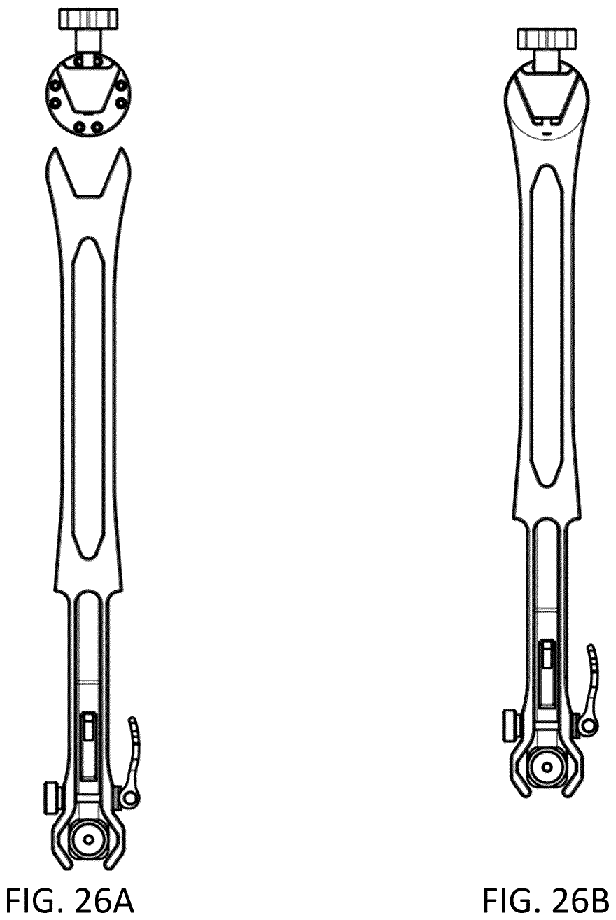

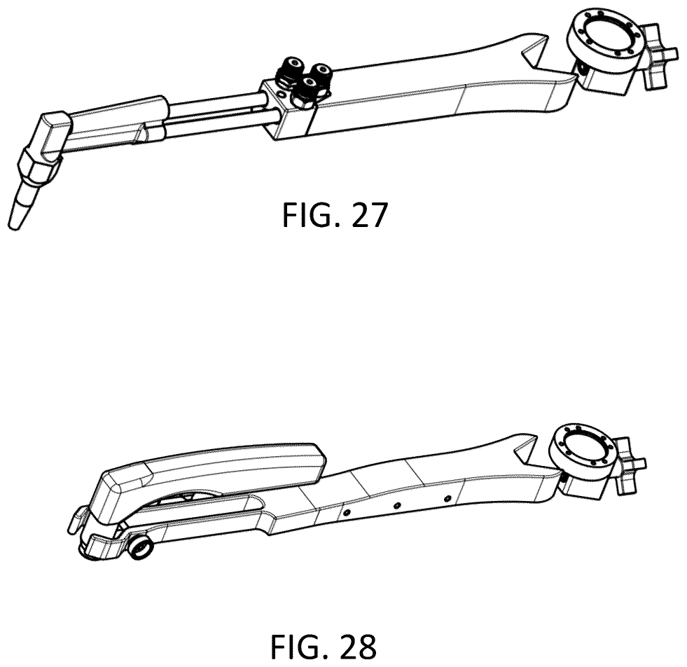

FIGS. 25A and 25B illustrate an arm attachment component and a quick attachment component according to one embodiment of the present invention. FIGS. 26A and 26B illustrate an arm attachment component and quick attachment component according to one embodiment of the present invention. FIG. 27 illustrates an oxy-fuel component, an arm component, and a quick attachment component according to one embodiment of the present invention. FIG. 28 illustrates an exploded view of a plasma torch, an arm component, and a quick attachment component according to one embodiment of the present invention. The arm component includes an integrated flexure operable to receive and clamp the plasma torch. For example, and without limitation, the plasma torch includes a diameter of at least 1 inch, at least 2 inches, at least 3 inches, or other torches of varying sizes. In some embodiments, the arm attachment component includes an ohmic sensor for sensing height. The arm attachment component further includes a cam lock and a nut to loosen and/or tighten the flexure to clamp a plasma torch or an oxy-fuel component.

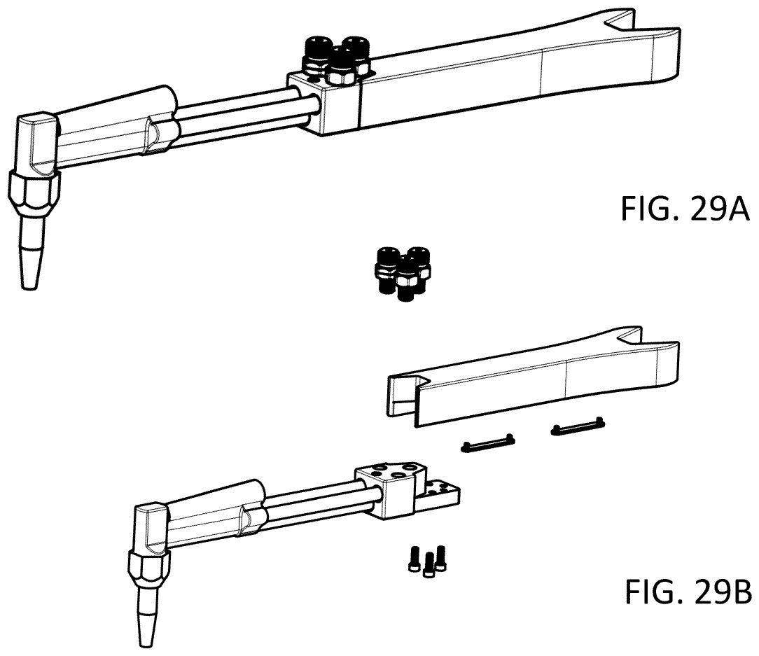

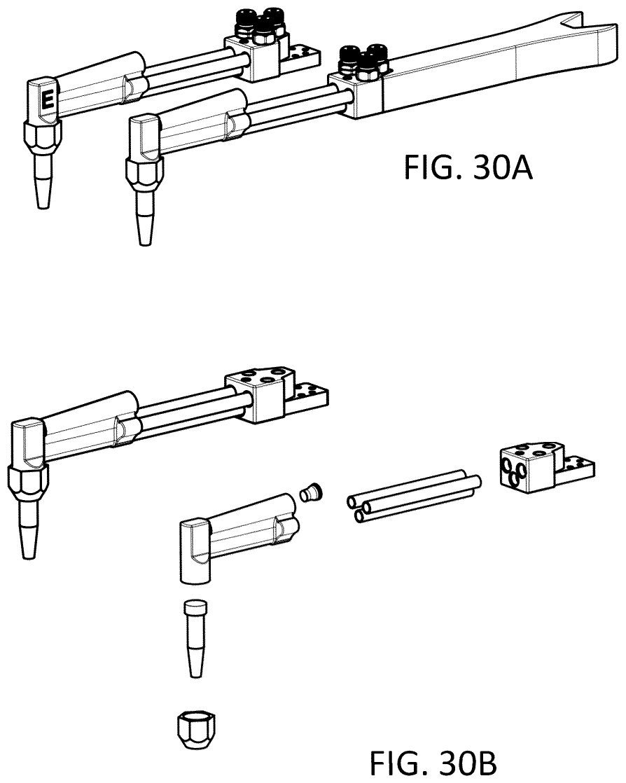

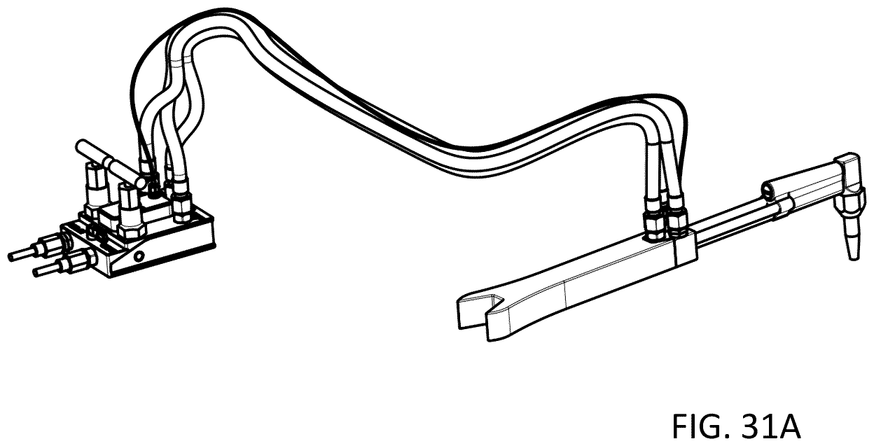

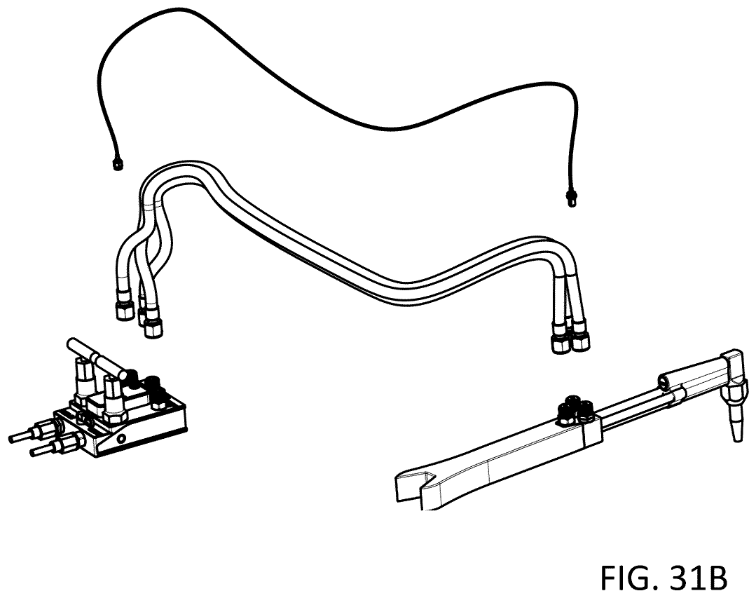

FIG. 29A illustrates an oxy-fuel attachment according to one embodiment of the present invention. FIG. 29B illustrates an exploded view of the oxy-fuel attachment shown in FIG. 29A. FIG. 30A illustrates an oxy-fuel attachment according to one embodiment of the present invention. FIG. 30B illustrates an exploded view of the oxy-fuel attachment shown in FIG. 30A. In some embodiments, the oxy-fuel attachment is designed to connect to an oxygen and/or acetylene tank via a manifold. The module includes a solenoid valve to control mixing and at least two values for controlling inlet pressure control. In yet another embodiment, the modular CNC system includes at least three solenoid valves and a corresponding sensor (e.g., pressure sensor) for each solenoid value. Each solenoid value corresponds to at least one gas flow intake and is designed to control the gas flow based on the sensor data. For example, and not limitation, the module is designed to control cutting oxygen jet flow and the oxy-fuel mixture for the preheat flame. FIG. 31A illustrates an oxy-fuel attachment connected to a manifold. FIG. 31B illustrates an exploded view of the oxy-fuel attachment and manifold shown in FIG. 31A.

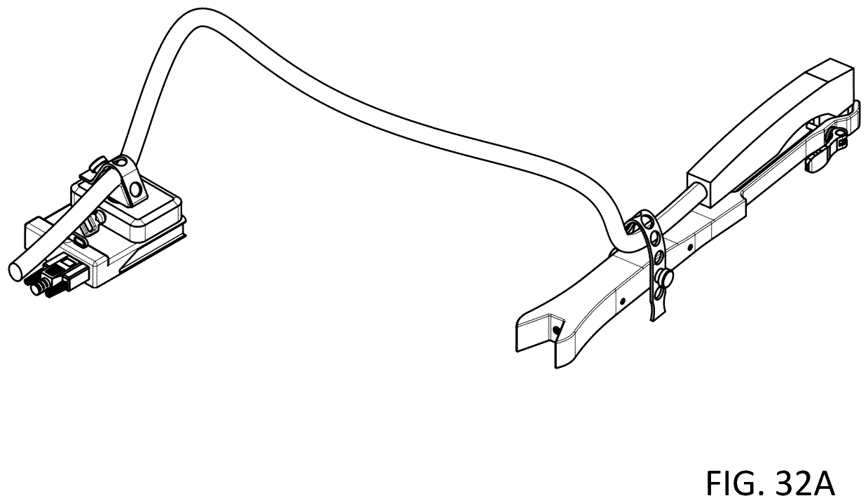

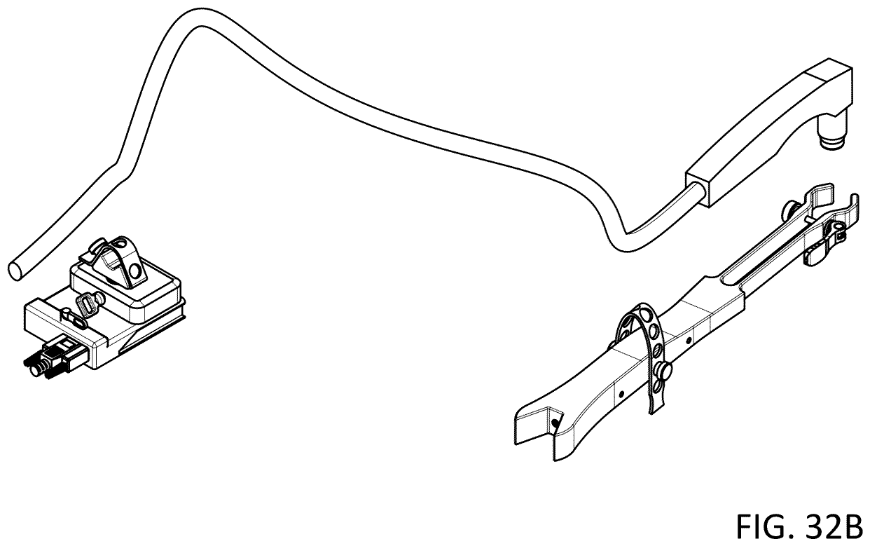

FIG. 32A illustrates a plasma attachment component and plasma manifold according to one embodiment of the present invention. FIG. 32B illustrates an exploded view of the plasma attachment component and plasma manifold shown in FIG. 32A. In some embodiments, the plasma attachment component includes a plasma torch that is electrically connected to a plasma cutter. In some embodiments, the plasma attachment component includes at least one strap for constraining a plasma cable connecting the plasma manifold and the plasma torch.

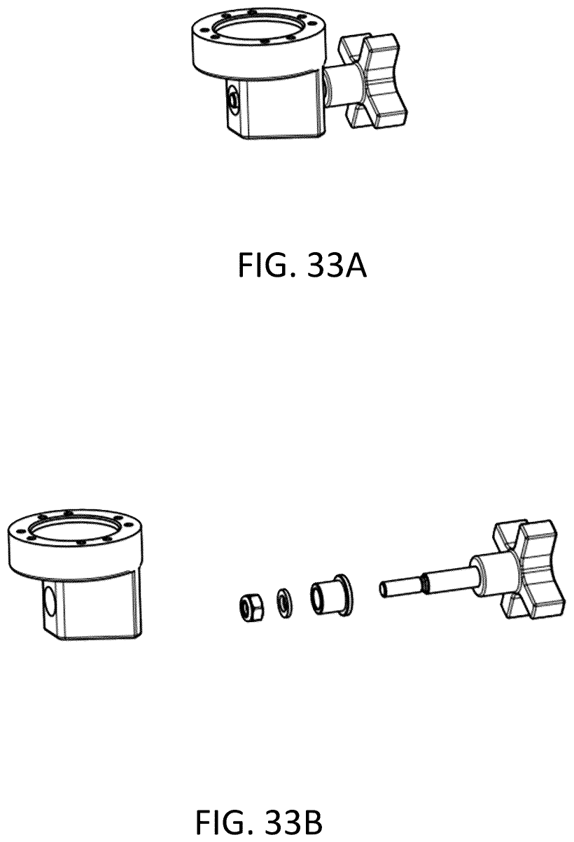

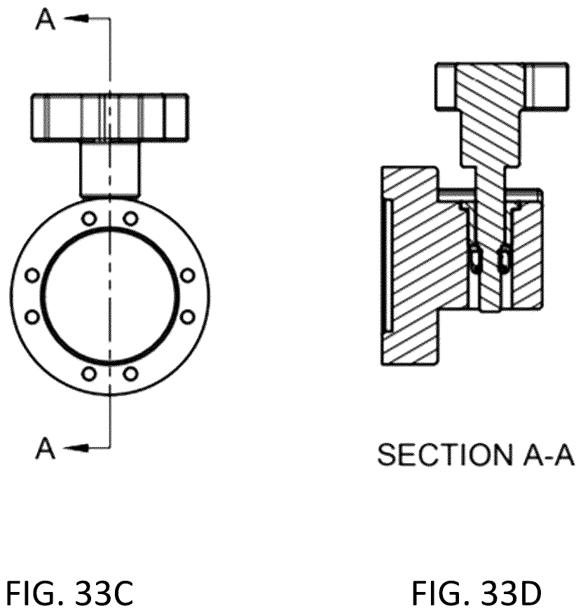

FIGS. 33A-33D illustrate various perspectives of a quick attachment component according to one embodiment of the present invention. The quick attachment component includes a thumbscrew and an adapter designed to attach to an arm attachment component of a modular CNC system. The adapter includes a tapered contact surface to improve bolt position. Alternatively, the adapter includes a snap latch, a clip, a carbineer, a magnet, and/or other similar locking mechanisms.

In some embodiments, the modular CNC system includes a selective compliance assembly robot arm (SCARA) robot. The modular CNC system includes two rotational axes and at least one linear axis. The two rotational axes create an arm-like component that enables the modular CNC system to move in a similar manner to a human arm. The linear axis creates a third dimension (e.g., “z” axis). The present invention is further operable to control the height of an end effector above a workpiece. Advantageously, the modular CNC system is designed to cut in any orientation, including but not limited to upside-down orientation or on a vertical surface.

In some embodiments, the modular CNC system includes at least one attachment for welding, scribing, laser cutting, and/or light abrasive grinding. Advantageously, the modular CNC system is designed for metalworking. In some embodiments, the modular CNC system weighs less than twenty-five pounds.

In some embodiments, the modular CNC system includes a base assembly including a sheet metal cover that protects the interior components of the modular CNC system from external elements. The modular CNC system further includes a Faraday cage to provide protection from electromagnetic interference. For example, and without limitation, the modular CNC system comprises aluminum.

In some embodiments, the modular CNC system includes an audio feedback component. During oxy-fuel cutting, the torch will preheat the surrounding material in addition to a cutline. This can result in undesired defects. To address this problem, the audio feedback component includes an audio sensor (e.g., microphone) attach to the an arm component. The audio sensor is designed to capture audio data corresponding to a cut. The captured audio data is transferred to the controller. The controller can determine whether a cut is occurring too fast based on captured audio data. The controller is operable to monitor the frequency spectrum and to adjust a cutting speed based on the frequency. Advantageously, the audio feedback component and adaptive torch speed minimize the additional heat. In some embodiments, the modular CNC system further includes a temperature sensor (e.g., infrared), an image sensor and/or system (e.g., camera), and/or other sensing devices.

In some embodiments, the modular CNC system is designed to automatically continue a cut while and after being moved using a camera and computer vision system. The modular CNC system generates a three-dimensional (3D) map of any edges and/or contours on a work material, identifies safety concerns and limitations, and provides feedback based on the position of the work material and the base, the base arm, the first attachment, and the second attachment. Advantageously, the modular CNC system enables an operator to track marking directly on the material and cut, weld, solder, and other attachment methods along a cutline.

In some embodiments, the modular CNC system is designed to measure a magnetic clamping force to ensure safe operation. If clamping fails during the operation of the modular CNC system, then harm can occur to an operator and/or the modular CNC system. Clamping failure is a result of thing, dirty, and/or heavily painted workpiece material. The modular CNC system measure the clamping force by monitoring the inductance of the magnetic clamp. For example, and without limitation, the modular CNC system monitors the rate of change in the magnet utilizing a current sensor in parallel to the magnet, introduce a small high-frequency signal into the current, and measure the voltage produced in response. By sensing the applied force and estimating the required clamping force, the modular CNC system is operable to modulate the power applied to the magnetic base to minimize its power consumption and ensure longer battery operation.

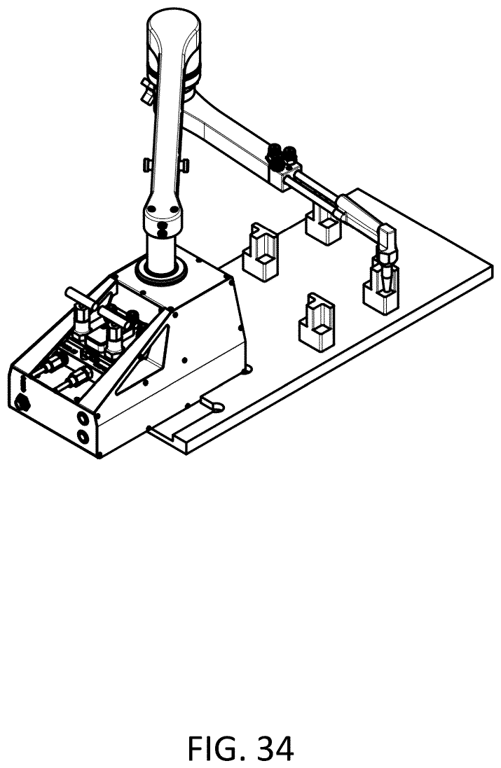

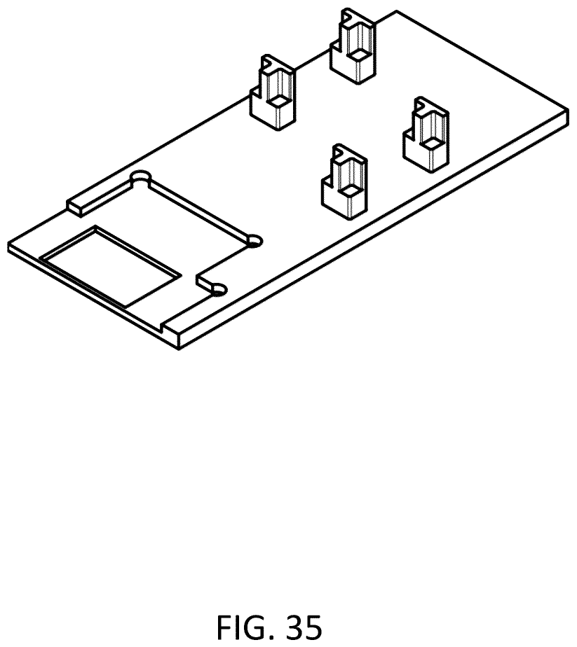

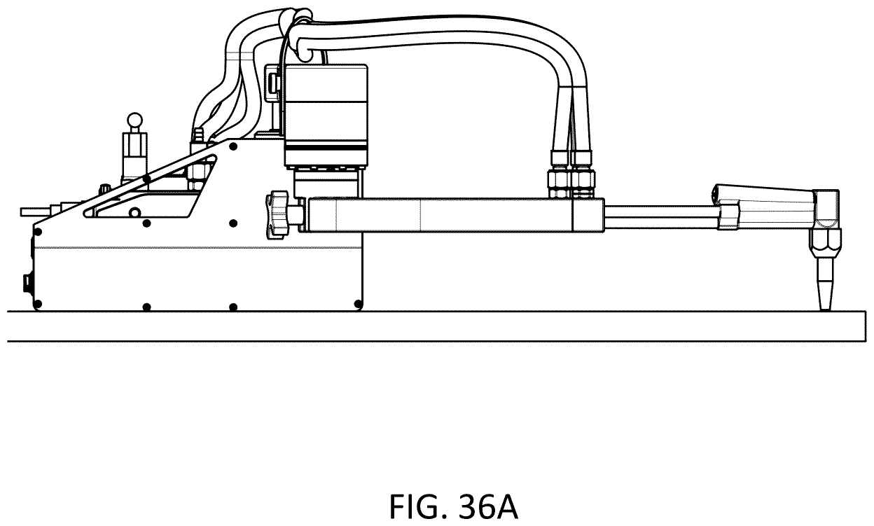

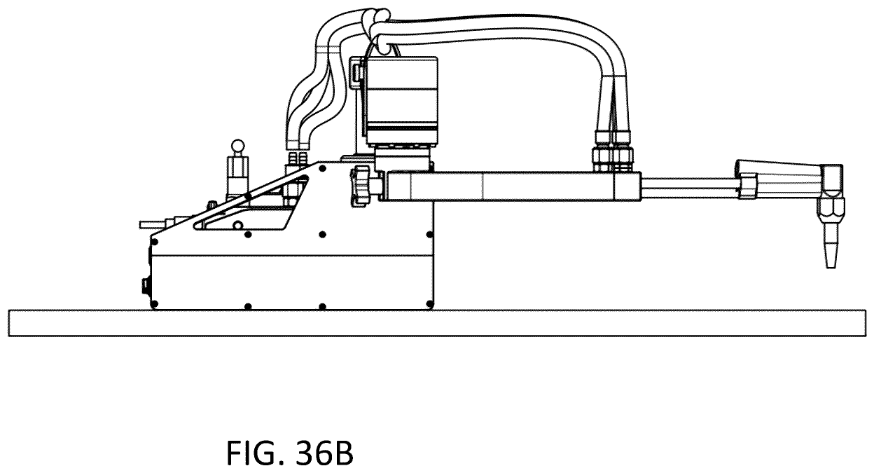

In some embodiments, the controller is designed to move each motor based on a positioning of a torch tip. The modular CNC system includes a software platform operable to determine the position of an arm relative to a workpiece material In some embodiments, the modular CNC system tracks the center-to-center distance of each arm and is operable to determine the position of each arm relative to a workpiece material. The modular CNC system is further operable to continuously measure the angles of the motors. The modular CNC system is operable to recalibrate a length and position of an arm in real-time. For example, and not limitation, the modular CNC system is operable to compare the position of an arm relative to a known calibration point and to update the arm calibration in response to the arm positioning. For further example, the modular CNC system, as shown in FIG. 34, can a plurality of calibration fixtures attached to a calibration plate. The positioning of the plurality of calibration fixtures and calibration plate is fixed. Therefore, when a torch arm touches a calibration fixture. The modular CNC system is operable to determine the position of an arm. FIG. 35 illustrates a calibration plate according to one embodiment of the present invention. FIG. 36A illustrates a modular CNC system including an arm attachment component in a lowered position. FIG. 36B illustrates a modular CNC system including an arm attachment component in a raised position.

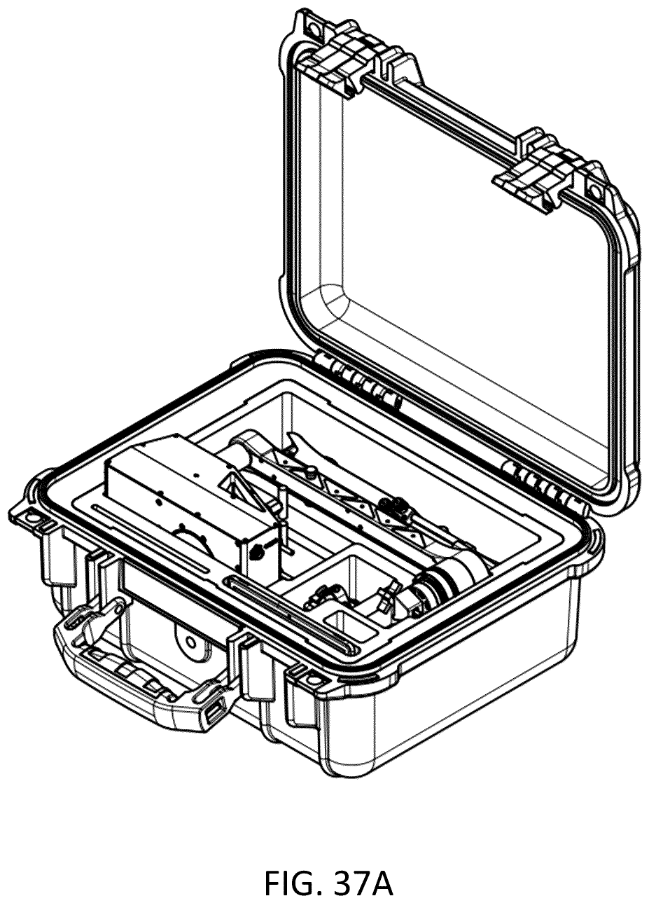

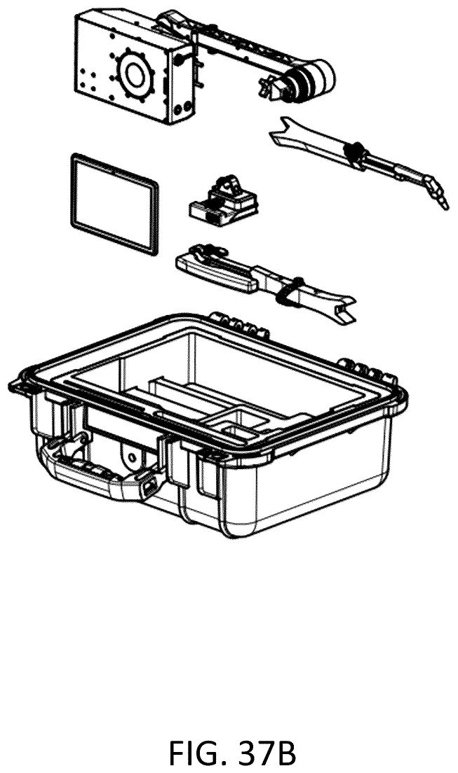

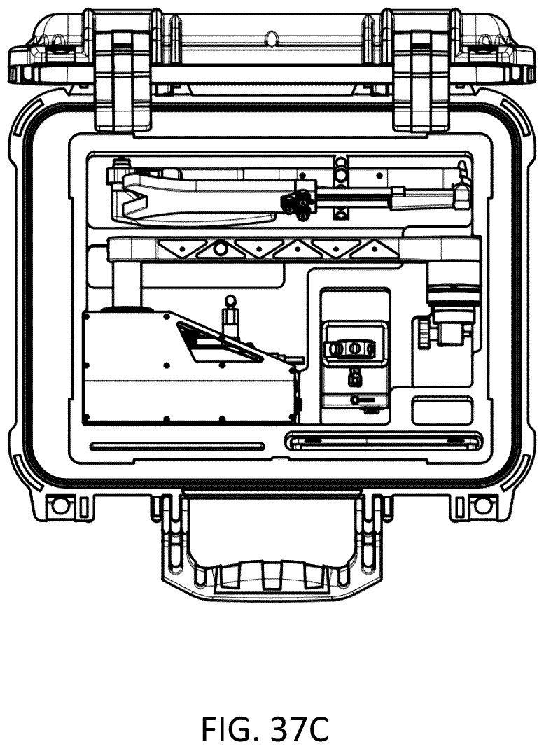

In some embodiments, the modular CNC system includes a carrying case. The modular CNC system includes a modular CNC machine including a base, a base arm, and at least one attachment component. The modular CNC machine is operable to fit within an interior of the carrying case. The carrying case includes at least one layer of material to protect the carrying case during transportation. FIG. 37A illustrates a top perspective view of modular CNC system according to one embodiment of the present invention. FIG. 37B illustrates an exploded view of the modular CNC system shown in FIG. 37A. FIG. 37C illustrates a top view of the modular CNC system shown in FIG. 37A.

In some embodiments, the modular CNC system includes a DC power source. Alternatively, or additionally, the modular CNC system includes a removable and/or rechargeable battery pack.

In some embodiments, the modular CNC system includes an image component designed to capture image data. For example, and without limitation, the modular CNC system includes a camera positioned on a base of a modular CNC machine, the first attachment component, and/or a second attachment. The modular CNC system is operable to recognize a desired cut based on the captured image data and to automatically provide instructions to the base arm, the first attachment, and the second attachment based on the desired cut. The controller of the modular CNC system is operable to control the speed of the CNC modular system based on pressure and/or sound.

In some embodiments, the modular CNC system includes control electronics. For example, and without limitation, the control electron electronics include a voltage-sensing circuit, an analog-to-digital converter (ADC), a processor, the indicator, and optionally a driver. The voltage sensing circuit can be any standard voltage sensing circuit, such as those found in volt meters. An input voltage VIN is supplied via the power BUS. In some embodiments, the voltage sensing circuit includes standard amplification or de-amplification functions for generating an analog voltage that correlates to the amplitude of the input voltage VIN that is present. The ADC receives the analog voltage from the voltage sensing circuit and performs a standard analog-to-digital conversion.

In some embodiments the controller includes a processor. The processor manages the overall operations of the modular CNC system. The processor is any controller, microcontroller, or microprocessor that is capable of processing program instructions. In some embodiments, the control electronics, include at least one antenna, which enables the modular CNC system to send information (e.g., torch speed) to at least one remote device (e.g., smartphone, tablet, laptop computer) and/or receive information (e.g., power commands) from at least one remote device. The at least one antenna provides wireless communication, standards-based or non-standards-based, by way of example, and not limitation, radiofrequency (RF), Bluetooth, ZigBee, near field communication, or other similar communication methods.

In some embodiments, the modular CNC system includes a software platform. The software platform is in network communication with at least one modular CNC machine. The software platform is operable for controlling and monitoring the operations of the at least one modular CNC machine. In some embodiments, the software platform is operable for controlling a plurality of modular CNC machines. For example, and without limitation, the software platform is used for a metalworking facility and is operable to monitor and control each modular CNC machine located in the metalworking factory. Advantageously, this provides a control center for managing various metalworking machines and processes.

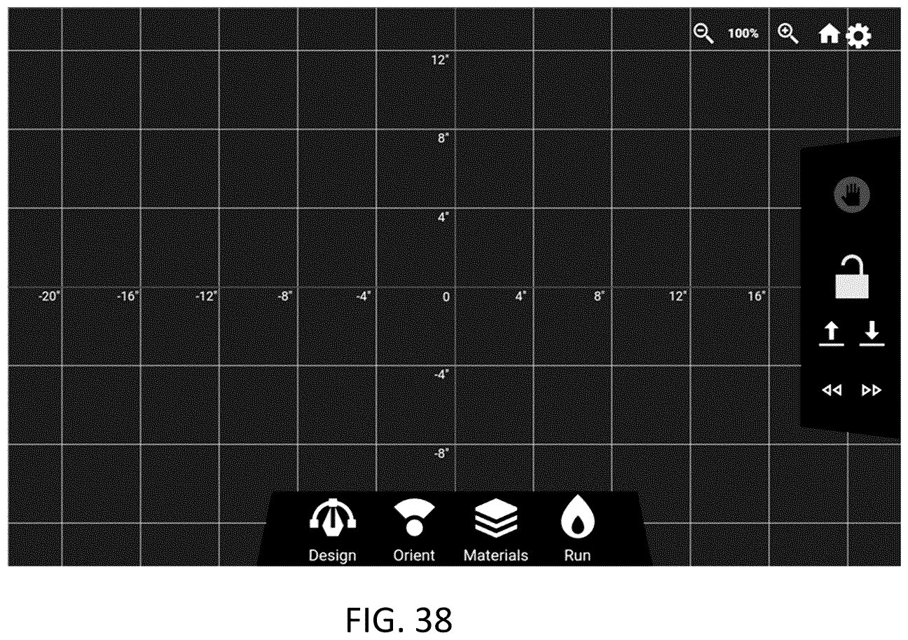

FIG. 38 illustrates a screenshot of a software platform of a modular CNC system according to one embodiment of the present invention. The software platform is displayable via user interface of a remote device. The software platform is operable for designing cuts, orienting a modular CNC machine, material selection, running a modular CNC machine, and real-time monitoring and analysis of at least one modular CNC machine. The software platform further includes power control. For example, and not limitation, the software platform is operable to transmit a power command to at least one CNC machine to power on/off and/or to activate or deactivate a corresponding tool (e.g., plasma torch).

The software platform is further operable to display a position of a modular CNC machine, a target cutline, a real-time cut, and a real-time position of the modular CNC machine. The software platform is operable to receive user input corresponding to a desired cut. For example, and not limitation, the user input includes a position of a cut on a workpiece, a rotation of a shape, a scale size, a x direction, a y direction, and/or a z direction. The user input can include a type of material, a type of thickness, a tip size, cut parameters (e.g., height, cut feed rate, piece height, preheat time). Advantageously, each parameter is operable to change via the software platform.

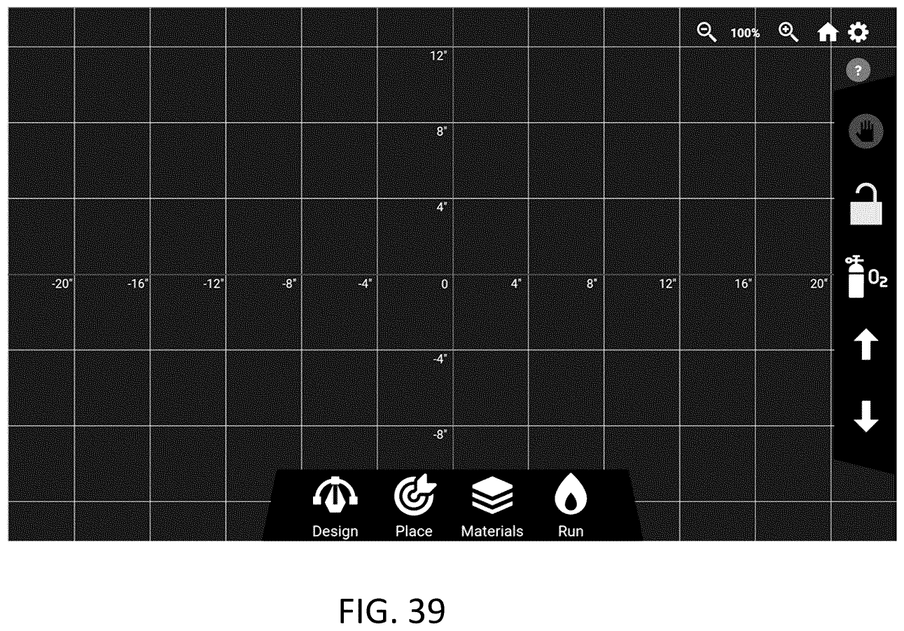

FIGS. 38-39 illustrates a control screen of a modular CNC software platform. The modular CNC software platform is operable to display an origin, an x-axis, and a y-axis for representing a workpiece, a modular CNC machine, and/or a cutting path. The modular CNC software platform is operable to receive user input via a plurality of interactive buttons. For example, and without limitation, the plurality of interactive buttons includes an emergency stop, a lockout, a height control, a cutting speed, a cutting design, an orientation feature, a materials component, run functionality, placement control, and fuel control.

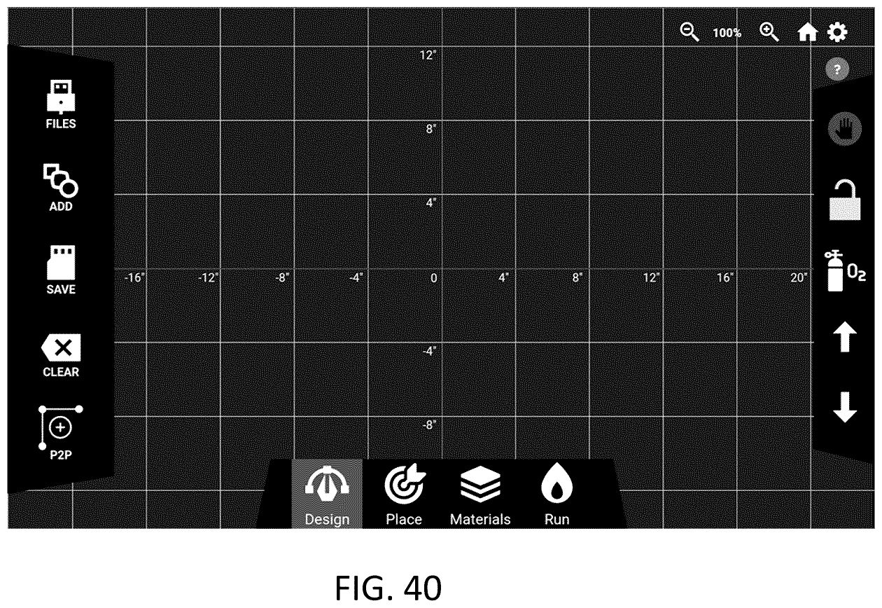

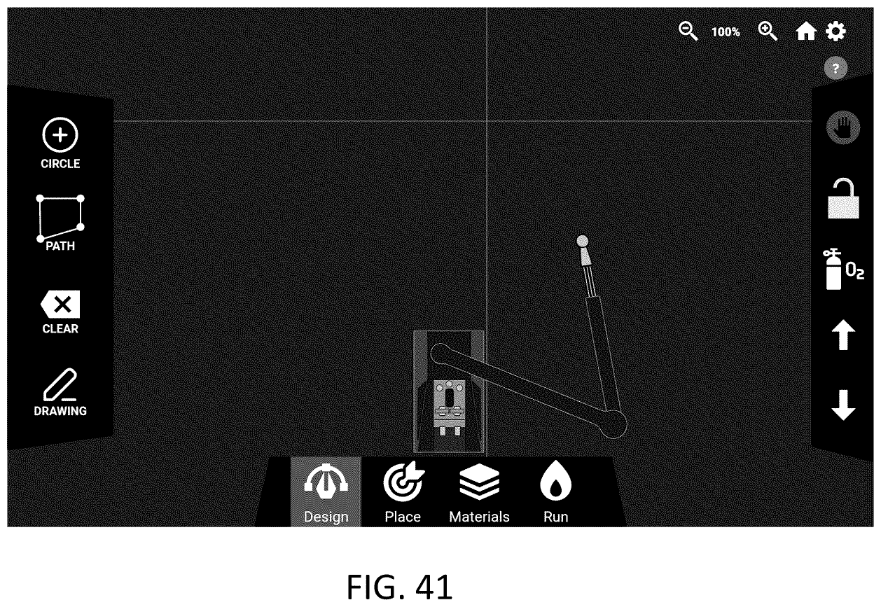

FIG. 40 illustrates a design component of a modular CNC software platform. Once the design component is selected, the modular CNC software platform is operable to display a plurality of design option including file upload, add shape, save file, clear design, and point to point design. The modular CNC software platform is operable to receive a design file (e.g., .dxf file) from a remote device, a remote server, a database, a third-party application, and/or a data storage device (e.g., universal serial bus (USB) drive). The software platform is operable to receive user input identifying a unit (e.g., inches, millimeters) of the drawing file. FIG. 41 illustrates a design component of a modular CNC software platform with a virtual representation of a modular CNC machine.

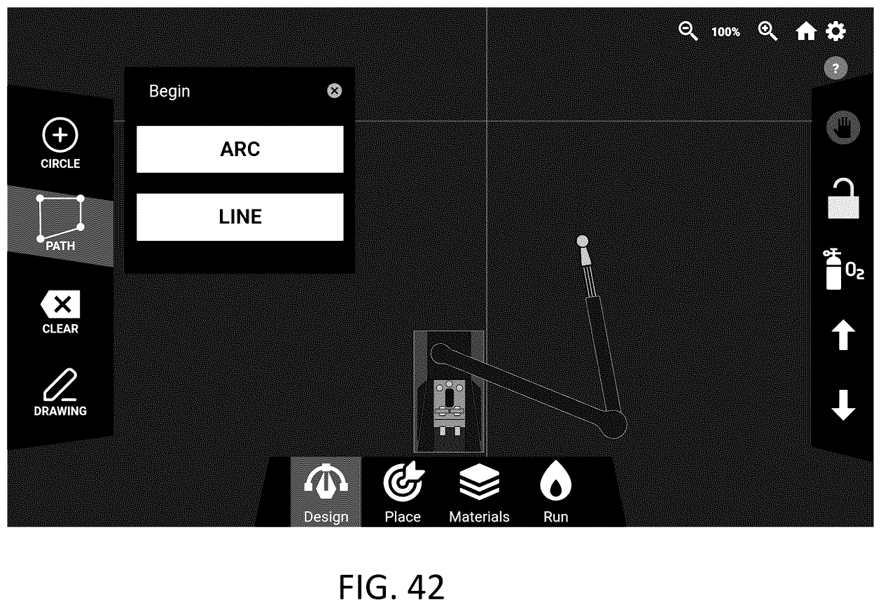

FIG. 42 illustrates a cutting path design component of the modular CNC software platform. The modular CNC software platform is operable to receive user input relating to a desired cutting path. The user input includes input received via a remote device (e.g., touchscreen) and/or via physical movement of the modular CNC machine corresponding to the virtual representation of the modular CNC machine. For example, and without limitation, the user input includes an curved shaped (e.g., arc), a linear shape (e.g., a line), and other similar cutting paths.

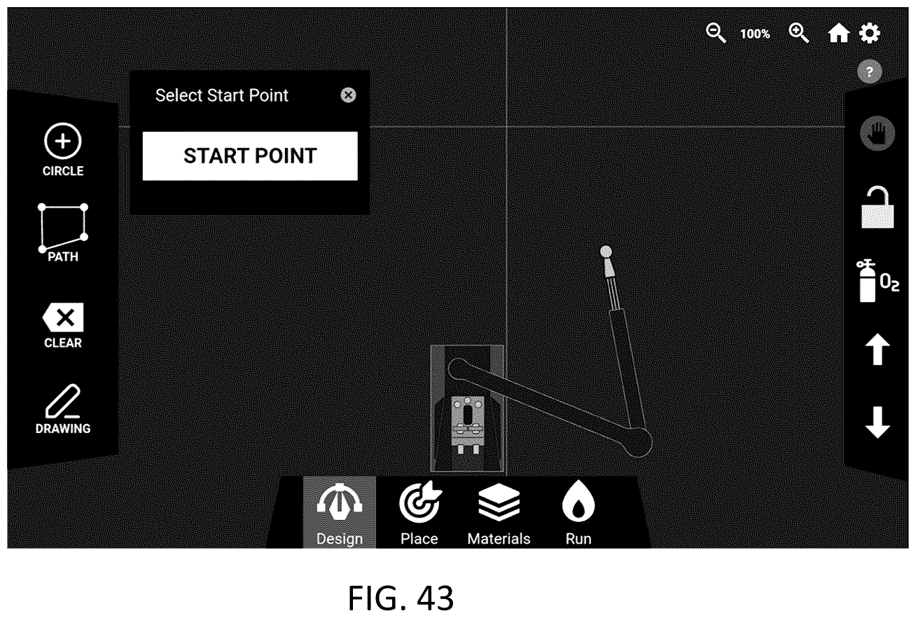

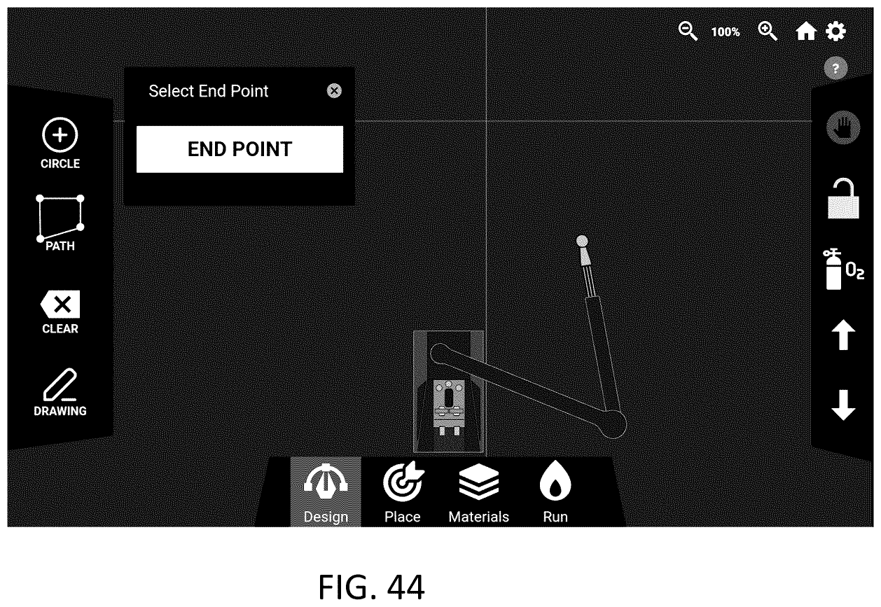

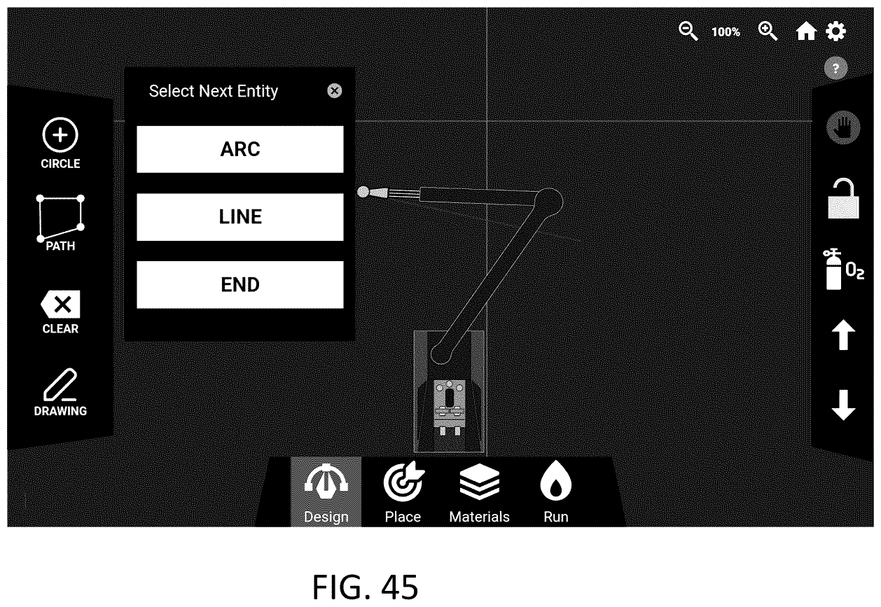

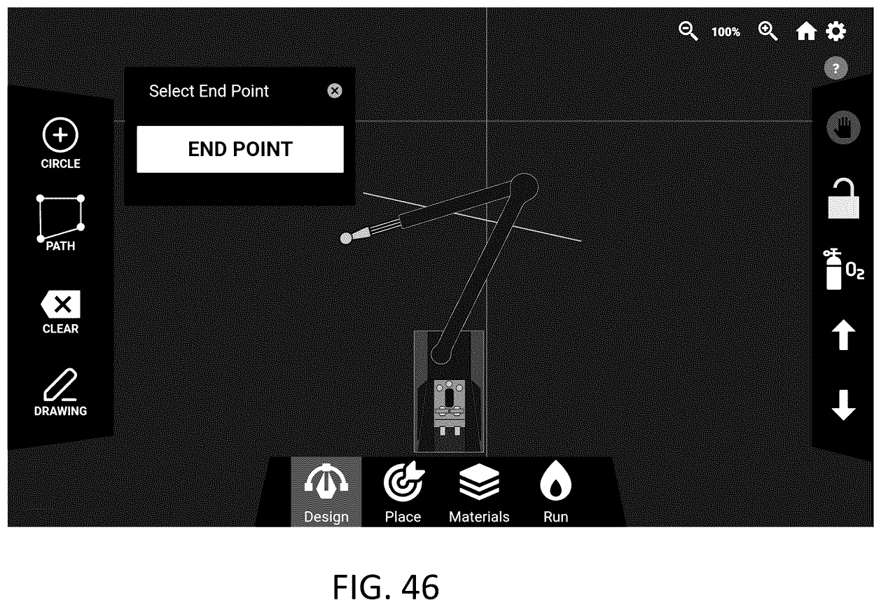

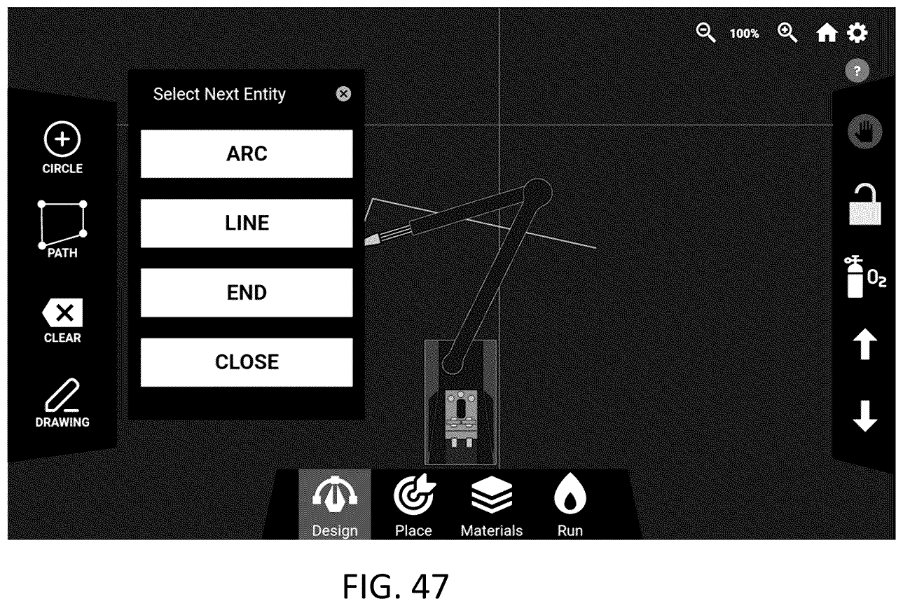

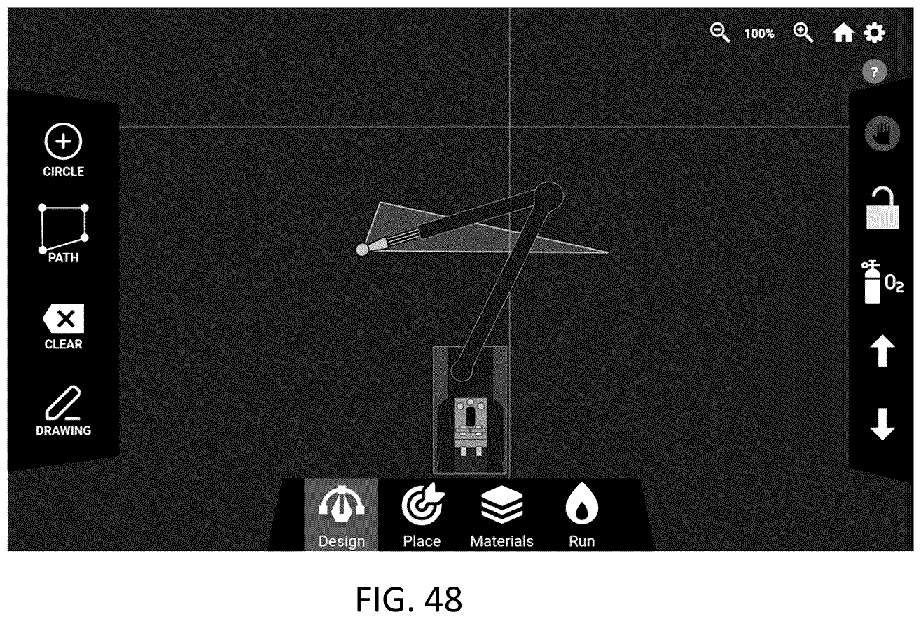

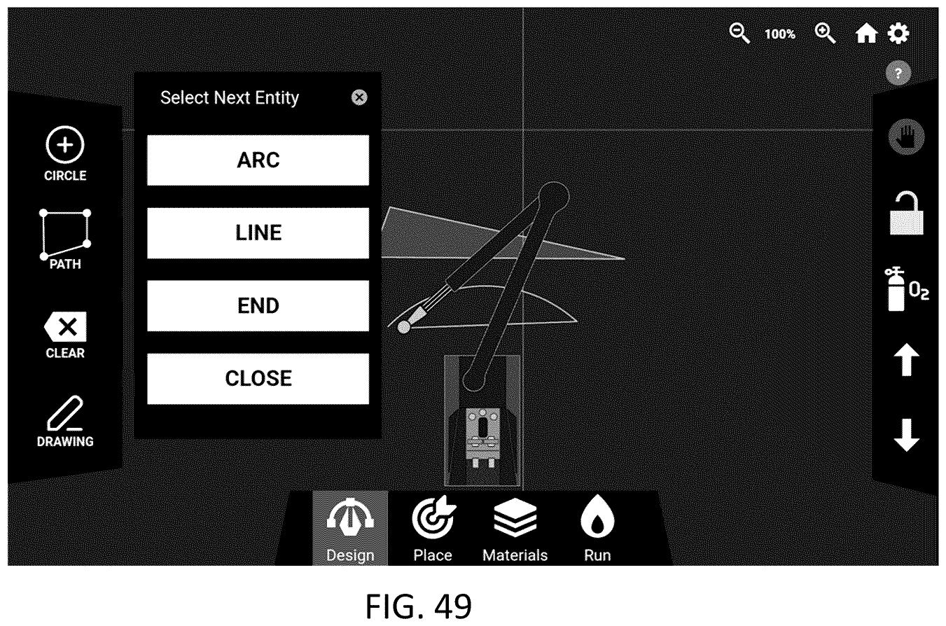

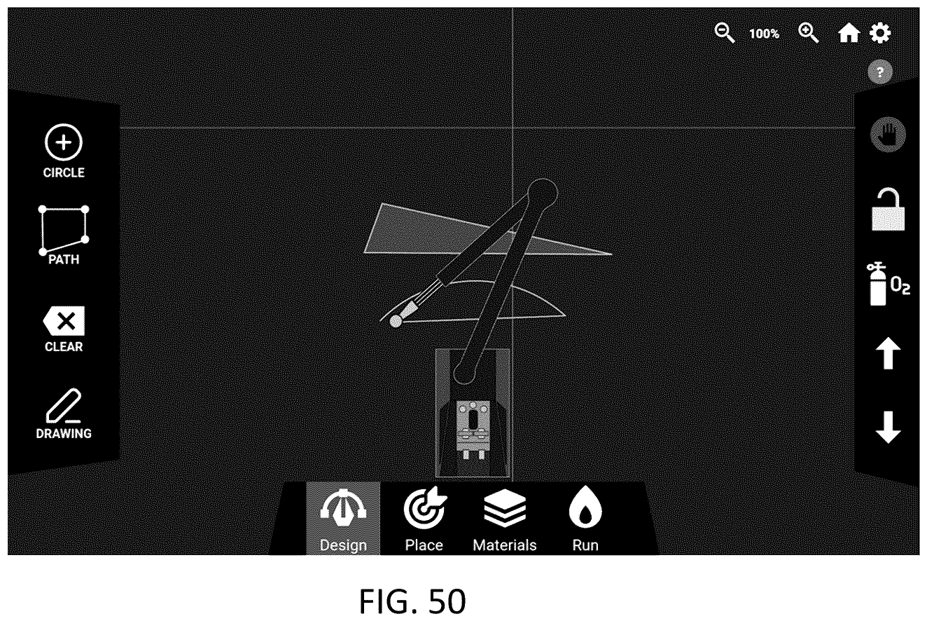

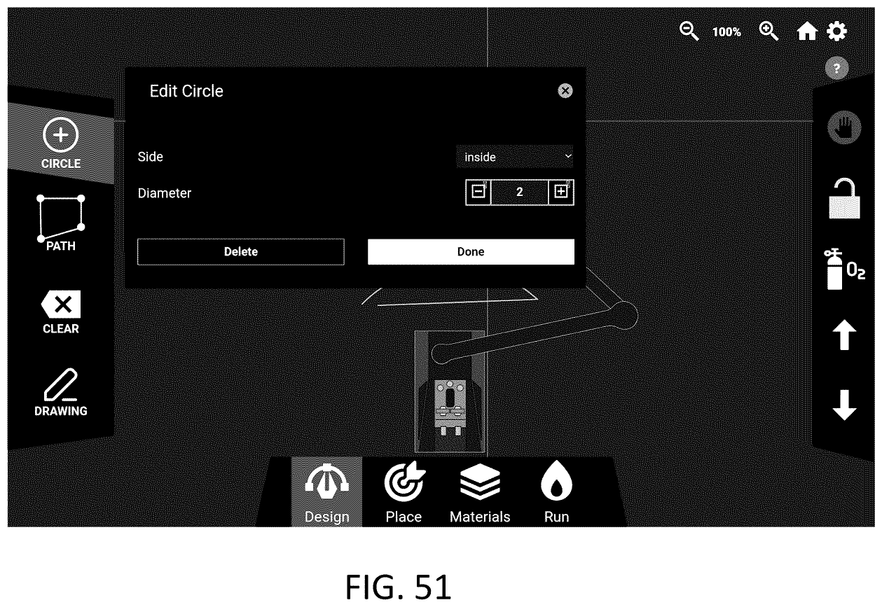

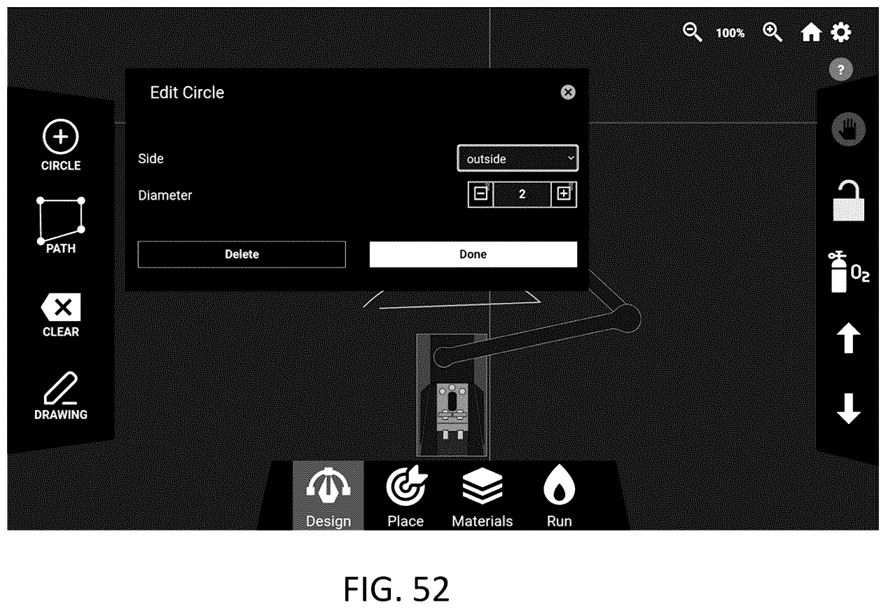

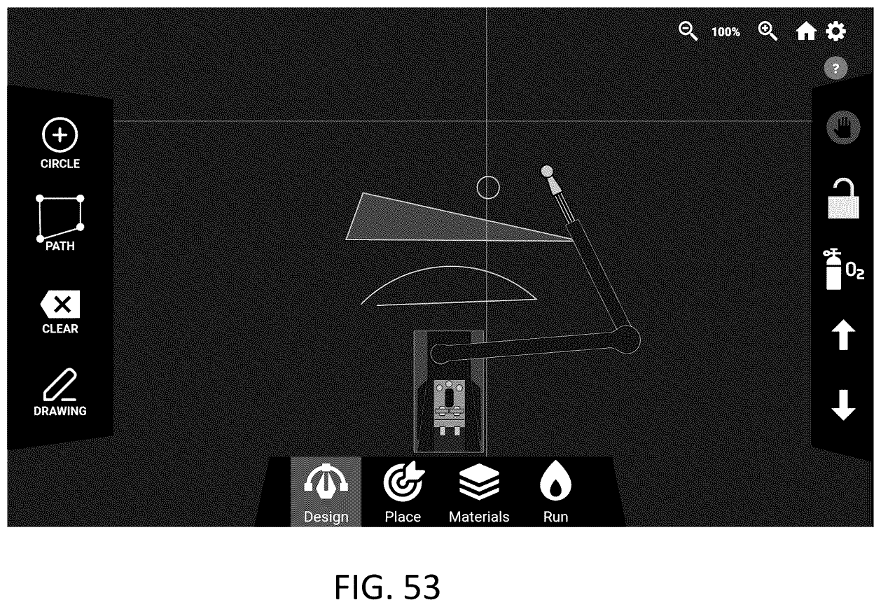

The modular CNC platform is operable to receive a starting point (FIG. 43) and an end point (FIG. 44). As illustrated in FIG. 45, after completing a virtual representation of a cutting path between a start point and end point, the modular CNC software platform is further operable to add additional cutting path shapes (e.g., arc, lines) or to complete the cutting path. FIGS. 46-48 illustrate a formation of a triangular cutting path using linear paths and multiple start and end points. FIGS. 49-50 illustrate a creating of a curved cutting path (e.g., arc). Advantageously, as shown in FIG. 51, the modular CNC software platform is operable to create and edit a shape corresponding to a cutting path. For example, and without limitation, the cutting shape includes a circle. The modular CNC software platform is operable to receive user input corresponding to a diameter of the circle. The modular CNC software platform is further operable to receive a starting position for a cutting tool. For further example, and without limitation, the starting position includes inside the selected shape (FIG. 51) or outside the selected shape (FIG. 52). If the starting position is inside the selected shape, then the cutting tool is positioned within the selected shape prior to cutting a corresponding workpiece. If the starting position is outside the selected shape, then the cutting tool is positioned outside of the selected shape prior to cutting the corresponding workpiece along the selected shape. FIG. 53 illustrates a virtual representation of a modular CNC machine with a virtual cutting path according to one embodiment of the present invention.

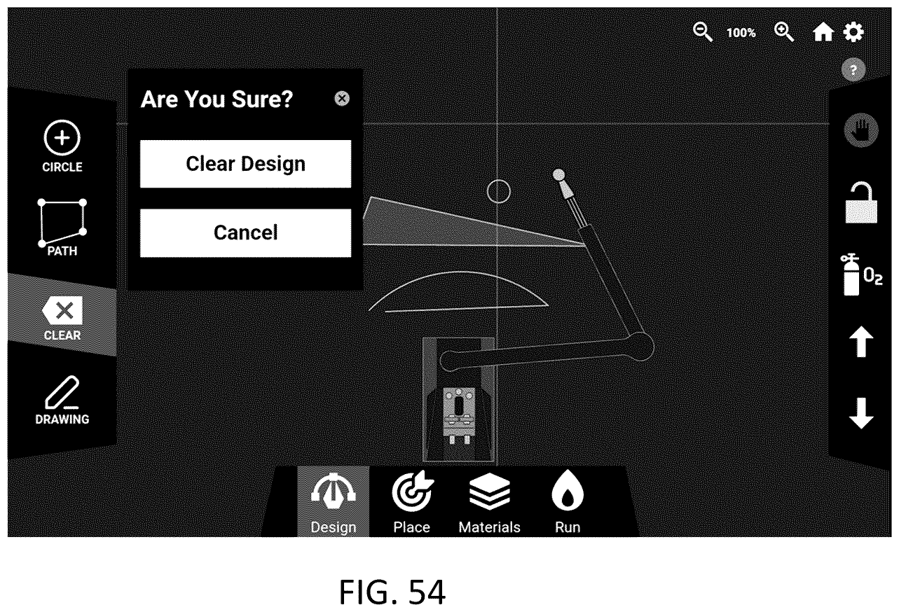

As illustrated in FIG. 54, the modular CNC software platform is operable to receive user input to clear a design. After receiving the user input, the modular CNC software platform is operable to clear a displayed virtual cutting path.

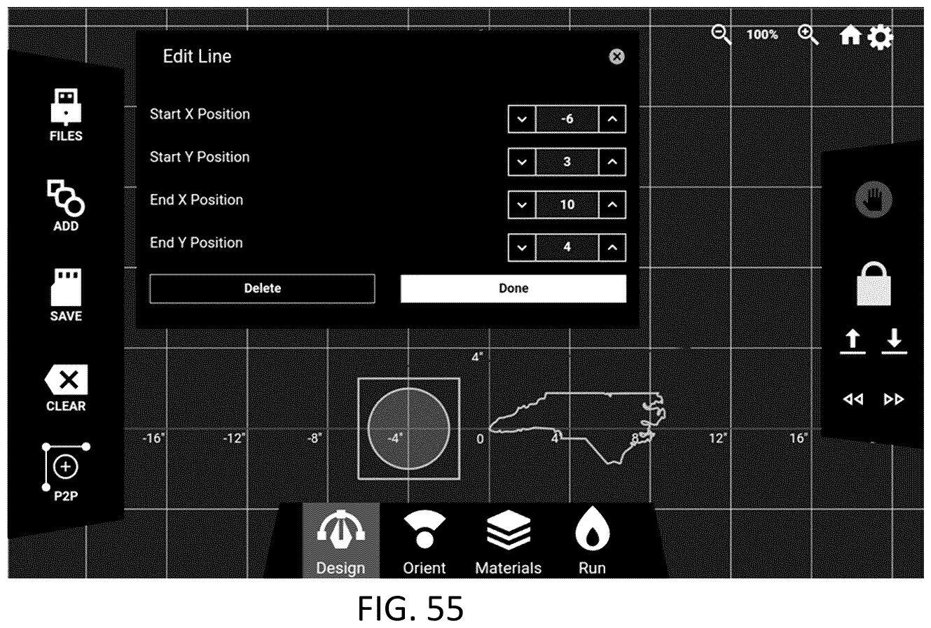

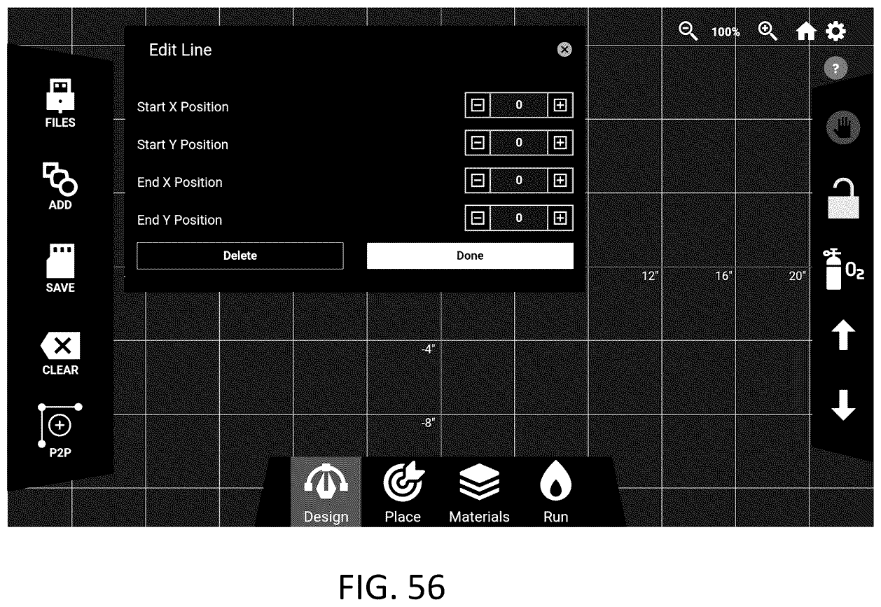

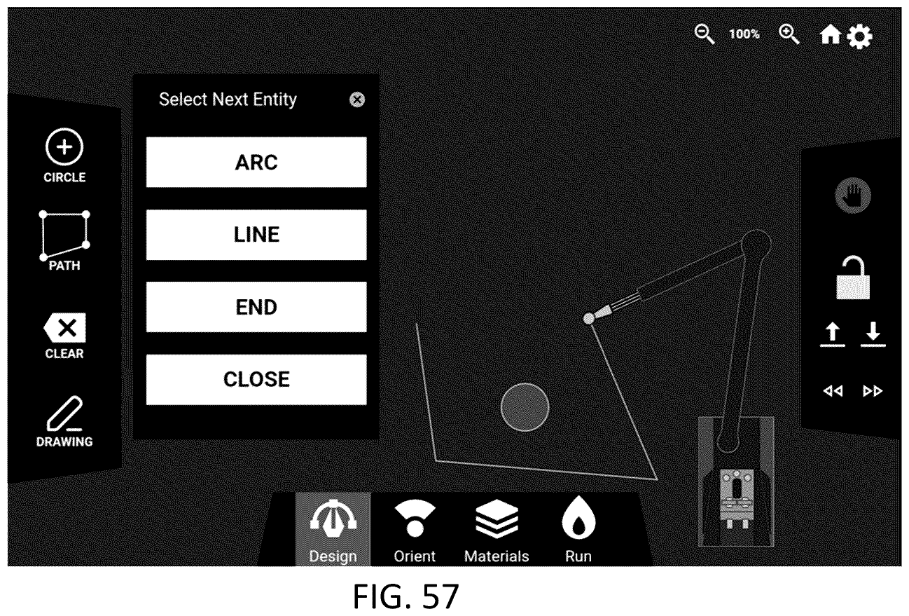

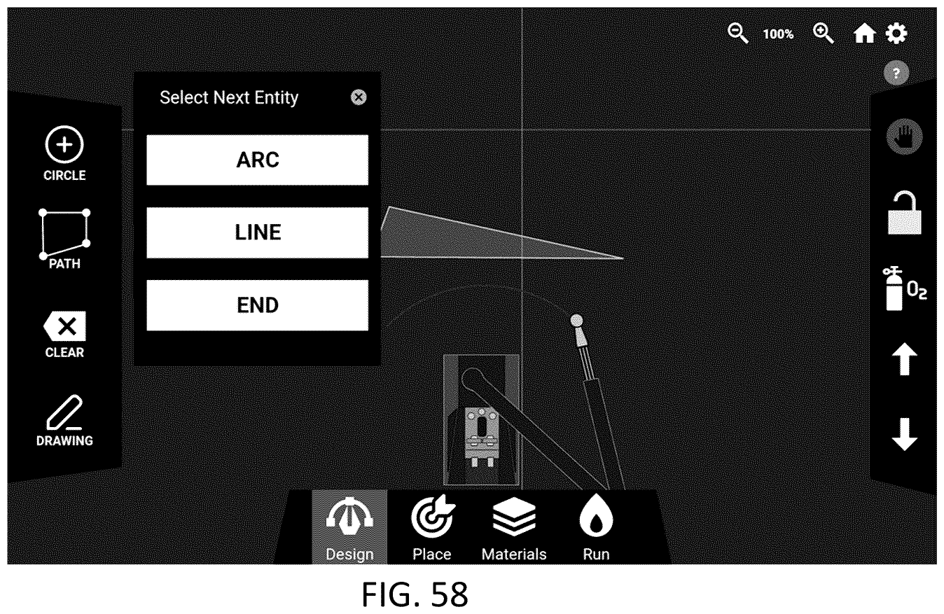

In some embodiments, as shown in FIGS. 55 and 56, the modular CNC software platform is operable to modify cutting path parameters. For example, and without limitation, the cutting path parameters includes a starting x-axis position, a starting y-axis position, an end x-axis position, and an end y-axis position. FIG. 57 illustrates a virtual cutting path and a virtual representation of modular CNC machine of a modular CNC software platform according to one embodiment of the present invention. FIG. 58 illustrates a curved virtual cutting path according to one embodiment of the present invention.

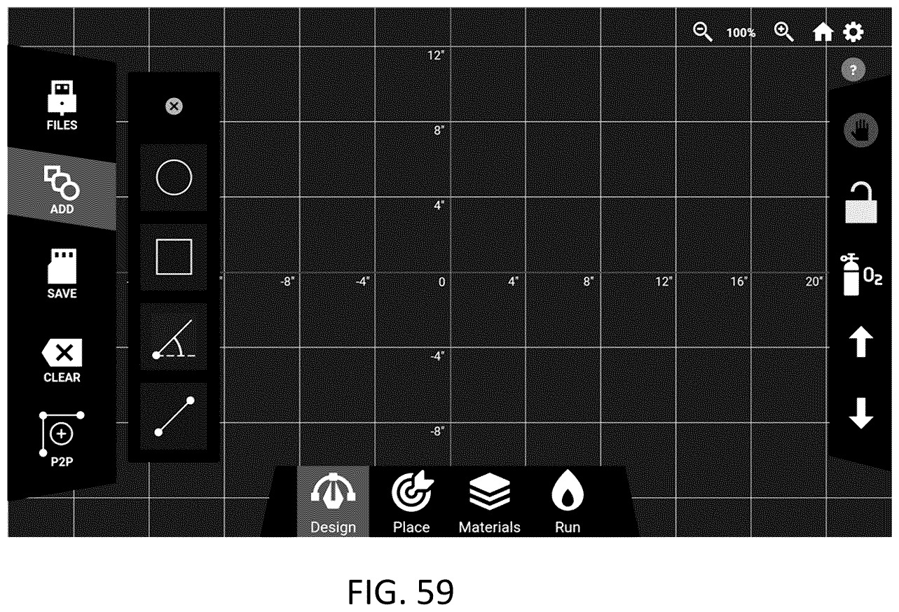

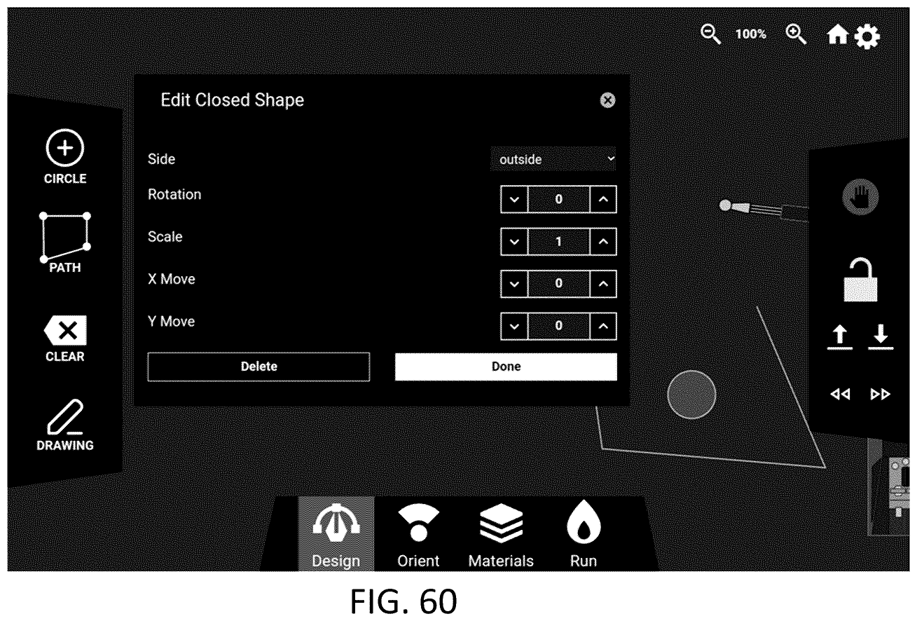

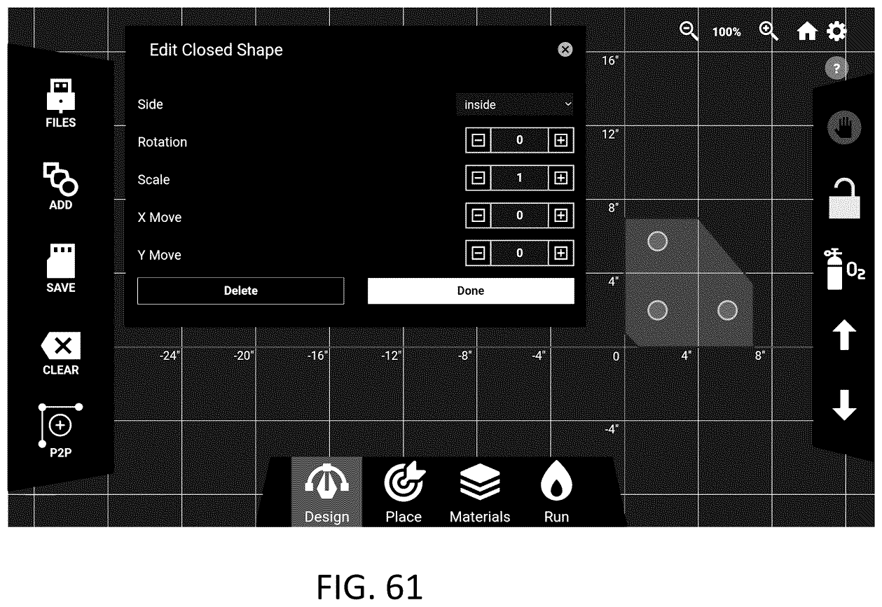

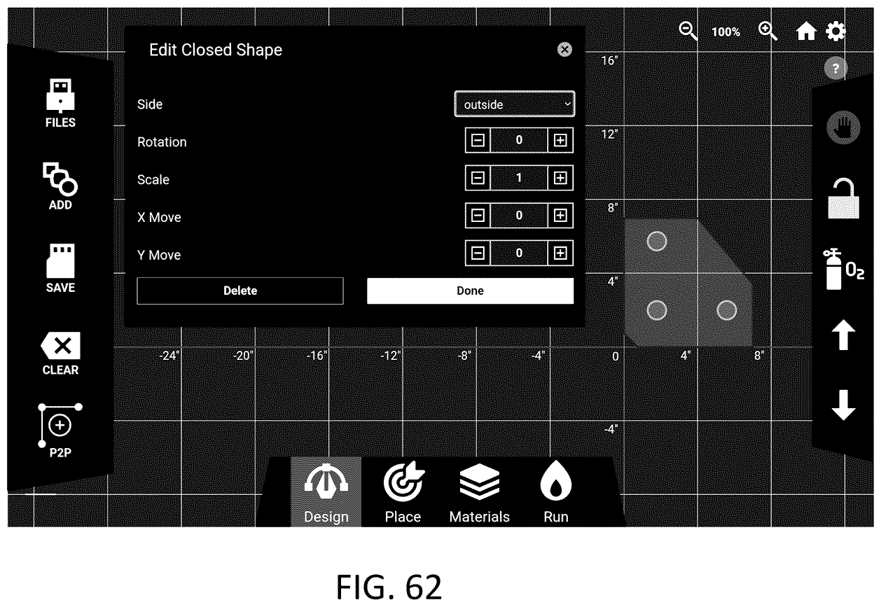

FIG. 59 illustrates the shape creation component of the modular CNC software platform. The modular CNC system is operable to create a plurality of shapes including but not limited to a circle, a rectangle, an angled line, lines with end points, and other shapes for cutting paths. FIGS. 60-62 illustrate shape parameters of a virtual cutting path according to one embodiment of the present invention. The modular CNC system is operable to modify shape parameters of a cutting path. The shape parameters include a cutting position (e.g., inside, outside), rotation, scale, x-axis movement, and y-axis movement.

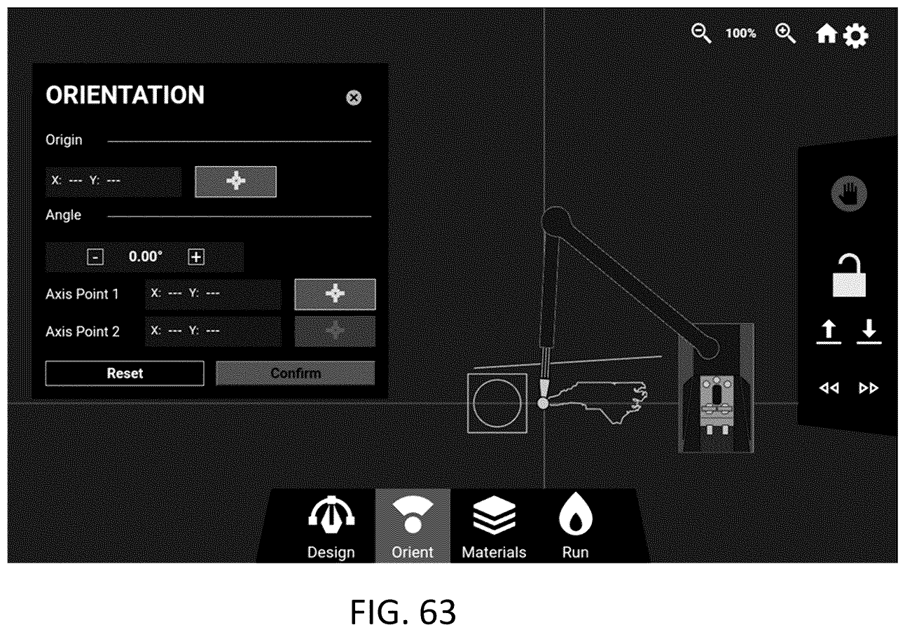

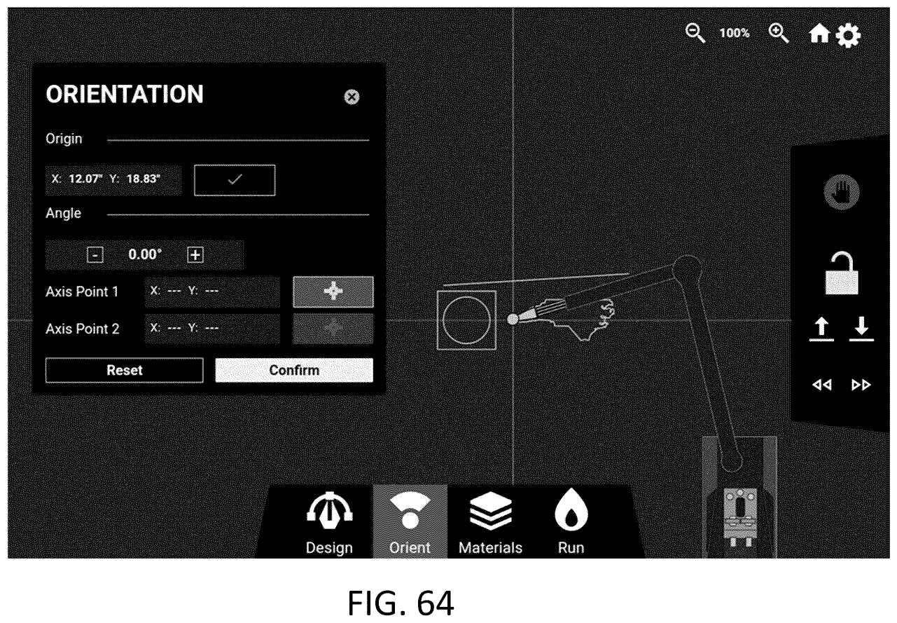

FIGS. 63-64 illustrate an orientation component of a modular CNC software platform. The modular CNC software platform is operable to orient a virtual cutting path and/or a modular CNC system based on orientation parameters. The orientation parameters include, but are not limited to, an origin point (x-axis position, y-axis position), an angle of rotation, a first axis point, and a second axis point.

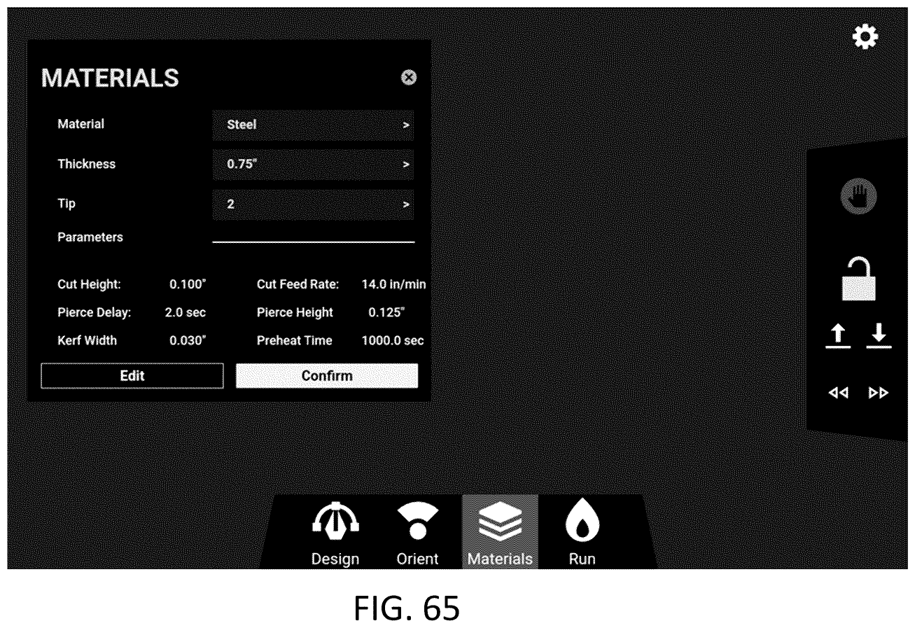

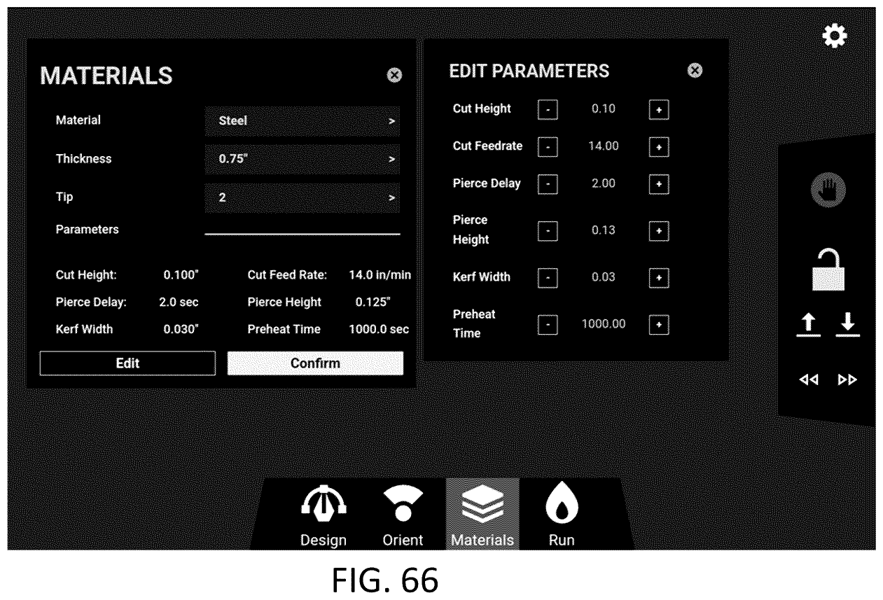

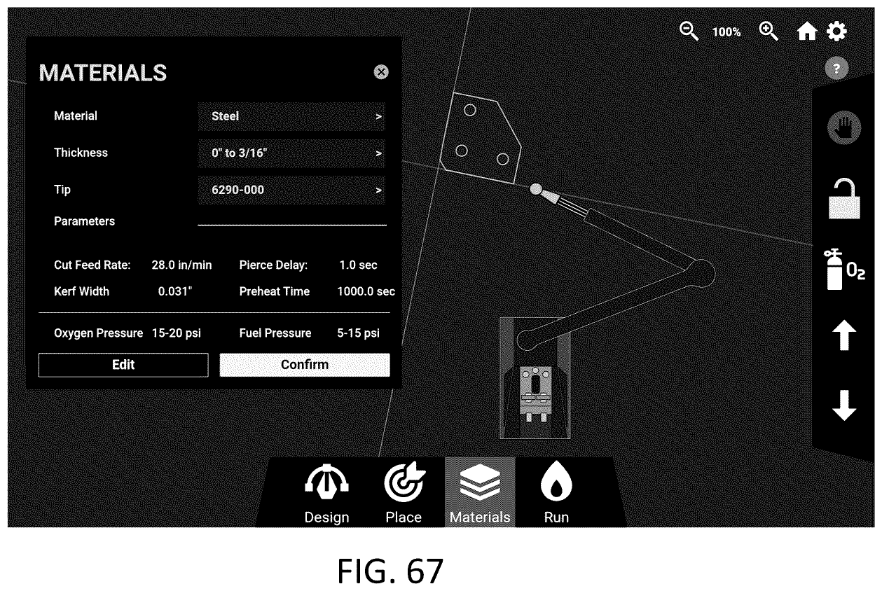

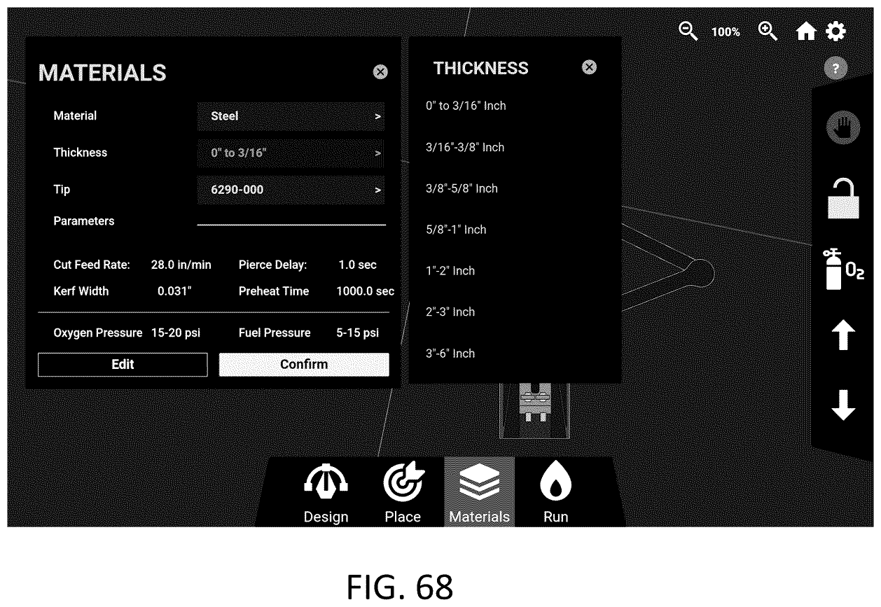

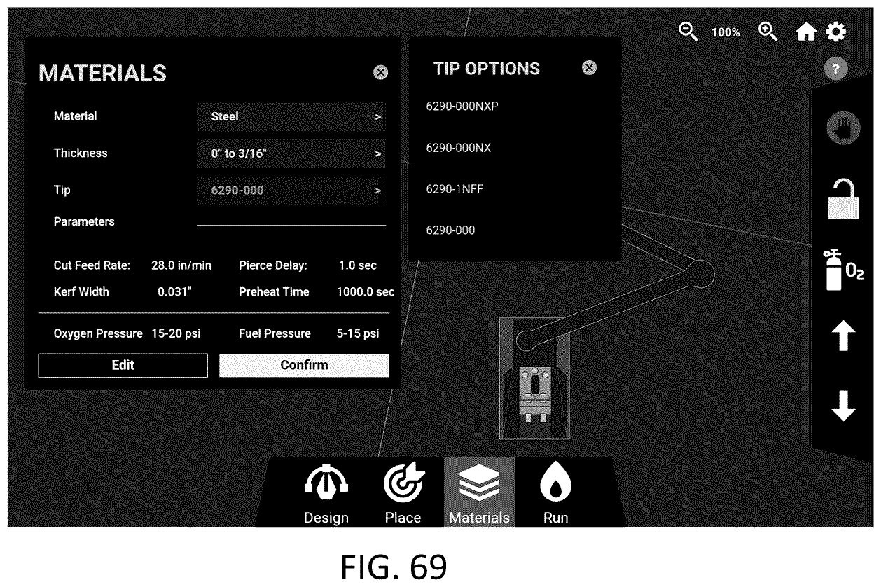

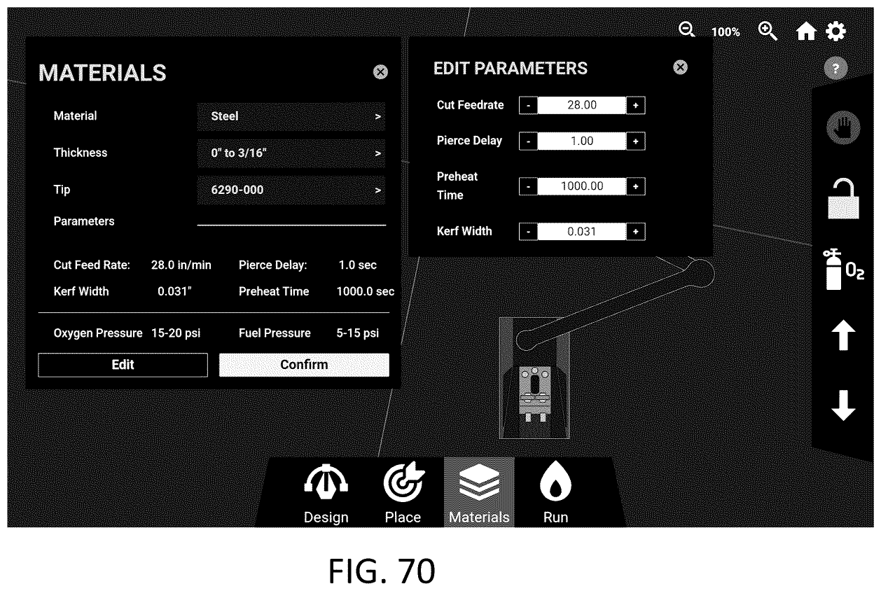

FIGS. 65-70 illustrates a material control component of a modular CNC software platform. The modular CNC software platform is operable to receive material information including but not limited to a material type (e.g., steel), a workpiece thickness, and a tip size of a cutting tool. The modular CNC system is operable to determine a cut height, a pierce delay, a kerf width, a cut feed rate, a pierce height, and a preheat time. The cut feed rate is a linear speed of a torch during a cut. The pierce delay is an amount of time that a torch pierces in place before moving along a cutting path. The preheat time is an amount of time between the torch arriving at a new pierce point and automatically piercing. The kerf width is a width of the cutting jet that offsets depending on a side of the cut. In some embodiments, the modular CNC platform is operable to generate a recommended cutting tip based on a selected tip type and materials. The modular CNC platform is further operable to recommend fuel and oxygen pressures for a desired cut.

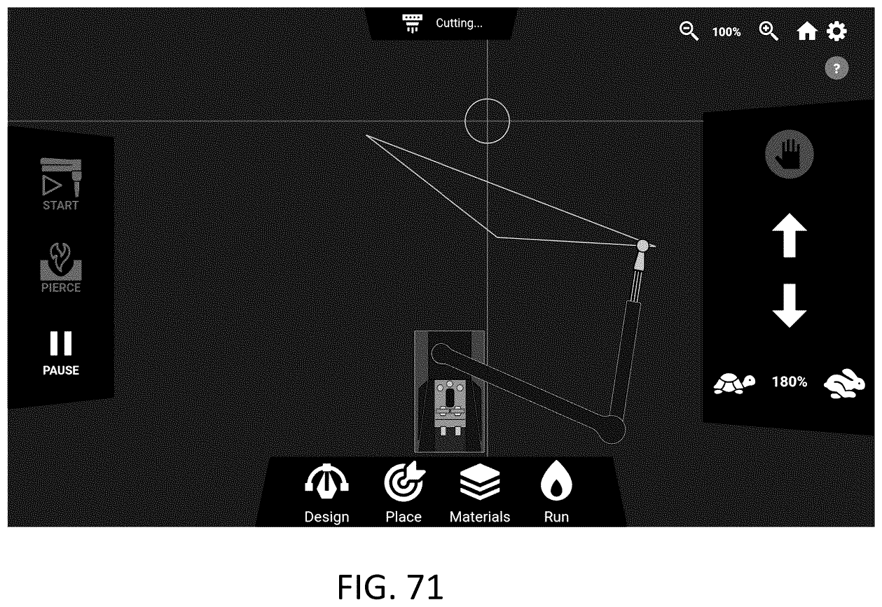

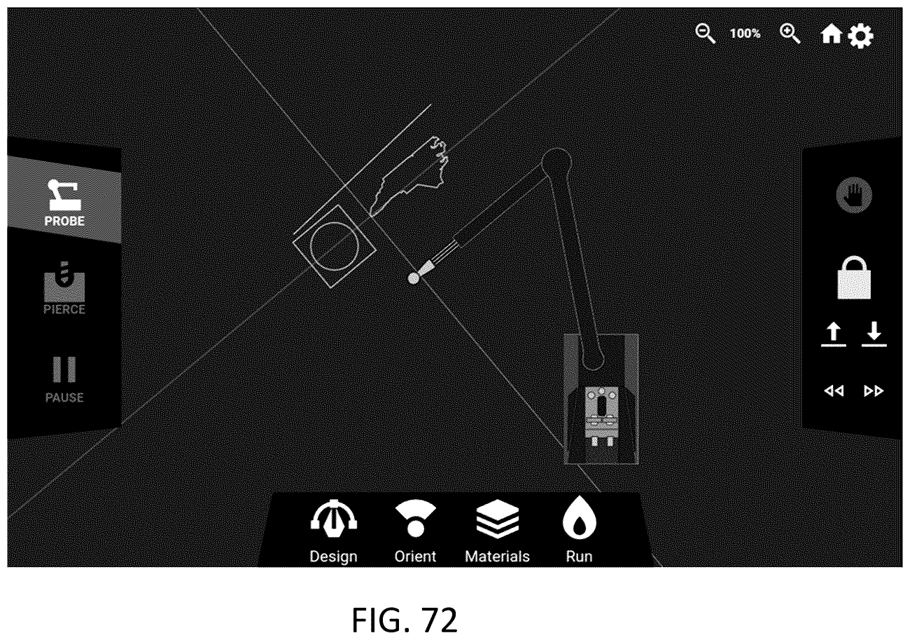

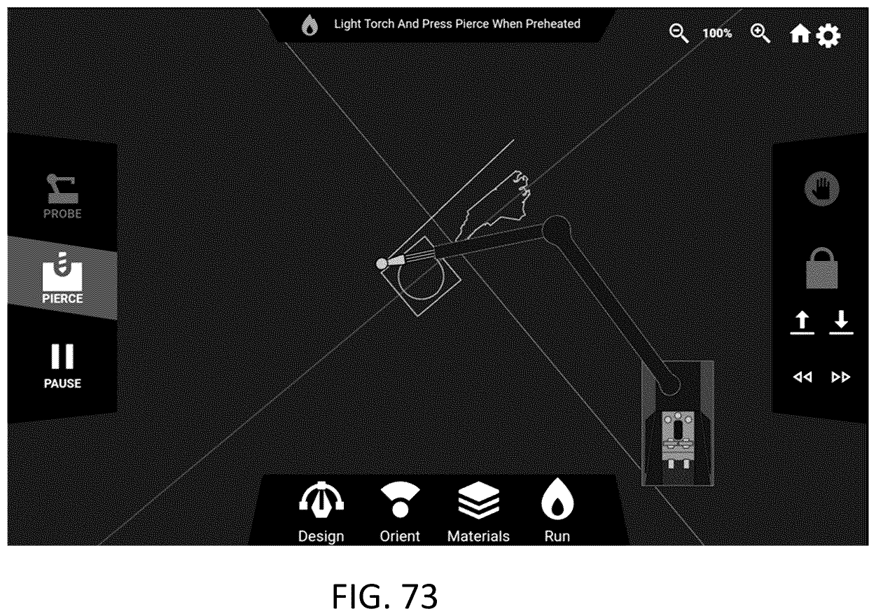

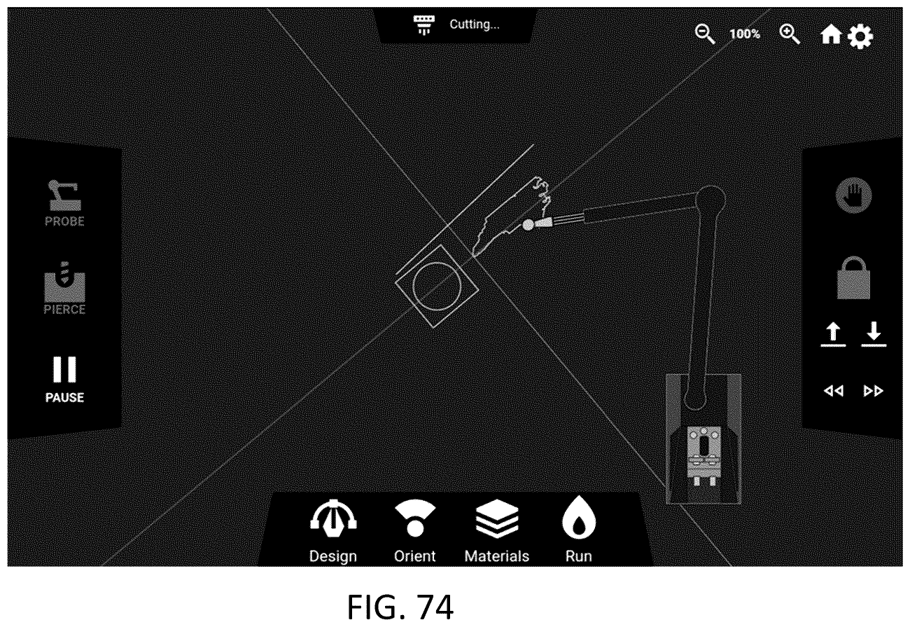

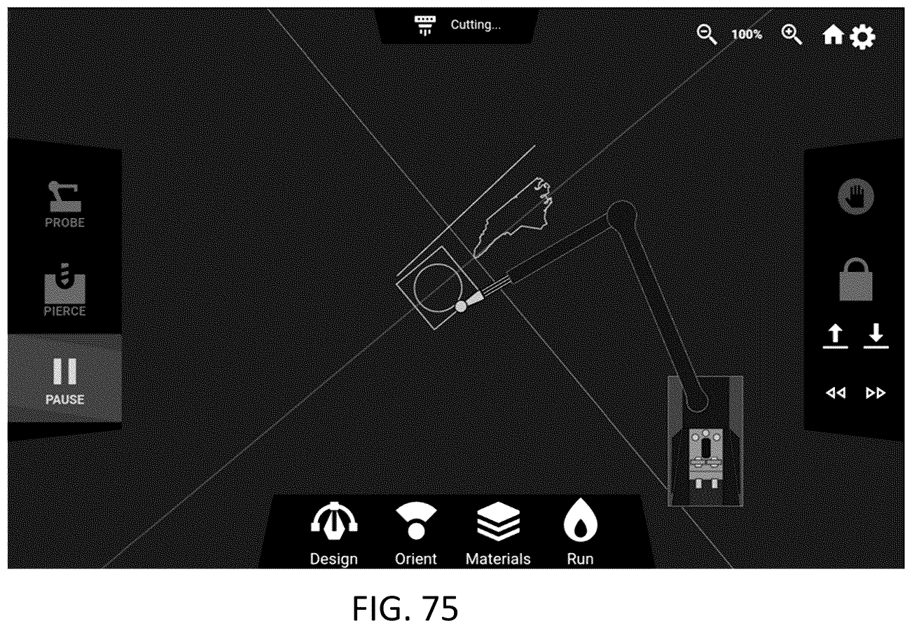

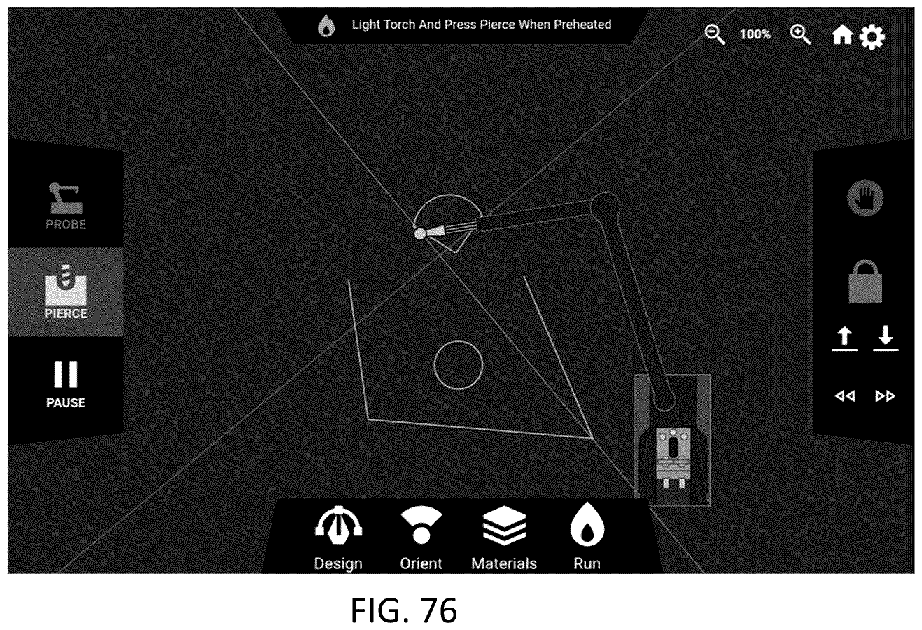

FIG. 71 illustrates a virtual representation of a modular CNC machine performing a cutting process along a cutting path. FIG. 72 illustrates a probe component of a modular CNC software platform. The modular CNC software platform is operable to transmit a command to a modular CNC machine to probe a workpiece material. FIG. 73 illustrates a pierce component of a modular CNC software platform. The modular CNC software platform is operable to transmit a command to a modular CNC machine to pierce a workpiece along a cutting path. Alternatively, or additionally, the modular CNC software platform is operable to automatically change to the pierce component after detecting manual piercing of a workpiece. FIG. 74 illustrates a virtual representation of a modular CNC machine performing a cutting process according to one embodiment of the present invention. As shown in FIG. 75, the modular CNC system is operable to pause a cutting process. FIG. 76 illustrates a pierce component of a modular CNC software platform according to one embodiment of the present invention.

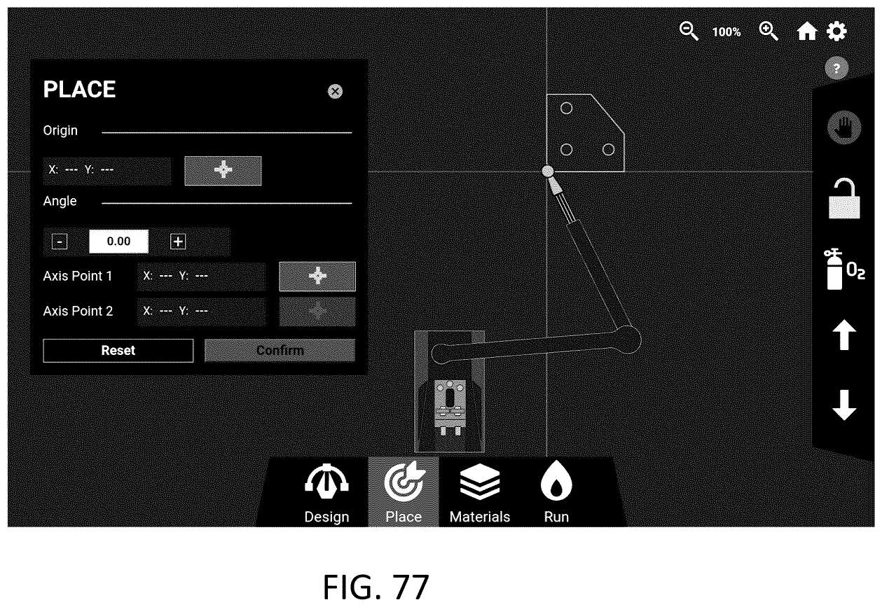

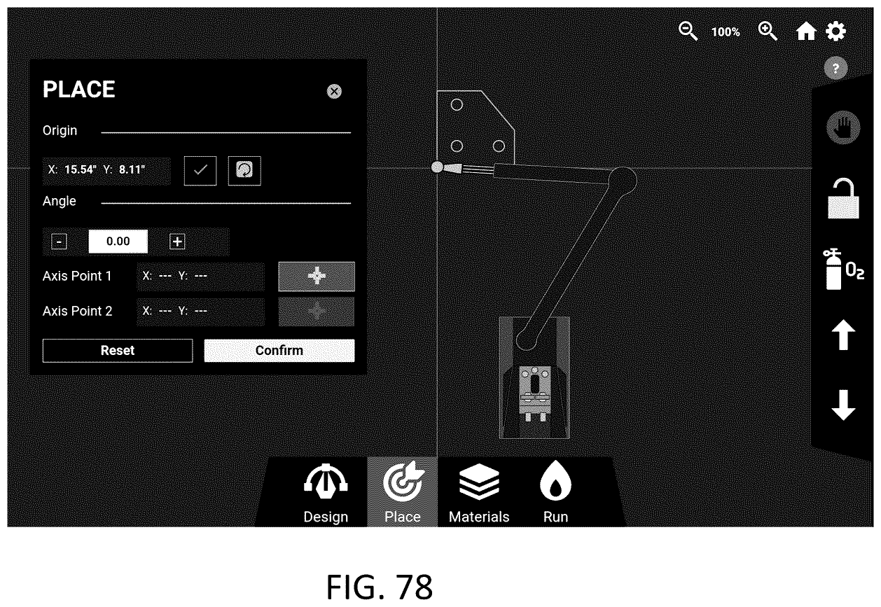

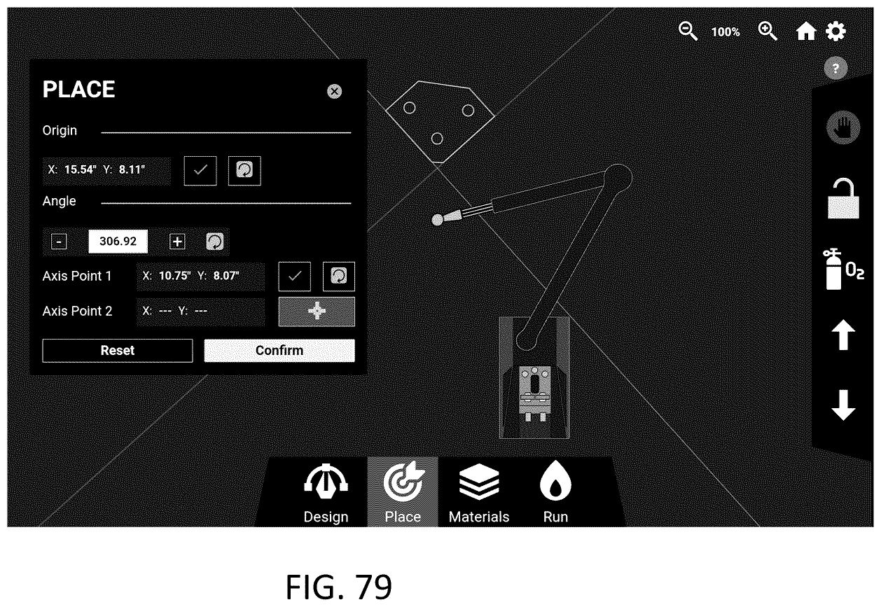

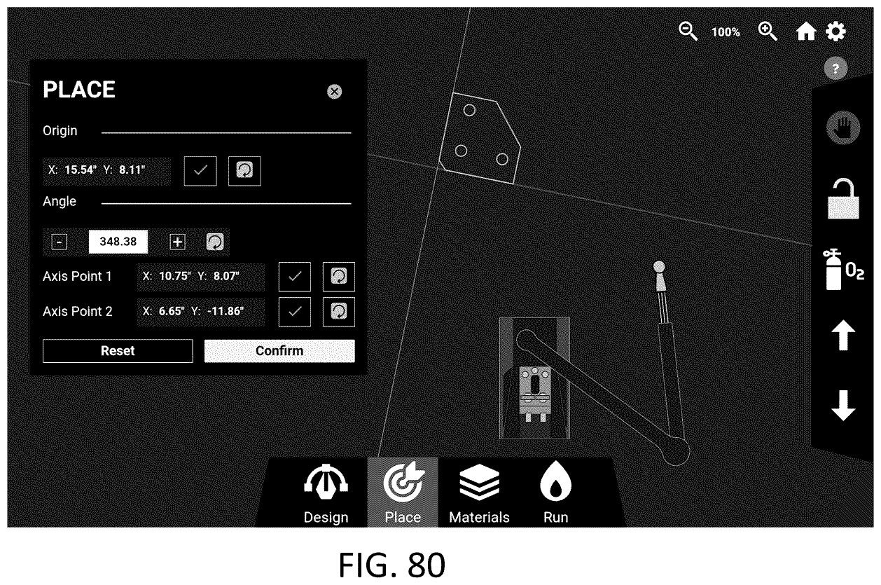

FIGS. 77-80 illustrate a placement control component of a modular CNC software platform according to one embodiment of the present invention. The placement control component is operable to define a classic design element for a cut. The modular CNC software platform is operable to receive user input when a modular CNC machine is in an origin position. In response to the user input, the modular CNC software platform is operable to update a virtual representation of the machine and cut to indicate the starting origin. The modular CNC software platform is operable for automatic and manual rotation of the starting origin via an angle orientation. The modular CNC software platform is further operable to receive at least two points to align at least one axis of the virtual representation. For example, and without limitation, the modular CNC software platform is operable to align a virtual x-axis based on a first point and a second point. The software platform is operable to automatically update a rotation angle of the virtual representation based on the two axis points.

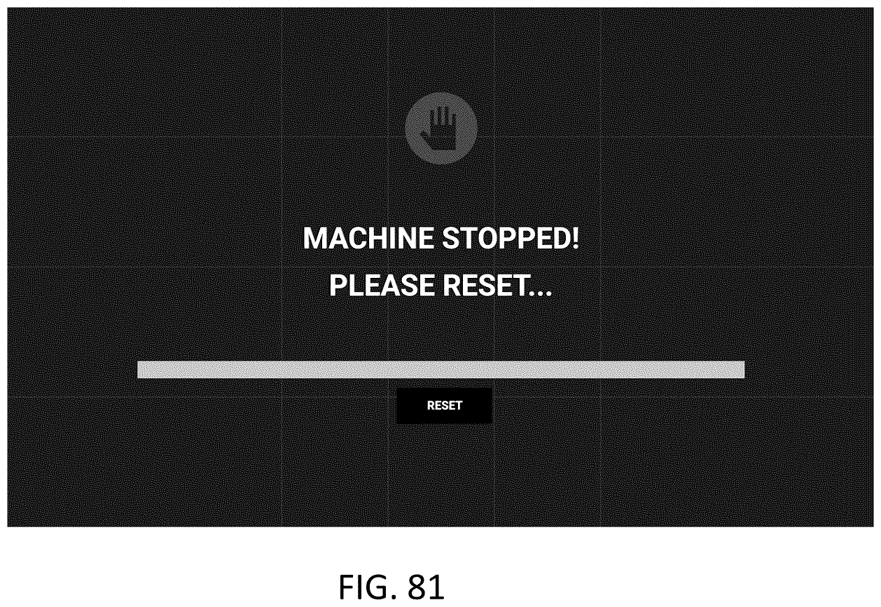

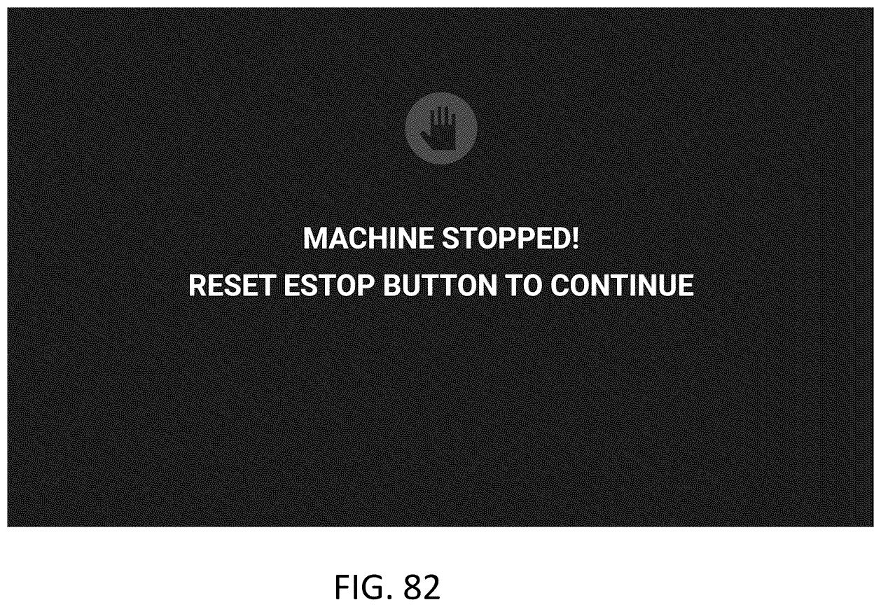

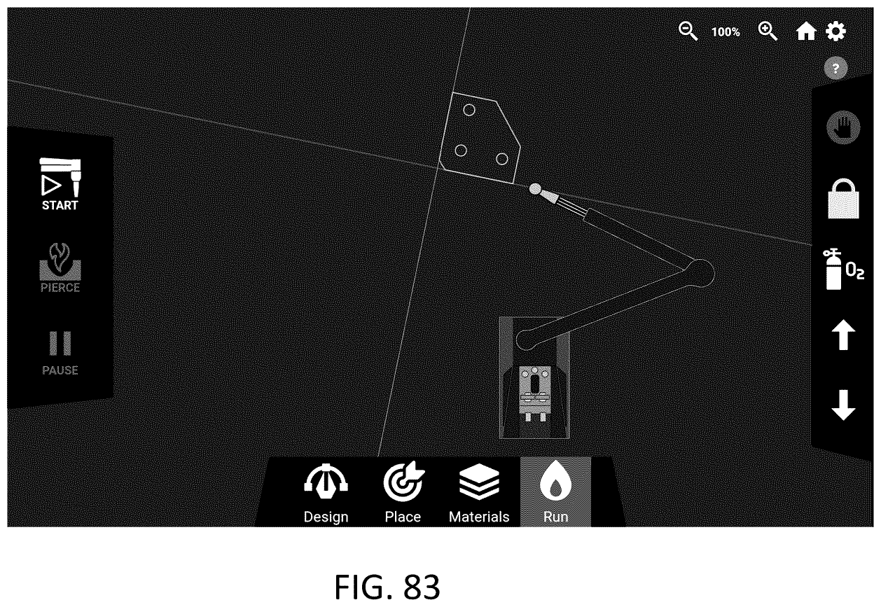

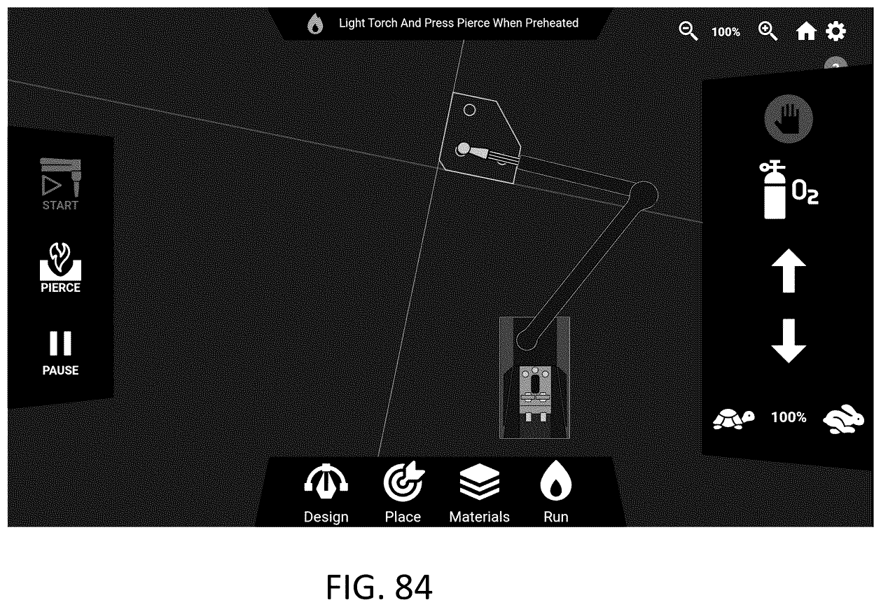

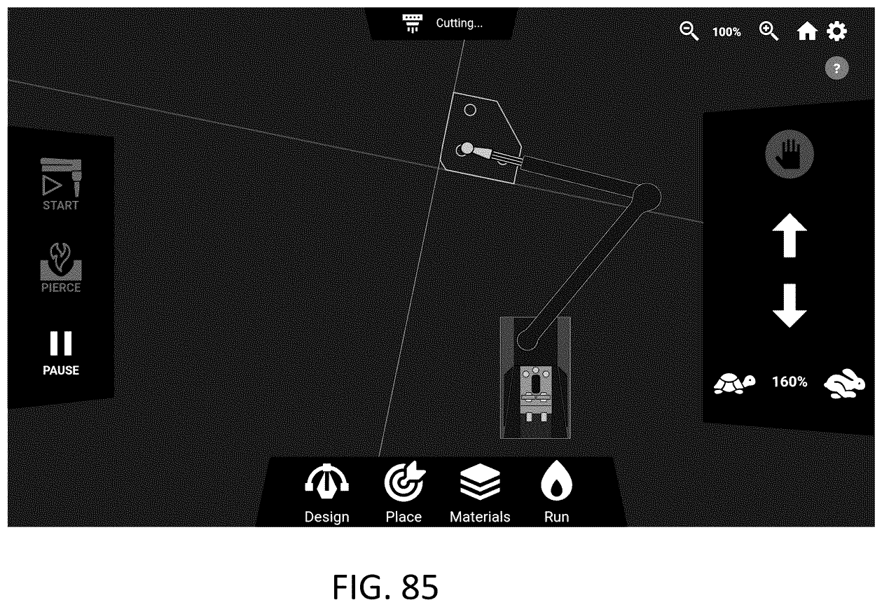

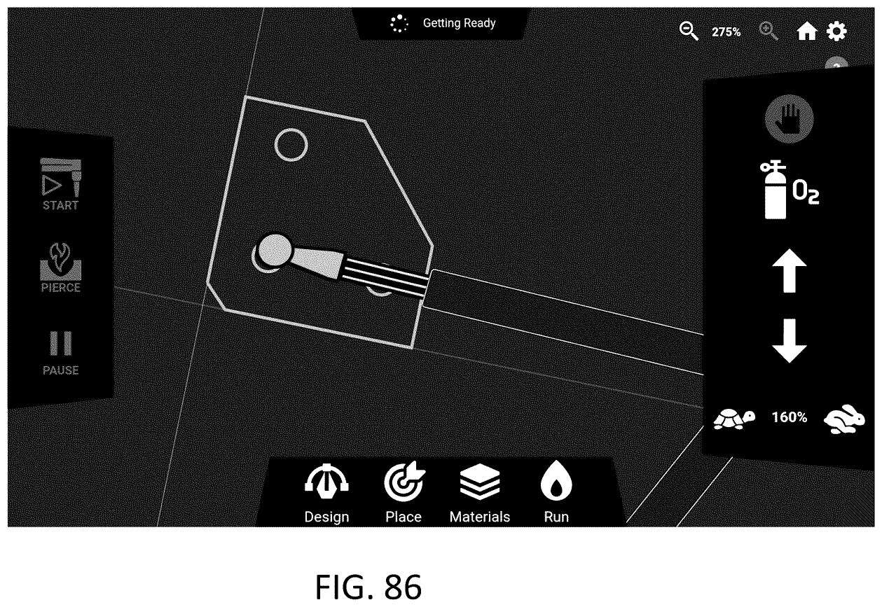

FIGS. 81-82 illustrates an emergency stop alert of a modular CNC software platform. FIG. 83 illustrates a run (e.g., cutting process) component of a modular CNC software platform. As shown in FIG. 84, the modular CNC software platform is operable to generate a virtual representation of a modular CNC machine in relation to a workpiece and a cutting path. As shown in FIG. 85, the modular CNC software platform is operable to change a speed of a cutting path. FIG. 86 illustrates a virtual representation of a modular CNC machine and a cutting path according to one embodiment of the present invention.

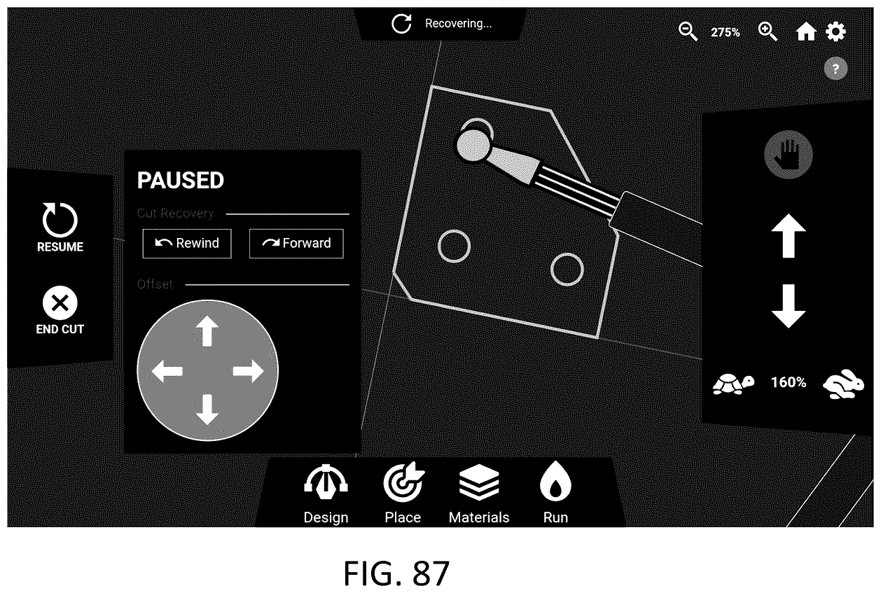

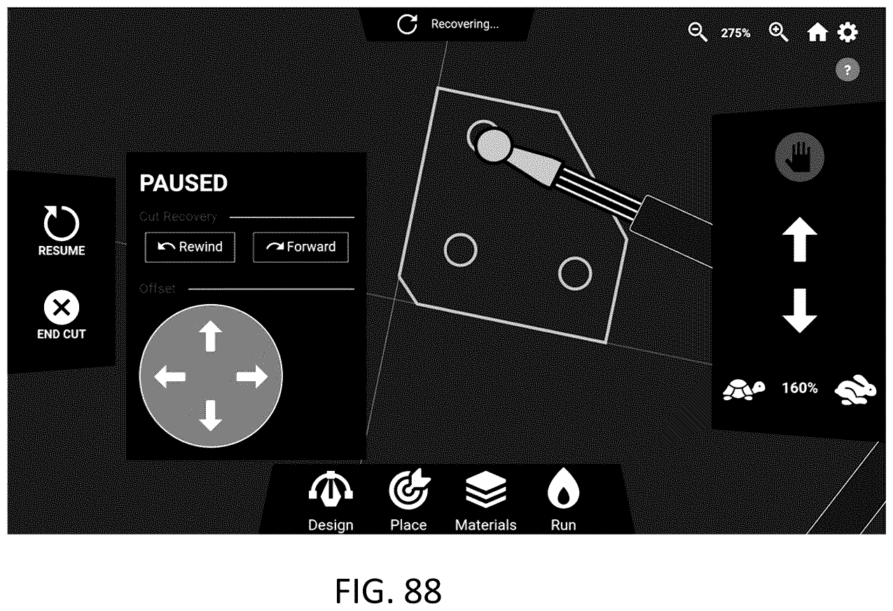

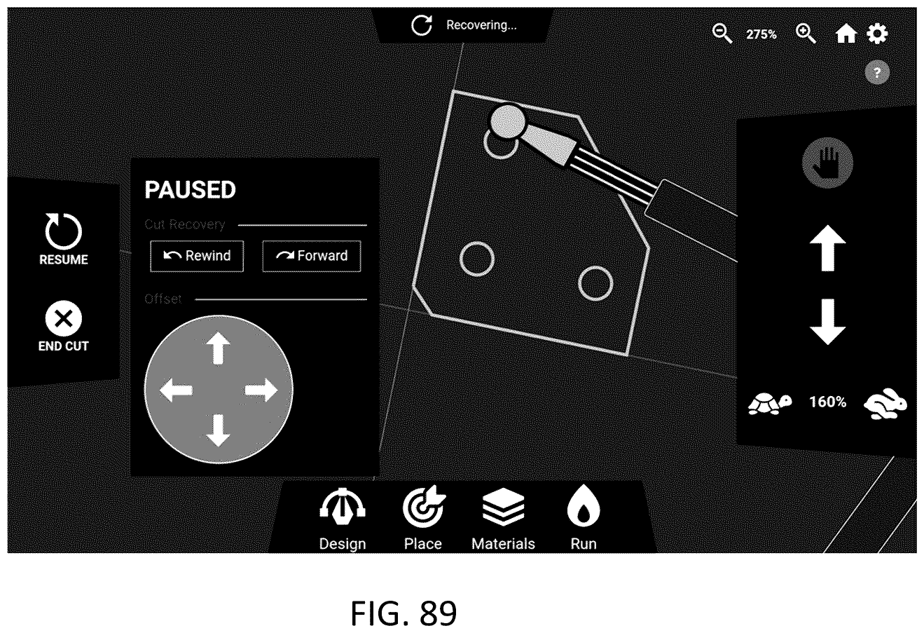

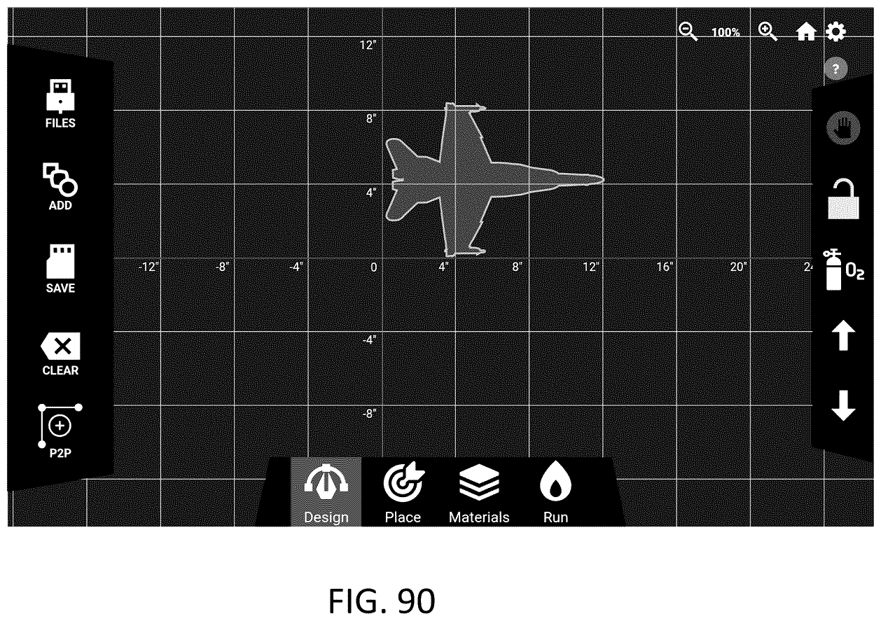

Advantageously, the modular CNC software platform is operable to stop a modular CNC machine during a cutting process and reposition a cutting tool to align with a cutting path. FIGS. 87-89 illustrate rewinding a modular CNC software platform along a cutting path. The virtual representation of repositioning of the modular CNC machine along the cutting path matches a corresponding movement of a physical modular CNC machine. FIG. 90 illustrates a virtual representation of a cutting path according to one embodiment of the present invention.

The modular CNC software platform is further operable to generate at least one alert. For example, and without limitation, the modular CNC software platform is operable to determine whether a flame is too much oxygen, not enough oxygen, and/or an ideal neutral flame. The modular CNC software platform is further operable to detect when a cutting tool is not following a path. The software platform is further operable to generate an alert if a modular CNC machine disconnects from a workpiece.

The modular CNC software platform is operable to command a torch to travel directly to a first pierce point. After preheating is complete, the cutting jet will be engaged and pierce a workpiece. After piercing, the torch will follow along a cutting path. During the cutting process, a torch height and a linear feed rate can be adjusted. The modular CNC software platform is further operable to pause or abruptly stop a cutting process. When pausing a cutting process, a torch will lift up and the cutting jet will be disengaged. The cut can be resumed or a cut recovery feature can be used to move further along a cut or to move backward along a cutting path. Advantageously, this enables a user to fix errors including an overrun cut or piercing issues.

In some embodiments, the modular CNC system includes a software platform for managing a modular CNC machine while performing welding, cutting, and other similar applications. The modular CNC software platform is operable to create a design for a cut. The software platform is further operable to receive a design for a cut. For example, and without limitation, the software platform is operable to receive a design file (e.g., .dxf file) from a remote device, a remote server, a database, and/or a third-party application. The software platform is operable to receive user input identifying a unit (e.g., inches, millimeters) of the drawing file. The software platform is further operable to identify and define where a desired cut will occur on a workpiece. The software platform is further configured to set up, monitor, and control a plurality of parameters for the desired cut. For example and without limitation, the plurality of parameters relates to the workpiece and/or at least one tool (e.g., oxy-fuel torch, plasma torch) for the desired cut.

In some embodiments, the modular CNC software platform includes an control panel. The control panel is operable to transmit commands to a modular CNC machine in real-time or near real-time. For example, and without limitation, the control commands include a unlocking or locking movement of the base arm, an unlocking or locking movement of the arm attachment component, an emergency stop, and/or height adjustment of a tool (e.g., oxy-fuel torch). The emergency stop is designed to halt all machine movements and to disable a tool (e.g., cutting joint). In some embodiments, the emergency stop function does not disengage an attachment mechanism of the modular CNC system or extinguish a neutral value set with manual valves. In some embodiments, the control panel includes a fuel override. The fuel override is operable to engage a cutting jet when activated. In some embodiments, the modular CNC software platform includes at least one height indicator via a user interface. The at least one software platform is operable to receive user input (e.g., touch screen) related to at least one height indicator. For example, and without limitation, the at least one height indicator includes an up arrow and a down arrow indicator. After receiving a selection of the up arrow, the modular CNC software platform is operable to transmit a command to a modular CNC machine to raise a height of the base arm and/or the arm attachment component. After receiving a selection of the down arrow, the modular CNC software platform is operable to transmit a command to a modular CNC machine to lower a height of the base arm and/or the arm attachment component.

In some embodiments, the modular CNC element is operable to automatically generate a predesigned cut. For example predesigned cut includes a shape (E.g., circle, rectangles, lines). The modular CNC software platform is further operable to modify a shape parameters (e.g., size, line shape, line depth). The parameters further indicate whether a lead-in to the closed shape starts from an inside or outside of the shape. The modular CNC software platform is operable to treat overlapping start and end points as a continuous cut.

The modular CNC software platform is operable for point-to-point functionality. The modular CNC software platform is operable to generated a closed element and use a gesture command to move a torch tip to a critical point of the closed element. In some embodiments, the modular CNC system is operable to receive gesture commands. The gesture commands are used for point-to-point processes and placement. The gesture commands enable a user to use a center point of an attachment for locating a design. The modular CNC software platform is operable to use a gesture command to guide the torch to a starting point and display the start point. The gesture movement moves the arm to a next critical point and the software platform is operable to add an additional point to the display. Additional arc and line elements can be added as needed. Once a path is completed, the modular CNC software platform is operable to receive user input to close the path. The modular CNC system is operable for an outside lead-in and an inside lead-in.

Advantageously, the modular CNC software platform is operable to receive user input corresponding to a desired cut. For example, and without limitation, the modular CNC software platform is operable zoom in and/or zoom out on a desired cut. The modular CNC software platform is further operable to send and receive software updates for the modular CNC system and modular CNC machine. In some embodiments, the software updates are sent and receive via a wired connection. Alternatively, or additionally, the software updates are transmitted via wireless communication.

Any combination of one or more computer-readable medium(s) may be utilized. The computer-readable medium may be a computer readable signal medium or a computer-readable storage medium (including, but not limited to, non-transitory computer-readable storage media). A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer readable storage medium and that can communicate, propagate, or transport a program for use by or in connection with an instruction execution system, apparatus, or device.

In one embodiment, the present invention includes a cloud-based network for distributed communication via a wireless communication antenna and processing by at least one mobile communication computing device. In another embodiment of the invention, the system is a virtualized computing system capable of executing any or all aspects of software and/or application components presented herein on computing devices. In certain aspects, the computer system may be implemented using hardware or a combination of software and hardware, either in a dedicated computing device, or integrated into another entity, or distributed across multiple entities or computing devices.

By way of example, and not limitation, the computing devices are intended to represent various forms of digital computers and mobile devices, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in this document.

By way of example, and not limitation, the computing devices are intended to represent various forms of digital computers and mobile devices, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in this document.

In one embodiment, the computing device includes components such as a processor, a system memory having a random-access memory (RAM) and a read-only memory (ROM), and a system bus that couples the memory to the processor. In another embodiment, the computing device may additionally include components such as a storage device for storing the operating system and one or more application programs, a network interface unit, and/or an input/output controller. Each of the components may be coupled to each other through at least one bus. The input/output controller may receive and process input from, or provide output to, a number of other devices, including, but not limited to, alphanumeric input devices, mice, electronic styluses, display units, touch screens, signal generation devices (e.g., speakers), or printers.

By way of example, and not limitation, the processor may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

By way of example, and not limitation, the processor may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another embodiment, multiple processors and/or multiple buses may be used, as appropriate, along with multiple memories of multiple types (e.g., a combination of a DSP and a microprocessor, a plurality of microprocessors, one or more microprocessors in conjunction with a DSP core).

Also, multiple computing devices may be connected, with each device providing portions of the necessary operations (e.g., a server bank, a group of blade servers, or a multi-processor system). Alternatively, some steps or methods may be performed by circuitry that is specific to a given function. According to various embodiments, the computer system may operate in a networked environment using logical connections to local and/or remote computing devices through a network. A computing device may connect to a network through a network interface unit connected to a bus. Computing devices may communicate communication media through wired networks, direct-wired connections or wirelessly, such as acoustic, RF, or infrared, through an antenna in communication with the network antenna and the network interface unit, which may include digital signal processing circuitry when necessary. The network interface unit may provide for communications under various modes or protocols.

In one or more exemplary aspects, the instructions may be implemented in hardware, software, firmware, or any combinations thereof. A computer readable medium may provide volatile or non-volatile storage for one or more sets of instructions, such as operating systems, data structures, program modules, applications, or other data embodying any one or more of the methodologies or functions described herein. The computer-readable medium may include the memory, the processor, and/or the storage media and may be a single medium or multiple media (e.g., a centralized or distributed computer system) that store the one or more sets of instructions. Non-transitory computer readable media includes all computer readable media, with the sole exception being a transitory, propagating signal per se. The instructions may further be transmitted or received over the network via the network interface unit as communication media, which may include a modulated data signal such as a carrier wave or other transport mechanism and includes any delivery media. The term “modulated data signal” means a signal that has one or more of its characteristics changed or set in a manner as to encode information in the signal.

Storage devices and memory include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system.

Particular embodiments and features have been described with reference to the drawings. It is to be understood that these descriptions are not limited to any single embodiment or any particular set of features, and that similar embodiments and features may arise, or modifications and additions may be made without departing from the scope of these descriptions and the spirit of the appended claims.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

What is claimed is:

1. A modular computerized numerical control (CNC) system comprising:
a base assembly comprising a housing, at least one power supply, at least one rotatable base arm, and an attachment mechanism;
at least one module;
at least one arm attachment component;
at least one processor;
and at least one tool;
wherein a first end of the at least one arm attachment component is rotatably connected to the at least one rotatable base arm via an attachment component;
wherein a second end of the at least one arm attachment component is operable to receive the at least one tool;
wherein the base attachment mechanism is operable to engage an external surface;
wherein the at least one module is in electrical connection with the at least one processor and the at least one tool; and
wherein the at least one module is operable to control the at least one tool.

2. The modular CNC system of claim 1, wherein the at least one tool is an oxy-fuel torch.

3. The modular CNC system of claim 2, wherein the at least one module is an oxy-fuel module, wherein the oxy-fuel module is operable to control a flow of gas to the oxy-fuel torch.

4. The modular CNC system of claim 1, wherein the base attachment mechanism includes an electromagnet, wherein the electromagnet is operable to attach the modular CNC system to a magnetic surface.

5. The modular CNC system of claim 1, wherein the at least one tool is a plasma torch.

6. The modular CNC system of claim 1, wherein the base assembly further includes a height control assembly, wherein the height control assembly is operable to control a height of the at least one rotatable base arm.

7. The modular CNC system of claim 1, wherein the base attachment mechanism includes a vacuum component, wherein the vacuum component includes at least two suction cups and at least one pump, wherein the at least one pump is operable to remove air from the at least two suction cups to create a sealed environment.

8. The modular CNC system of claim 1, wherein the at least one processor is in network communication with at least one remote device, wherein the at least one remote device is operable to transmit at least one command to the at least one processor, wherein the at least one command includes a power command and/or a position command, wherein the power command includes at least one of activating the base assembly, deactivating the base assembly, activating the at least one tool, or deactivating the at least one tool, wherein the position command includes a target position for the at least one rotatable base arm and/or the at least one tool.

9. A modular computerized numerical control (CNC) system comprising:
a base assembly comprising a housing, at least one power supply, at least one rotatable base arm, and an electromagnet;
at least one module;
at least one arm attachment component;
at least one processor;
and at least one tool;
wherein a first end of the at least one arm attachment component is rotatably connected to the at least one rotatable base arm via an attachment component;
wherein a second end of the at least one arm attachment component is operable to receive the at least one tool;
wherein the electromagnet is operable to engage an external surface;
wherein the at least one module is in electrical connection with the at least one processor and the at least one tool; and
wherein the at least one module is operable to control the at least one tool.

10. The modular CNC system of claim 9, wherein the at least one tool is an oxy-fuel torch.

11. The modular CNC system of claim 10, wherein the at least one module is an oxy-fuel module, wherein the oxy-fuel module is operable to control a flow of gas to the oxy-fuel torch.

12. The modular CNC system of claim 8, wherein the at least one tool is a plasma torch.

13. The modular CNC system of claim 8, wherein the base assembly further includes a height control assembly, wherein the height control assembly is operable to control a height of the at least one rotatable base arm.

14. The modular CNC system of claim 8, further comprising a carrying case, wherein the carrying case is operable to receive the base assembly, the at least one module, the at least one arm attachment component, and the at least one tool.

15. A modular computerized numerical control (CNC) system comprising:
a base assembly comprising a housing, at least one power supply, at least one rotatable base arm, and an attachment mechanism;
at least one module;
at least one arm attachment component;
at least one processor;
and at least one tool;
wherein a first end of the at least one arm attachment component is rotatably connected to the at least one rotatable base arm via an attachment component;
wherein a second end of the at least one arm attachment component is operable to receive the at least one tool;
wherein the base attachment mechanism is operable to engage an external surface;
wherein the at least one module is in electrical connection with the at least one processor and the at least one tool;
wherein the at least one rotatable base arm and the at least one arm attachment component are operable to extend away from the base housing; and
wherein the at least one module is operable to control the at least one tool.

16. The modular CNC system of claim 15, wherein the at least one tool is an oxy-fuel torch.

17. The modular CNC system of claim 16, wherein the at least one module is an oxy-fuel module, wherein the oxy-fuel module is operable to control a flow of gas to the oxy-fuel torch.

18. The modular CNC system of claim 15, wherein the at least one tool is a plasma torch.

19. The modular CNC system of claim 15, wherein the base assembly further includes a height control assembly, wherein the height control assembly is operable to control a height of the at least one rotatable base arm.

20. The modular CNC system of claim 15 further comprising at least one sensor, wherein the at least one sensor is operable to receive audio data during operation of the at least one tool, wherein the at least one sensor is operable to transmit the received audio data to the at least one processor, wherein, based on the received audio data, the at least one processor is operable to change at least one operation of the at least one tool, wherein the at least one operation includes a cutting rate.
